(19) United States
(12) Patent Application Publication
(10) Pub. No.: US 2026/0013496 A1
(43) Pub. Date: Jan. 15, 2026

(54) ANTIMICROBIAL AND/OR ANTIVIRAL MATERIALS

(71) Applicant: KLURA LTD, Haverhill, Suffolk (GB)

(72) Inventors: Payam NAHAVANDI, Haverhill (GB); Reza SABERI MOGHADDAM, Haverhill (GB); Mohammad MOHSENI, Haverhill (GB); Masoomeh BAZZAR, Haverhill (GB); Osama ALSWAFY, Haverhill (GB); Robyn JERDAN, Haverhill (GB); Cigdem WILLIAMS, Haverhill (GB)

(21) Appl. No.: 18/993,713

(22) PCT Filed: Oct. 5, 2023
(86) PCT No.: PCT/GB2023/052584

§ 371 Date: Jan. 13, 2025

(30) Foreign Application Priority Data
Oct. 5, 2022 (GB) 2214657.5
Feb. 21, 2023 (GB) 2302468.0

(51) Int. Cl. A01N 25/10; A01N 59/06; C08J 5/02; C08K 3/22

(52) U.S. Cl. CPC A01N 25/10; A01N 59/06; C08J 5/02; C08K 3/22; C08J 2333/18

(57) ABSTRACT

Described a coagulant formulation for use in the preparation of a material that is formed by dipping, wherein the formulation includes a lipophilic and/or amphiphilic polymeric ionophore:ion complex wherein the polymeric ionophore is a hydrophilic and/or amphiphilic polymer and wherein the polymeric ionophore:ion complex imparts antimicrobial and/or antiviral properties to the material.

### CROSS-REFERENCE TO RELATED APPLICATIONS

This application is a U.S. National Stage Application, filed under 35 U.S.C. § 371, of International Application No. PCT/GB2023/052584, filed Oct. 5, 2023, which claims the benefit of GB Application No. 2214657.5, filed Oct. 5, 2022 and GB Application No. 2302468.0, filed Feb. 21, 2023, the content of each of which is incorporated by reference in its entirety.

### DESCRIPTION

The present invention relates to formable materials that have antimicrobial, antibacterial and/or antiviral properties. In particular, these properties are intrinsic to the material by virtue of the fabrication process. The invention has particular application to synthetic and non-synthetic elastic and inelastic polymers, including disposable gloves.

Disposable gloves are an essential item in many environments, particularly healthcare, where they protect workers and customers/patients from exposure to potentially dangerous microbes and provide essential hygiene. Disposable gloves are generally made from one of three materials: nitrile, latex, or vinyl, as well as a blend of nitrile and vinyl.

For decades, latex has been the material of choice, particularly in the medical disposable glove world. This is because latex gloves were recommended in the 1980s and 1990s against bloodborne pathogens like HIV. But, as their popularity increased, so did cases of allergic reactions. This led to more demand for latex-free disposable glove alternatives, like nitrile and vinyl. For those who are not allergic, latex gloves are comfortable, relatively cost-effective, and offer a high degree of touch sensitivity.

Vinyl gloves are made from polyvinyl chloride (PVC), a petroleum-based film and a monomeric material. A plasticiser is sometimes added to make the material suitably flexible for glove use. The primary benefit of vinyl disposable gloves is that they are inexpensive to manufacture. However, they are less durable than latex and nitrile, and they offer limited protection against chemical or biomedical exposure. When vinyl gloves are stretched or flexed, the individual molecules separate, and the integrity of the protective barrier is compromised. Vinyl gloves are also a concern in terms of their environmental impact. Due to their low cost and low protection levels, vinyl gloves are commonly used in non-hazardous and low-infection environments.

Nitrile gloves came to prominence in the 1990s as a leading alternative to latex. While they are not as elastic or flexible as their latex counterparts, disposable nitrile gloves are notably more durable and resistant to chemicals. As such, these gloves are the ideal choice for anyone who has to handle potentially hazardous and corrosive chemicals. They are also perfectly suited for most medical environments, being exceptionally puncture-resistant and eliminating the risk of latex allergy reactions.

Nitrile, sometimes called nitrile butadiene rubber (NBR), is a copolymer of butadiene and acrylonitrile. This is important for nitrile because it derives several key benefits from both butadiene and acrylonitrile. Acrylonitrile is a volatile synthetic liquid with a strong smell and butadiene is a colourless gas and organic compound that can easily become liquid.

Acrylonitrile (C₃H₃N) is made through the SOHIO process which reacts propane, ammonia, water, and air to synthesise both acrylonitrile and acetonitrile. Acetonitrile is used in the synthesis of butadiene. Butadiene (C₄H₆) is made as a by-product in the production of ethylene, which happens through steam cracking. Butadiene is then obtained through extractive distillation: this process filters through heavier by-products in order to extract butadiene. Nitrile is then formed through the co-polymerisation of both acrylonitrile and butadiene, in which they are reacted together and ultimately formed into crude, synthetic rubber. The nitrile is then moulded into gloves.

Butadiene provides nitrile with flexibility and puncture/tear resistance (three times as puncture resistant as latex), while acrylonitrile enhances the chemical resistance. These unique chemical qualities are what give each material its benefits as a glove. Latex, for example, is the most flexible of the three, while nitrile is the most durable, and vinyl is the least expensive.

Thanks to butadiene and acrylonitrile, nitrile gloves have a few unique benefits that are not found in other gloves. First and foremost is nitrile's tensile strength. Nitrile is one of the most durable glove materials currently on the market, offering three times the durability of latex. In addition, nitrile offers impressive heat resistance, with a functional temperature range between −4° C. and 110° C. This makes nitrile an excellent choice for the handling of hot and cold materials for extended periods of time.

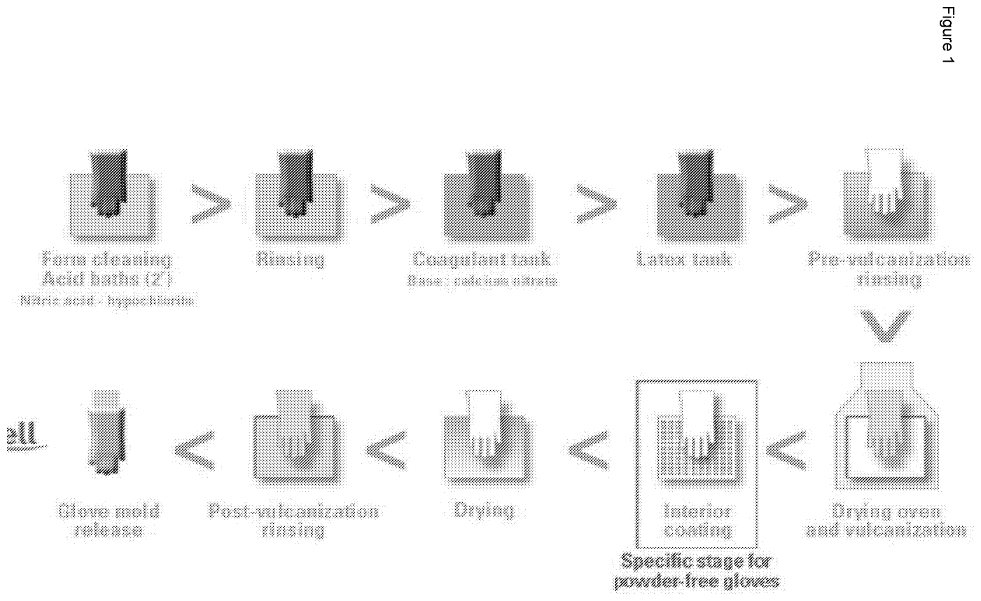

Because nitrile and vinyl gloves are made from synthetic materials, they are manufactured slightly differently to latex gloves. The manufacturing process described below and illustrated in FIG. 1 mainly focuses on nitrile gloves, but the concept is applicable equally to all four types of glove material.

First, the manufacturing equipment runs ceramic or aluminium hand-shaped formers through water and bleach to clean them and remove residue from previous manufacturing runs. The formers are then dried before being dipped in a mixture of calcium carbonate and calcium nitrate, which helps the synthetic materials coagulate around the formers. The formers are then dried again.

Next, the formers are dipped in tanks of NBR or PVC, depending on the type of glove being made. The gloves are then heated at a high temperature (vulcanisation) to form the gloves as they dry.

To help nitrile gloves go on more easily, they undergo one of two processes: polymer coating or chlorination. Polymer coating involves adding a layer of polymer to lubricate the glove's surface, whereas chlorination exposes the glove to a chlorine acid or gas mixture to make the material harder and slicker.

The last phase of the production process is called the stripping phase, in which blasts of air remove the gloves from the formers.

It may be argued that the coagulant formulation has the most important role in the manufacturing of gloves. For example, Ansell Ltd has patented over ten formulations just for the coagulant alone. The formulation of the coagulant varies depending on the type of glove being made and the processing setting of the manufacturing line. Below are two examples of the coagulant formulation used by Ansell Ltd:

| | | | |
|---|---|---|---|
| Anhydrous calcium chloride | 15 pbw (parts by weight) | calcium nitrate tetrahydrate | 60 pbw |
| Calcium nitrate tetrahydrate | 15 pbw | distilled water | 30 pbw |
| Methy/ethyl alcohol | 50 pbw | acetone | 5 pbw |
| Water | 20 pbm | non-ionic wetting agent | 1 pbw |

As can be seen from the above, calcium nitrate exists in both the formulations and, in fact calcium nitrate, is the most important ingredient in the coagulation process and the common element in most coagulant formulations. Calcium nitrate aids the pick-up of the raw material (e.g. nitrile) at the next stage and acts as the binder of the nitrile polymer. In fact, it is the concentration of the calcium nitrate in the coagulant which determines the final thickness of the glove.

Generally, the coagulant formulation consists of calcium nitrate, an anti-tack (demoulding) ingredient such as calcium stearate which aids the removal of the glove from the former, wetting agents and solvents.

In light of recent world health matters, it has become important to impart antimicrobial and/or antiviral properties to substrates and surfaces. For the avoidance of doubt, the term “antimicrobial” refers to an effect against a wide spectrum of microbes including bacteria, mould, fungi and viruses. However, the use of the term “antimicrobial” in this document refers to “antibacterial” and/or “antiviral” and will be inferred as such.

Coatings have been explored for disposable materials and one such product is provided by Biocote® Ltd. The antimicrobial additives used are Silver Ion, Copper, Zinc and Organic Additives including phenolic biocides, quaternary ammonium compounds and fungicides (e.g. thiabendazole) which are included in the coagulation tank. Specifically, this glove material utilises ZnO and TiO₂ in its coagulant formulation. However, the antimicrobial efficacy of these coatings is low, and it takes hours for any antimicrobial action to take effect.

One particular concern for materials with antimicrobial properties is access to the antimicrobial/antiviral effect of any active agent. Therefore, while a material may include one or more active agent that imparts antimicrobial to that material, for example by adding one or more antimicrobial agents to a dipping solution, such a property is likely to be reduced or limited because the agent(s) is/are deposited on the inside of the formed material which offers little protection against pathogens touching the external surfaces of the formed material. Therefore, a coating is the most desirable option.

However, coating formed materials, particularly disposable gloves, is not straight forward. As explained above, gloves are manufactured on formers and so coating must take place either by coating formers before glove material is deposited, or after gloves have been cured and removed from the formers. This is because gloves are formed inside-out. While formers may be sprayed, dipped, or coated prior to dipping in a coagulation tank, this adds one or more manufacturing steps and associated cost so is less desirable.

Another consideration with coatings is that they, naturally, impart a surface layer. Such a layer can impact on physical properties of the material, including flexibility, stickiness, touch sensitivity, and is at risk of cracking, washing and/or rubbing off in use.

Another concern is for a coating to be effective against gram-positive, as well as gram-negative, bacteria. Gram-negative bacteria are surrounded by a thin peptidoglycan cell wall, which itself is surrounded by an outer membrane containing lipopolysaccharide. Gram-positive bacteria lack an outer membrane but are surrounded by layers of peptidoglycan many times thicker than is found in gram-negative bacteria. However, gram-negative bacteria are much harder to inactivate and kill.

It is in this context that the present invention has been devised. In view of the drawbacks of added coatings, the present invention provides a coagulant formulation for use in the manufacture of formed materials, in which the formulation imparts antimicrobial properties to an external surface of the formed material.

Accordingly, in a first aspect, the present invention resides in a coagulant formulation or composition for use in the manufacture of a polymer material formed by dipping, the coagulant formulation or composition comprising a coagulant, one or more wetting agent surfactant, a solvent, and an anti-tack agent, wherein the coagulant comprises a lipophilic and/or amphiphilic and/or hydrophobic polymeric ionophore:ion complex, wherein the polymeric ionophore is a hydrophilic and/or amphiphilic polymer, and wherein the polymeric ionophore:ion complex imparts antimicrobial properties to the material. For the avoidance of doubt, the term “antimicrobial” encompasses bacteria and viruses.

In one embodiment, the polymeric ionophore may be hydrophilic and/or amphiphilic. In an alternative or additional embodiment, the polymeric ionophore may be water soluble.

To make an ionophore:ion complex of polymer and ion, there needs to be interaction between polymer and ion. This interaction usually comes from a functional group in the polymer. As an example, ethyl cellulose (EC) has one functional group while hydroxypropyl cellulose (HPC) has three. As a result, when the ion in the formulation is calcium, the calcium engages with the only functional group in EC, and the complex becomes lipophilic. Since HPC will have only one engaged functional group out of a total of three, the complex becomes amphiphilic.

Examples of suitable polymers include cellulose, ethyl cellulose (EC), methyl cellulose, hydroxypropyl cellulose (HPC), cellulose acetate and cellulose acetate butyrate, cellulose nitrate, cellulose triacetate, ethylene/vinyl acetate, poly(acrylic acid), poly(methyl methacrylate), poly(propylene oxide), poly(vinyl acetate), poly(methyl methacrylate) (PMMA), poly(2-phenyl-2-oxazoline) (PPhOx), polyethylene oxide (PEO), poly(2-hydroxyethyl methacrylate), poly(1,2 butylene glycol) (PBG), polyacrylonitrile, polyvinyl chloride, polyvinylidene fluoride, polyvinyl acetate, water-based resins or latex, water-based acrylics, polyurethanes, nitrile latex and natural rubbers, styrene-butadiene and carboxylated styrene-butadiene, cationic surfactants such as dicetyldimonium chloride, anionic surfactants such as sodium dodecylbenzenesulfonate and ammonium dodecyl benzenesulfonate, non-ionic surfactants such as nonylphenol ethoxylated (NPE) and ECO BRIJ® 010, and combinations thereof.

In one embodiment, the ion in the complex may be a positively charged ion, preferably a metal ion such as Na⁺, K⁺, Ca²⁺, Mn²⁺, Mg²⁺, Sr²⁺, Ti²⁺, Ti⁴⁺, Ba²⁺, Zn²⁺, Fe²⁺, Al³⁺, Cr³⁺ and Bi³⁺. Ideally the ion in the complex is provided in the formulation as a salt, such as a nitrate, chloride, hydroxide, carbonate, stearate, iodide, triiodide, iodite, hypoiodite, periodate, iodate or acetate. In a particular embodiment, the positive charge of the ionophore:ion complex may be enhanced by the use of a higher valency ion and/or the inclusion of more than one ion species in the formulation. For example, different valences of manganese could be used. In a particular example, the ion may be potassium, calcium or aluminium.

Ideally, the polymeric ionophore:ion complex may be present in the coagulant in an amount of between about 0.1% and about 10%. For example, where the polymeric ionophore:ion complex is ethyl cellulose:calcium or ethyl cellulose:potassium, a concentration of between about 1% and 2%, such as about 1.5%, is appropriate.

In a particular embodiment, the solvent may be water, an alcohol such as ethanol or a mixture thereof. Other constituents may also be present, such as acetone. The solvent may be 100% alcohol or a dilution thereof.

In an embodiment, the formulation may further include at least one plasticiser. Alternatively, the polymeric ionophore:ion complex may be selected also for its plasticiser properties. It will be appreciated that a plasticiser is a substance added to a formulation to produce or promote plasticity and flexibility and to reduce brittleness. Suitable plasticisers include Dibutyl sebacate (DBS), Hydroxyl end group PDMS (poly dimethyl siloxane), glycerol, sorbitol, sucrose, dibutyl phthalate, ethylene glycol, diethylene glycol, tri ethylene glycol, tetra ethylene glycol, polyethylene glycol, oleic acid, citric acid, tartaric acid, malic acid, soybean oil, dodecanol, lauric acid, tributyrin, trilaurin, epoxidised soybean oil, mannitol, diethanolamine, Fatty acids, triethyl citrate, and/or sucrose esters, and combinations thereof. A plasticiser concentration in the formulation of between about 0.1% and about 5% is suitable.

It will be appreciated that there is a chemical interaction between the coagulant formulation and the material being formed during formation of polymeric material. In one situation, the formulation may be mixed with the polymeric material and so the constituent parts of the formulation are incorporated into the polymer matrix. This situation can be achieved by direct mixing of substrate polymer and the antimicrobial polymeric ionophore:ion complex but requires compatible polymers in terms of solvent, solubility and miscibility.

In another situation, the polymer being formed may be a substrate on which a layer or coating of coagulant formulation is deposited. The chemical interaction between the substrate and the resulting coagulant layer may then be via weak Van der Waals forces between the substrate polymer and the polymer in the antimicrobial polymeric ionophore:ion complex. Van der Waals forces are defined as nonspecific interactions that can form between any kinds of molecules, regardless of chemical structure.

Alternatively, there may be a covalent bond between the substrate polymer and the polymer in the antimicrobial ionophore:ion complex. Achieving covalent bonding requires compatible polymers with appropriate functional groups which can create covalent bonds, and/or the use of appropriate functionaliser(s) to functionalise the polymer(s) where the polymeric ionophore is not able to create covalent bonds with the substrate polymer. In the latter case, an appropriate fuctionaliser(s) needs to be chosen based on the polymeric ionophore:ion complex and substrate polymer compatibility. In this way, a complicated network of copolymers is created.

The coagulant formulations of the present invention and described herein are suitable for use in all three of the chemical interactions described above.

Thus, in an embodiment, the strength of the chemical bonding between the polymeric ionophore:ion complex and the substrate polymer may be enhanced by functionalisation of the polymeric ionophore. In other words, the polymer may be functionalised. This also reduces leaching of the polymeric ionophore:ion complex because the polymer in the ionophore:ion complex is now functionalised with a functional group, such as acrylate, and that functional group is able to create a chemical bond with the substrate (nitrile) during the vulcanisation stage by the vulcanisation agents. This leads to a stronger covalent chemical bond which is stronger than Van der Waals bonding if the functionaliser is absent. Examples of suitable functional groups include acrylates, allylics, vinyls and methacrylates. Functionalisation may be achieved by the inclusion of one or more functionalising agents in the formulation, such as a mono-, di- or multi-factional acrylic, a methacrylic monomer, and acrylic macromonomer, a methacrylic macromonomer, acryloyl chloride, vinyl chloride, vinyl bromide, vinyl iodide, methacryloyl chloride, methacryloyl bromide, allyl chloride, allyl iodide, allyl bromide, allyl glycidil, methacrylate glycidil, 3-(Trimethoxysilyl)propyl acrylate, 3-(Triethoxysilyl)propyl acrylate, 3-(Trimethoxysilyl)propyl methacrylate, 3-(Triethoxysilyl)propyl methacrylat, 3-(Dimethylchlorosilyl)propyl methacrylate and 3-(Dimethylchlorosilyl)propyl acrylate. For example, acryloyl chloride or acrylic acid may be included to add acrylic moieties.

In a yet further embodiment, the coagulant formulation may further comprise at least one antimicrobial agent. Such an agent may be a basic or acidic compound such as a metal hydroxide, a metal hydrate, a metal nitrate, a metal silicate, a metal halide, a metal acetate, metal sulphide, a tertiary amine, and/or a benzene-based carboxylic acid. The formulation may include one or more components whose function is antimicrobial. The addition of a specifically antimicrobial agent to the formulation enhances the antimicrobial effect of the formulation. The addition of such agents also enables the target microbial species to be broadened. Accordingly, while the formulation may have antimicrobial activity against one or other type of bacteria, an additional agent may add activity against gram-negative and/or gram-positive bacteria.

Examples of suitable antimicrobial agents include a salt of a positively charged ion, preferably a metal ion such as Nat, K⁺, Ca²⁺, Mn²⁺, Mg²⁺, Sr²⁺, Ba²⁺, Zn²⁺, Fe²⁺, Al³⁺, Cr³⁺ and Bi³⁺. Examples of suitable salts include nitrate, chloride, hydroxide, acetate, carbonate, silicate, formates and diformates, and benzoate. An example of a suitable antimicrobial agent is a potassium salt such as potassium hydroxide, potassium nitrate, potassium carbonate, potassium chloride, potassium acetate, and potassium benzoate. Another example of a suitable antimicrobial agent is a sodium salt, such as sodium hydroxide, sodium nitrate, sodium chloride, sodium acetate, and sodium benzoate.

Potassium hydroxide (KOH) is highly effective against gram-negative bacteria, as are other soluble metal oxides, such NaOH. KOH is an antimicrobial salt that works by dissolving the thin peptidoglycan layer of the cell walls of gram-negative bacteria. This leads to disintegration of the gram-negative cell wall and lyses the cell and releases its contents. Benzoic acid is a water-soluble agent for gram-positive bacteria with high anti-microbial efficiency. Other water-soluble organic acids include tannic acid, lactic acid, citric acid, oxalic acid, uric acid, malic acid, and tartaric acid and are similarly suitable for use in the formulation of the present invention. Potassium benzoate is the product of the reaction of benzoic acid and KOH and also has antimicrobial activity.

Examples of other suitable antimicrobial agents include O-phenylphenol; sodium phenolate; glycol ethers such as propylene glycol phenyl ether (PGPE), 1-phenoxy-2-propanol, phenoxyethanol, 2-Butoxyethanol and poly(ethylene glycol) methyl ether; cationic polymers/surfactants such as polyethylenimine, dimethylaminoethyl acrylate (DA), and ethylenediaminetetraacetic acid (EDTA); and benzoyl peroxide.

In an embodiment the antimicrobial agent may be present in the formulation in an amount of between about 0.5% w/v and about 10% w/v. As an example, where the antimicrobial agent is potassium hydroxide, the agent may be present in the formulation in an amount of about 2% w/V, about 4% w/v, about 5% w/v, about 6% w/v or about 8% w/v.

It will be appreciated that more than one antimicrobial agent may be present in the formulation. Other additional antimicrobial agents include phenols, thymols (terpenes and terpenoids) and cymenes (alkylbenzene). A particular example of a phenol is eugenol.

In another embodiment, the formulation may further comprise at least one ionic, or non-ionic surfactant. Brij™ 35 is a particular example of a suitable non-ionic surfactant. Ionic and non-ionic surfactants are believed to act as additional ionophores.

In a specific embodiment in which the ion in the polymeric ionophore:ion complex is calcium (such as provided by calcium nitrate), the solvent may include one or more components that dissolve calcium hydroxide (Ca(OH)₂). Calcium salts can react with hydroxides present in the formulation, such as KOH, to form insoluble Ca(OH)₂ which then precipitates out of the formulation as sediment. Such sediment has a tendency to make the coagulant non-homogenous, remains on the former during material manufacture, make pinholes and leave powdery residues on the prepared material. Ca(OH)₂ (or slaked lime) is extremely insoluble in ethanolic solution and is only slightly soluble in water. Examples of suitable solvents for dissolving Ca(OH)₂ in coagulant formulation include water, glycerol (glycine) and mixtures thereof.

The Ca(OH)₂ solvent may be present in an amount of between about 0.1% and about 10%. For example, about 1 to 2% glycerol has been found to be suitable. Alternatively or in addition, about 5% water has been found to be suitable. A mixture of 1% glycerol and 5% water has been found to be suitable and does not affect the dispersibility of the polymeric ionophore or other ions present in the formulation.

It will be appreciated that suitable amounts of coagulant are known to the skilled person and easily derivable from the art, because the coagulant influences the thickness of the material produced. However, for the particular application of this invention, the coagulant may be present in the formulation in an amount of between about 2% and about 20%, optionally about 14%.

Suitable wetting agent surfactants are known to the skilled person and may be selected according to preference and final utility of the material, in accordance with standard skill and knowledge. Two common wetting agents used in coagulants are Teric® 320 and Surfynol® TG.

In an embodiment, the formulation may further include one or more anti-tack agents, such as a stearate salt, examples of which include calcium stearate, zinc stearate and magnesium stearate. As an example, one or more anti-tack agents may be present in the formulation in an amount of between about 0.1% and about 5%, optionally about 1.8%.

In a further embodiment, the formulation may further include a neutral, pleasant, or unpleasant fragrance and/or flavouring, and/or colourant.

It will be appreciated that the components of the formulations of the invention may be combined in any order and steps that are suitable to produce a homogenous coagulant solution (dispersion). In a specific embodiment, there is provided a method of producing the formulation as described herein, the method comprising the steps of:
a) Dissolving an amount of a polymeric ionophore in a solvent;
b) Adding an amount of a functionaliser to form a first mixture;
c) Once both the polymeric ionophore and functionaliser are completely dissolved, adding an amount of a positive ion in the form of a salt and an amount of an anti-tack agent to form a second mixture.

In a specific example, ethyl cellulose (polymeric ionophore) may be dissolved in ethanol (solvent), followed by acryloyl chloride (functionaliser) to form a first mixture. Once these components have dissolved completely, calcium nitrate (ion in the polymeric ionophore:ion complex), and calcium stearate (anti-tack agent) may be added to the first mixture to create a second mixture which is stirred before use.

Homogeneity of the coagulant is an important parameter for the uniformity of the resulting material. As a result, the methodology of coagulant preparation and the step at which additional components, such as antimicrobial agents, are added to the coagulant is an important parameter. Accordingly, in an embodiment, the method may further include the step of dissolving an antimicrobial agent in the solvent in step a) before adding the polymeric ionophore.

In a particular example, a part of the amount of the antimicrobial agent may be added to the solvent in step a), and the remainder of the amount may be added in step c). In other words, the inventors have found that the antimicrobial agent may be added to the formulation in more than one part. For example, a third or half of the required amount of KOH may be dissolved in ethanol before ethyl cellulose and acryloyl chloride are added to create the first mixture. The remaining amount may then be added in step c) to create the second mixture. The inventors have found that addition of KOH to both the first and second mixtures enhances the homogeneity of the mixture.

Where the antimicrobial agent is KOH, it is believed that KOH plays two roles in the coagulant formulation. The first role is acting as a base for the functionalisation reaction of EC. The second role is antimicrobial activity against gram-negative bacteria. However, KOH will be consumed in the reaction with calcium nitrate and, therefore, the efficiency and effectiveness against bacteria is lowered. As a result, it may be desirable to add extra KOH, either in the same step or in the next steps.

In another embodiment, the method may further include adding in step c), one or more components that dissolve Ca(OH)₂. For example, water and/or glycerol may be added together with calcium nitrate and calcium stearate in step c).

While the antimicrobial properties may be imparted to the nitrile material by way of the coagulant formulation, antimicrobial properties may be additionally imparted via the elastic polymer. For example, a part of the required amount of the antimicrobial agent may be included in the coagulant formulation and the remainder is added to nitrile. Specifically, a third or half of the required amount of KOH may be included in the coagulant formulation and the remaining amount may be included in the nitrile. Such a method minimises the amount of reaction time between KOH and other coagulant ingredients.

In an alternative, the coagulant may include potassium carbonate in the coagulant tank with some water (e.g. 5% as potassium carbonate (K₂CO₃) is also insoluble in ethanol), while the water-based nitrile tank includes Ca(OH)₂—Ca(OH)₂ has suitable solubility in water. Alternatively, the coagulant may include Ca(OH)₂ in the coagulant tank, while the nitrile tank includes K₂CO₃. In this way, KOH may be prepared by the reaction between CaOH₂ and K₂CO₃, with the end products being KOH and calcium carbonate (CaCO₃).

The coagulant formulation of the invention is particularly suitable for use in the forming of synthetic and natural polymers, both elastic and inelastic, especially in the dipping processes as described herein. Examples of synthetic and natural elastic (elastomeric, rubber) polymers include latex, nitrile, vinyl and/or nitrile/vinyl. Examples of synthetic inelastic polymers include poly(vinyl chloride) (PVC), polyethylene terephthalate (PET), polypropylene (PP), polyethylene (PE), polylactic acid (PLA), polycaprolactone (PCL), Polytetrafluoroethylene (PTFE), polyamide (PA), and polyurethane (PU). Examples of natural inelastic polymers include biopolymers such as polysaccharides (such as starch, chitosan and cellulose), gelatin, silk and collagen. For the avoidance of doubt, the term “nitrile” encompasses nitrile butadiene rubber, NBR, Buna-N, and acrylonitrile butadiene rubber.

Manufacture of the formable materials may be by any suitable method, including the commercial and well-known method illustrated in FIG. 1. The design of manufacturing processes is driven by the desired results, cost and time. In some situations, a single coagulant layer may be required, but in others, different layers imparting different properties to the formable material may be required. For example, an insulating layer may be required on the outer surface of the formable material, or additional coatings may be required to add or increase certain functionalities such as antimicrobial properties. Layer-by-layer forming methods such as the ones described herein require the use of two-, three- or four-tank dipping methods.

Accordingly, in a second aspect, the present invention encompasses a method for producing a formable material in which the method comprising the steps of:
a) dipping a former in a coagulant formulation to produce a coagulant-dipped former,
b) drying and pre-polymerising the dipped former to produce a dried coagulant-dipped former,
c) cooling the dried coagulant-dipped former to around 25° C.,
d) dipping the dried coagulant-dipped former in a solution comprising an elastic polymer to produce a coated former, and
e) curing and vulcanising the coated former,
   wherein the coagulant formulation is a coagulant formulation as defined and described herein.

Coagulant dipping is the first step in the manufacture of elastic (“rubber”) materials, such as latex, nitrile, vinyl and/or nitrile/vinyl, meaning that the coagulation layer will be then exposing the outside layer of the material once cured and removed from formers.

In a particular embodiment, the former may be dipped in coagulant formulation for between about 10 seconds and up to about 5 minutes. Suitable time periods may be about 1 second, 30 seconds, about 1 minute, about 2 minutes, about 3 minutes, about 4 minutes, or about 5 minutes. This time period is termed the “dwell” time and it influences the thickness of the material. A suitable temperature for dipping is room temperature, for example around 25° C. Dipping temperatures of between about 25° C. and 40° C. may also be suitable.

In a particular embodiment, the coagulant-dipped former from step a) may be dried for between about 10 seconds and about 20 minutes. Suitable time periods may be 1 second, 30 seconds, about 1 minute, about 5 minutes, about 10 minutes or about 15 minutes. Without wishing to be bound by theory, a pre-polymerisation of the ionophore/carrier polymer occurs as double bonds of the polymer are radicalised and made ready to participate in the vulcanisation in step e). By “radicalised” it means the functional group, which is now attached to the polymeric ionophore, has the capability to be polymerised. During the controlled heating (in terms of temperature and duration), this functional group is partially polymerised (under a radical thermal polymerisation reaction) to enable the polymeric ionophore to participate in the final vulcanisation step and to form a covalent bond between ionophore polymer and the polymer substrate.

A suitable temperature for drying may be around 100° C.

Optionally, the dried coagulant-dipped former may be pre-dipped one or more further times in an additional formulation. The additional formulation may comprise ingredients to impart functionality, such as insulation, to the resulting material, wherein the first additional layer comprises an antimicrobial agent. The former is dried after each additional dipping step.

Examples of suitable antimicrobial agents include non-biological antimicrobial agents such as a disinfectant, a cleaning and/or sanitising agent, a bleach, an alcohol, an oxidant, a weak acid, and combinations thereof. Particular examples of such agents include electrolysed water, hypochlorous acid, a metal oxide, a poloxamer, a quaternary ammonium salt, fluoride ions, chitosan, poly(hexamethylene guanidine) (PHMG), carnosol, alpha-tocopherol, glutaraldehyde, hyaluronic acid, citric acid, acetic acid, an alcohol, chlorhexidine digluconate, and combinations thereof.

The additional layers may have the same or different formulations. In addition, the time and temperature for dipping may be the same or different between layers. Additionally, the layers may or may not be dried in between, at the same or different temperatures and/or for the same or different periods of time.

In a particular embodiment, the dried coagulant-dipped former may be dipped in the elastic polymer solution for between about 10 seconds and about 5 minutes. Suitable time periods may be 1 second, 30 seconds, about 2 minutes or between about 3 minutes and about 5 minutes. A suitable temperature for dipping is room temperature, such as about 25° C.

In a particular embodiment, the coated former from step c) may be cured and vulcanised for between about 6 minutes and about 20 minutes. Suitable time periods may be about 6 minutes, about 15 minutes or about 20 minutes. A suitable temperature for curing and vulcanisation may be between about 90° C. and about 130° C. Temperatures of about 90° C., between about 100° C. to about 125° C., or about 130° C. have been found to be suitable.

In a yet further embodiment, the method may further include a pre-step in which the former is heated before being dipped in coagulant formulation. In a particular example, the former may be heated for about 30 seconds to about 10 minutes. A suitable temperature has been found to be around 100° C.

In a particular embodiment, the formable material and former are for the manufacture of a glove, optionally a disposable glove.

Also described herein are methods for producing the coagulant formulations described herein. For example, one method comprises the steps of:
a) Dissolving an amount of a polymeric ionophore in a solvent;
b) Adding an amount of a functionaliser to form a first mixture;
c) Once both the polymeric ionophore and functionaliser are completely dissolved, adding an amount of a positive ion in the form of a salt and an amount of an anti-tack agent to form a second mixture.

The method may further include the step of adding an amount of an antimicrobial agent to the solvent in step a) before the polymeric ionophore.

In a particular example, a part of the amount of antimicrobial agent may be added to the solvent before step a) and the remainder of the amount is added in step c).

In an additional or alternative example, the method may further include adding in step c) one or more components that dissolve Ca(OH)₂.

The present invention will now be described in more detail with reference to the following non-limiting examples and figures, in which:

FIG. 1: A schematic diagram illustrating the manufacturing steps for the fabrication of nitrile gloves published by Ansell Ltd.

FIG. 2: Antiviral effect of a coagulant formulation including ethyl cellulose. FIG. 2A: Antiviral activity of test samples with a 1 min contact time in which the y axis is the viral log reduction and the X axis is the sample number. FIG. 2B: Antibacterial activity of test samples in 1 min contact time in which the y axis is the bacterial log reduction and the x axis is the sample number. MHV: murine hepatitis virus. PG: Commercially available glove (purple colour).

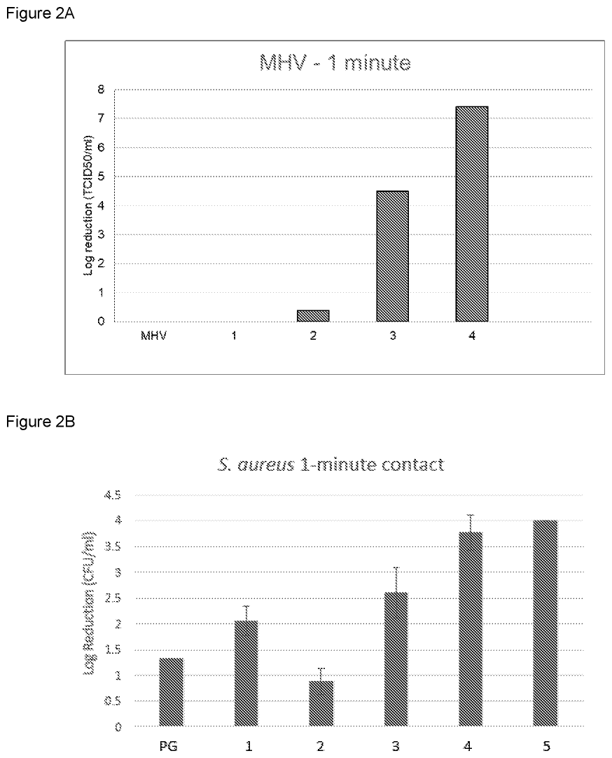

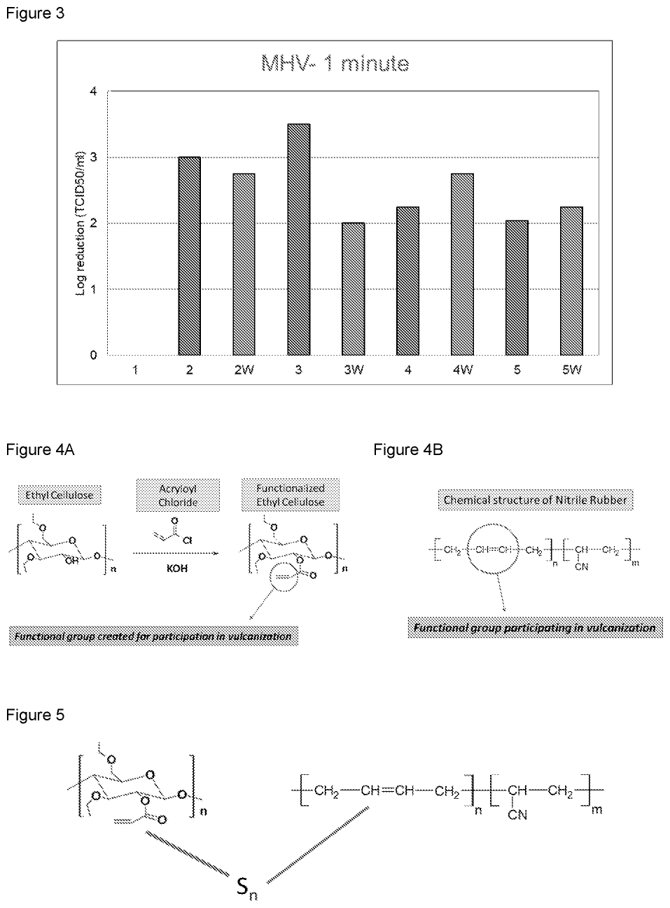

FIG. 3: Effect of plasticiser in formulation. Antiviral activity of washed and unwashed test samples in 1 min contact time. W: Samples washed with water before testing. Washing was performed by immersing samples into water at 40° C. for 5 mins with gentle agitation at 100 rpm. MHV: murine hepatitis virus.

FIG. 4: FIG. 4A: Reaction of EC with Acryloyl Chloride (AC) through an esterification process in the presence of a basic agent such as potassium hydroxide (KOH) or Triethanolamine (TEA). The product is ethyl cellulose with functional groups available for participation in the vulcanisation reaction. FIG. 4B: Chemical structure of nitrile and illustration of the existing functional groups for participation in the vulcanisation reaction.

FIG. 5: Illustration of how functional groups of nitrile and functionalised EC can participate in a vulcanisation reaction in the presence of vulcanisation agents such as sulphur.

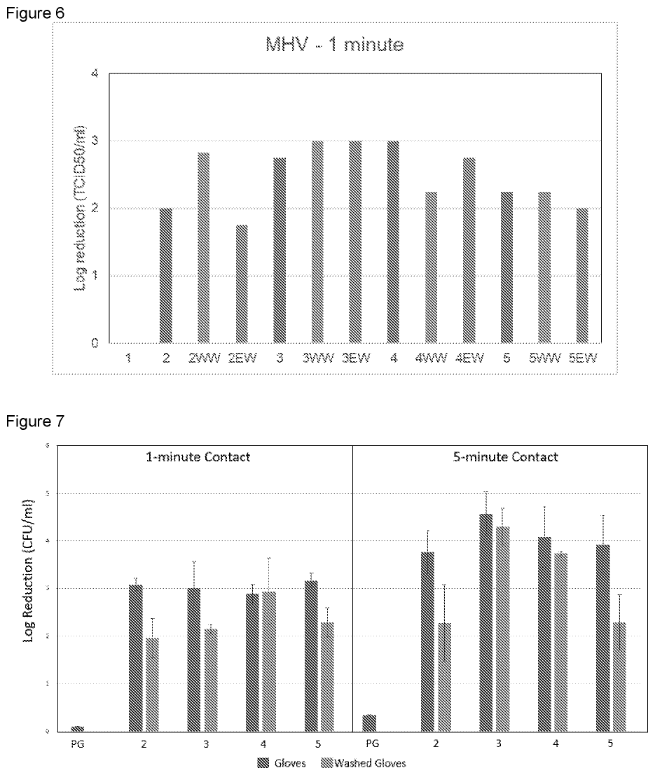

FIG. 6: Effect on EC functionalisation on antiviral activity after 1 min contact time. Samples were also tested after washing with either water (WW) or ethanol (EW). Washing was performed by immersing samples into either water (at 40° C.) or ethanol for 5 mins with gentle agitation at 100 rpm.

FIG. 7: Effect on EC functionalisation on antibacterial activity against S. aureus after 1 min and 5 min contact times. Samples were also tested after washing with water (immersing in 40° C. water for 5 min with gentle agitation at 100 rpm).

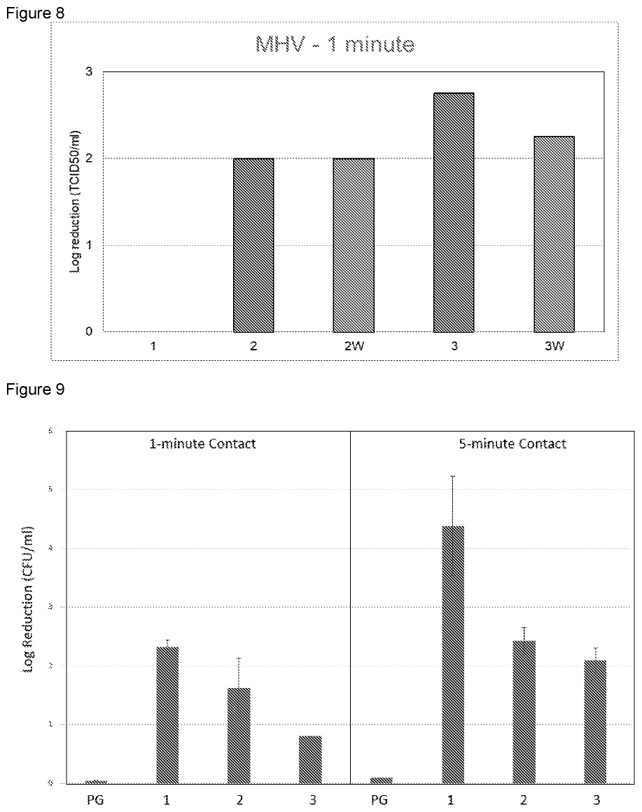

FIG. 8: Effect of additional positively charged ions on the antiviral activity in test samples with 1 min contact time. Samples were also tested after washing with water (immersing in 40° C. water for 5 min with gentle agitation at 100 rpm).

FIG. 9: Effect of additional positively charged ions to antibacterial activity against S. aureus in test samples with a 1 min or 5 min coagulant formulation contact time.

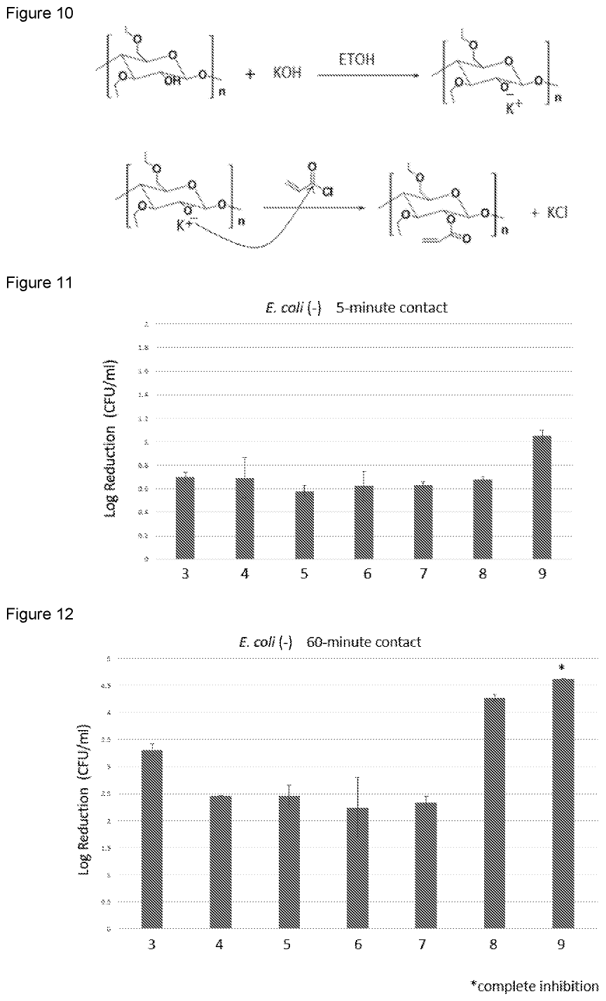

FIG. 10: Schematic representation of the chemical reaction between ethyl cellulose and acryloyl chloride as a functionaliser.

FIG. 11: Antibacterial effect of nitrile materials manufactured using coagulant formulations of the present invention on the growth of E. coli. Exposure to bacteria was 5 minutes. X-axis is sample number in which: Sample 3=0.5% EC+14% CN+1.8% CS+0.5% Acryloyl chloride (AC)+1.5% KOH+0.5% Al(NO₃)₃+100 ml EtOH; Sample 4=0.5% EC+14% CN+1.8% CS+0.5% AC+1.5% KOH+0.5% Al(NO₃)₃+1% EDTA+100 ml EtOH; Sample 5=0.5% EC+14% CN+1.8% CS+0.5% AC+1.5% KOH+0.5% Al(NO₃)₃+1% Citric acid+100 ml EtOH; Sample 6=0.5% EC+14% CN+1.8% CS+0.5% AC+1.5% KOH+0.5% Al(NO₃)₃+20 kppm HOCl+100 ml EtOH; Sample 7=0.5% EC+14% CN+1.8% CS+0.5% AC+1.5% KOH+0.5% Al(NO₃)₃+1% DA+100 ml EtOH; Sample 8=0.5% EC+14% CN+1.8% CS+0.5% AC+4% KOH+0.5% Al(NO₃)₃+100 ml EtOH; and Sample 9=0.5% EC+14% CN+1.8% CS+0.5% AC+8% KOH+0.5% Al(NO₃)₃+100 ml EtOH.

FIG. 12: Antibacterial effect of nitrile materials manufactured using coagulant formulations of the present invention on the growth of E. coli. Exposure to bacteria was 60 minutes. X-axis is sample number as per FIG. 11.

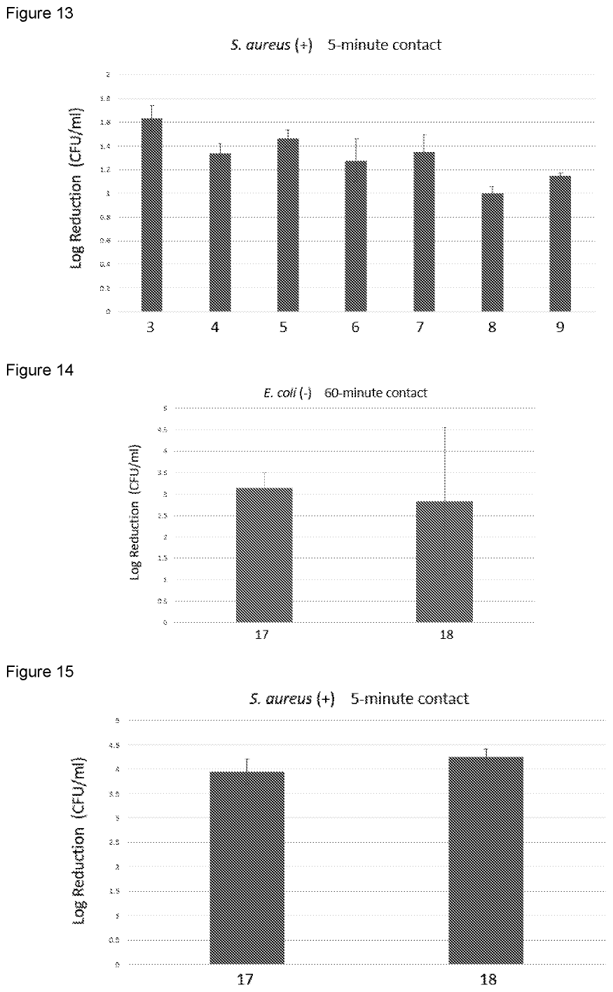

FIG. 13: Antibacterial effect of nitrile materials manufactured using coagulant formulations of the present invention on the growth of S. aureus. Exposure to bacteria was 5 minutes. X-axis is sample number as per FIG. 11.

FIG. 14: Antibacterial effect of nitrile materials manufactured using coagulant formulations of the present invention including eugenol on the growth of E. coli. Exposure to bacteria was 60 minutes. X-axis is sample number in which: sample 17=0.5% HPC+14% CN+1.8% CS+0.5% acryloyl chloride+4% KOH+0.5% Al(NO₃)₃+1% Eugenol+100 ml EtOH; sample 18=0.5% EC+14% CN+1.8% CS+0.5% AC+4% KOH+0.5% Al(NO₃)₃+1% Eugenol+100 ml EtOH.

FIG. 15: Antibacterial effect of nitrile materials manufactured using coagulant formulations of the present invention including eugenol on the growth of S. aureus. Exposure to bacteria was 5 minutes. X-axis is sample number as per FIG. 14.

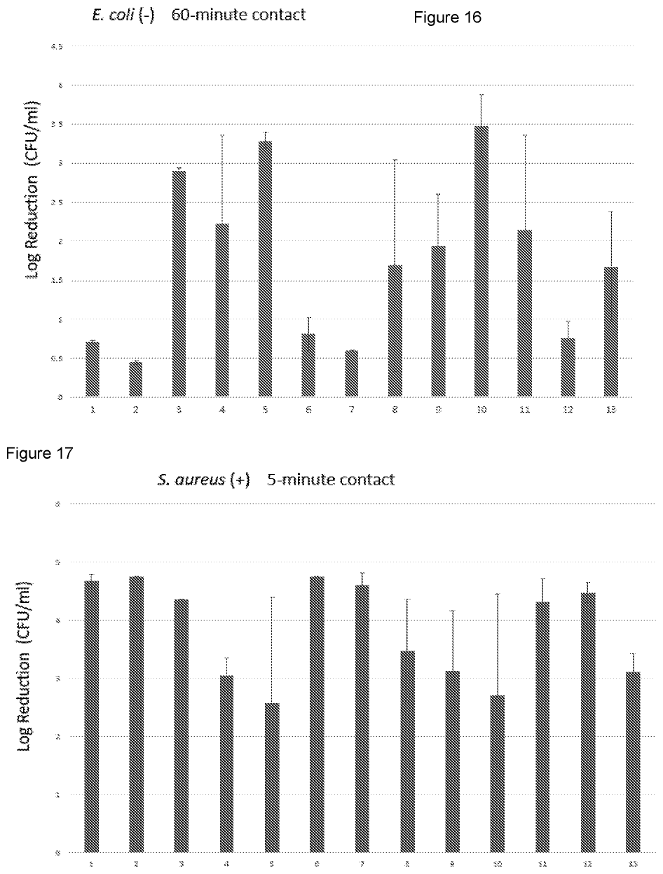

FIG. 16: Antibacterial effect of nitrile materials manufactured using coagulant formulations of the present invention on the growth of E. coli. Exposure to bacteria was 60 minutes. X-axis is sample number: Sample 1=0.5% EC+14% CN+1.8% CS+0.5% AC+2% KOH+100 ml EtOH; Sample 2=0.5% EC+14% CN+1.8% CS+0.5% AC+2% KOH+0.5% Al(NO₃)₃+100 ml EtOH; Sample 3=0.5% EC+14% CN+1.8% CS+0.5% AC+5% KOH+100 ml EtOH; Sample 4=0.5% EC+14% CN+1.8% CS+0.5% AC+5% KOH+0.5% Al(NO₃)₃+100 ml EtOH; Sample 5=0.5% EC+14% CN+1.8% CS+0.5% AC+5% KOH+1% NaOH+100 ml EtOH; Sample 6=0.4% HPC+0.1% EC+14% CN+1.8% CS+0.5% AC+2% KOH+100 ml EtOH; Sample 7=0.4% HPC+0.1% EC+14% CN+1.8% CS+0.5% AC+2% KOH+0.5% Al(NO3)3+100 ml EtOH; Sample 8=0.4% HPC+0.1% EC+14% CN+1.8% CS+0.5% Acryloyl chloride+5% KOH+100 ml EtOH; Sample 9=0.4% HPC+0.1% EC+14% CN+1.8% CS+0.5% AC+5% KOH+0.5% Al(NO₃)₃+100 ml EtOH; Sample 10=0.4% HPC+0.1% EC+14% CN+1.8% CS+0.5% AC+5% KOH+1% NaOH+100 ml EtOH; Sample 11=0.4% HPC+0.1% EC+14% CN+1.8% CS+0.5% AC+5% KOH+1% Eugenol+100 ml EtOH; Sample 12=0.4% Branched Polyethylenimine+0.1% EC+14% CN+1.8% CS+0.1% AC+2% KOH+100 ml EtOH; Sample 13=0.4% Branched Polyethylenimine+0.1% EC+14% CN+1.8% CS+0.1% AC+5% KOH+100 ml EtOH.

FIG. 17: Antibacterial effect of nitrile materials manufactured using coagulant formulations of the present invention on the growth of S. aureus. Exposure to bacteria was 5 minutes. X-axis is sample number as per FIG. 16.

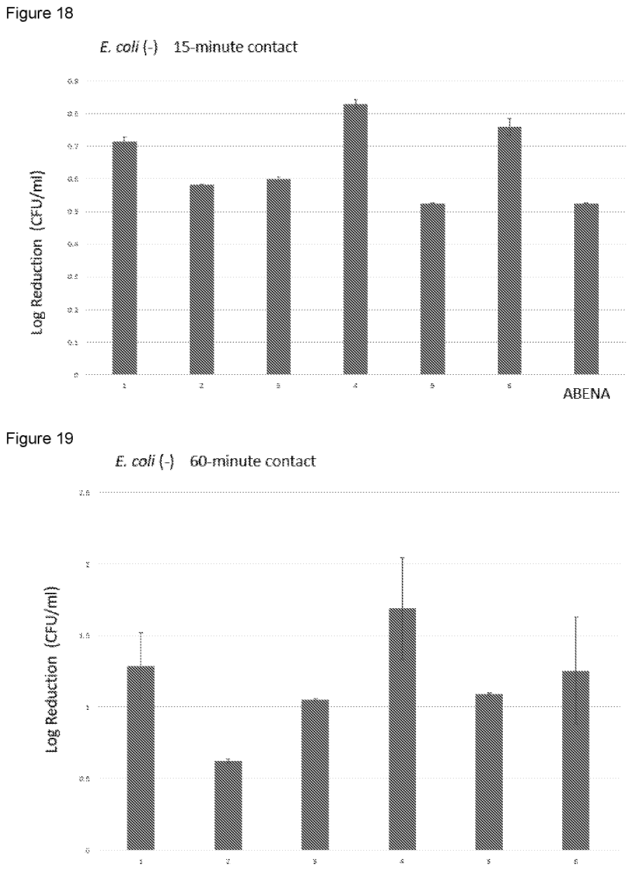

FIG. 18: Antibacterial effect of nitrile materials manufactured using coagulant formulations of the present invention on the growth of E. coli. Exposure to bacteria was 15 minutes. X-axis is sample number: Sample 1=0.5% EC+14% CN+1.8% CS+0.5% AC+2% KOH+100 ml EtOH; Sample 2=0.5% HPC+14% CN+1.8% CS+1% AC+2% KOH+100 ml EtOH; Sample 3=0.5% Polyethylenimine, branched+14% CN+1.8% CS+1% AC+2% KOH+100 ml EtOH; Sample 4=0.5% EC+14% CN+1.8% CS+0.5% AC+5% KOH+100 ml EtOH; Sample 5=0.5% HPC+14% CN+1.8% CS+1% AC+5% KOH+100 ml EtOH; Sample 6=0.5% Polyethylenimine, branched+14% CN+1.8% CS+1% AC+5% KOH+100 ml EtOH; ABENA=antimicrobial glove obtained from Hartalega Holdings Berhad, used as a control.

FIG. 19: Antibacterial effect of nitrile materials manufactured using coagulant formulations of the present invention on the growth of E. coli. Exposure to bacteria was 60 minutes. X-axis shows sample number as per FIG. 18.

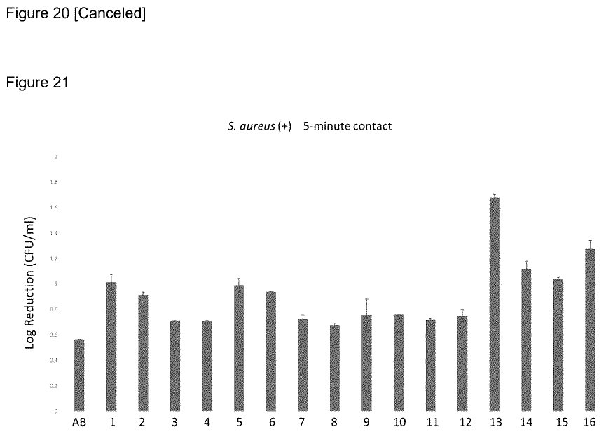

FIG. 20: Deleted

FIG. 21: Antibacterial effect of nitrile materials manufactured using coagulant formulations of the present invention on the growth of S. aureus. Bacterial log reduction (y-axis) is plotted against sample number (x-axis): The sample formulations were: Sample 1=0.5% EC+14% CN+1.8% CS+0.5% Acryloyl chloride+4% KOH+0% water+100 ml EtOH, 5 min drying time of coagulant; Sample 2=0.5% EC+14% CN+1.8% CS+0.5% AC+4% KOH+5% water+95 ml EtOH, 5 min drying time of coagulant; Sample 3=0.5% EC+14% CN+1.8% CS+0.5% AC+4% KOH+0.5% Al(NO₃)₃+0% water+100 ml EtOH, 5 min drying time of coagulant; Sample 4=0.5% EC+14% CN+1.8% CS+0.5% AC+4% KOH+0.5% Al(NO₃)₃+5% water+95 ml EtOH, 5 min drying time of coagulant; Sample 5=0.5% EC+14% CN+1.8% CS+0.5% AC+4% KOH+0% water+100 ml EtOH, 15 min drying time of coagulant; Sample 6=0.5% EC+14% CN+1.8% CS+0.5% AC+4% KOH+5% water+95 ml EtOH, 15 min drying time of coagulant; Sample 7=0.5% EC+14% CN+1.8% CS+0.5% AC+4% KOH+0.5% Al(NO₃)₃+0% water+100 ml EtOH, 15 min drying time of coagulant; Sample 8=0.5% EC+14% CN+1.8% CS+0.5% AC+4% KOH+0.5% Al(NO₃)₃+5% water+95 ml EtOH, 15 min drying time of coagulant; Sample 9=0.5% EC+14% CN+1.8% CS+0.5% AC+6% KOH+0% water+100 ml EtOH, 5 min drying time of coagulant; Sample 10=0.5% EC+14% CN+1.8% CS+0.5% AC+6% KOH+5% water+95 ml EtOH, 5 min drying time of coagulant; Sample 11=0.5% EC+14% CN+1.8% CS+0.5% AC+6% KOH+0.5% Al(NO₃)₃+0% water+100 ml EtOH, 5 min drying time of coagulant; Sample 12=0.5% EC+14% CN+1.8% CS+0.5% AC+6% KOH+0.5% Al(NO₃)₃+5% water+95 ml EtOH, 5 min drying time of coagulant; Sample 13=0.5% EC+14% CN+1.8% CS+0.5% AC+6% KOH+0% water+100 ml EtOH, 15 min drying time of coagulant; Sample 14=0.5% EC+14% CN+1.8% CS+0.5% AC+6% KOH+5% water+95 ml EtOH, 15 min drying time of coagulant; Sample (15) Codikoat Coagulant (0.5% EC+14% CN+1.8% CS+0.5% AC+4% KOH+0.5% Al(NO₃)₃+0% water+100 ml EtOH), 15 min drying time of coagulant; Sample 16=0.5% EC+14% CN+1.8% CS+0.5% AC+6% KOH+0.5% Al(NO₃)₃+5% water+95 ml EtOH, 15 min drying time of coagulant. AB=ABENA branded antimicrobial glove obtained from Hartalega Holdings Berhad, used as a control.

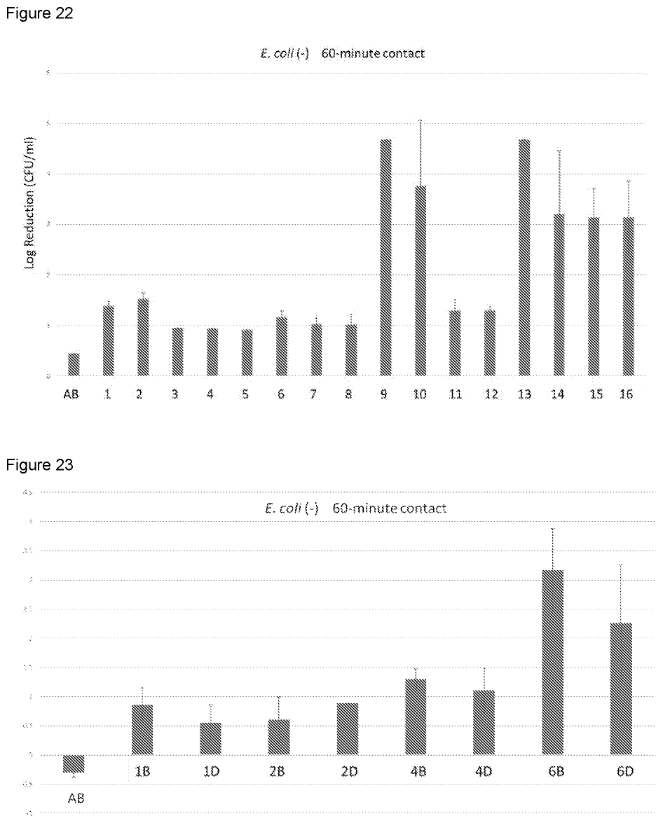

FIG. 22: Antibacterial effect of nitrile materials manufactured using coagulant formulations of the present invention on the growth of E. coli. Exposure to bacteria was 60 minutes. X-axis shows sample number as per FIG. 21.

FIG. 23: Antibacterial effect of nitrile materials manufactured using coagulant formulations of the present invention on the growth of E. coli. Exposure to bacteria was 60 minutes.

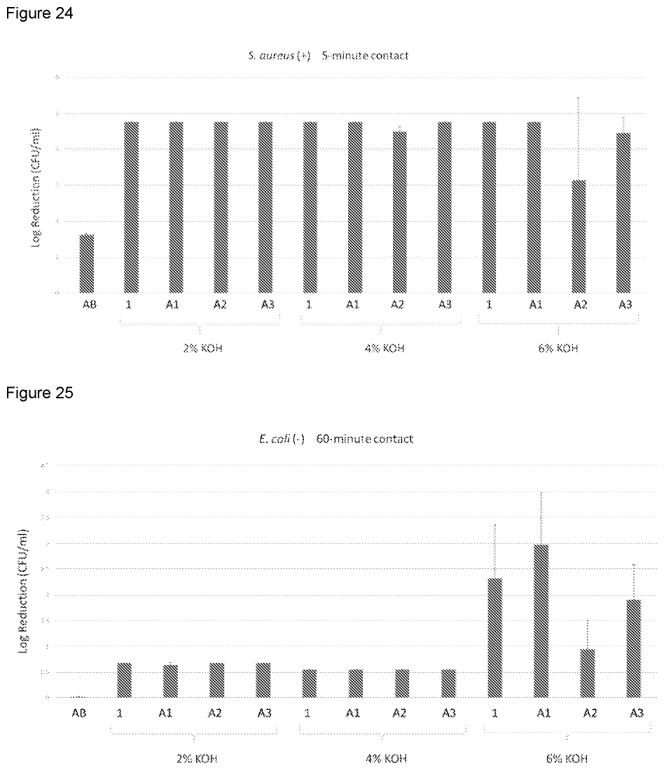

FIG. 24: Antibacterial effect of nitrile materials manufactured using coagulant formulations of the present invention including varying concentrations of KOH on the growth of S. aureus.

FIG. 25: Antibacterial effect of nitrile materials manufactured using coagulant formulations of the present invention including varying concentrations of KOH and fresh batches of nitrile compound on the growth of E. coli.

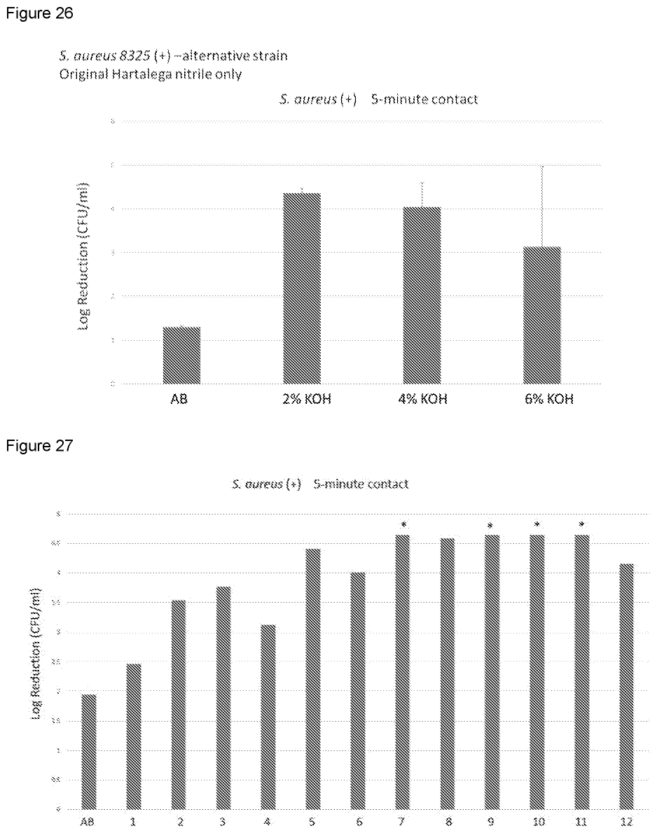

FIG. 26: Antibacterial effect of nitrile materials manufactured using coagulant formulations of the present invention including varying concentrations of KOH and a previous batch of nitrile compound on the growth of S. aureus strain 8325.

FIG. 27: Antibacterial effect of nitrile materials manufactured using coagulant formulations of the present invention on the growth of S. aureus. Exposure to bacteria was 5 minutes.

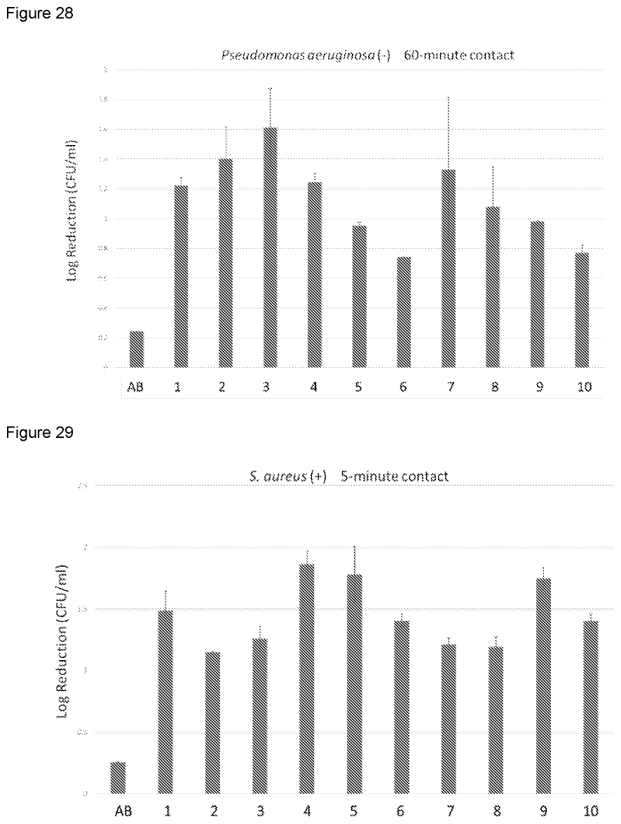

FIG. 28: Antibacterial effect of nitrile materials manufactured by a commercial manufacturing protocol and using coagulant formulations of the present invention on the growth of P. aeruginosa. Exposure to bacteria was 30 minutes. X-axis is sample number: Sample 1=0.5% EC+14% CN+1.8% CS+0.5% AC+2% KOH+100 ml EtOH, Method M; Sample 2=0.5% EC+14% CN+1.8% CS+0.5% AC+4% KOH+5% water+1% Glycerol+95 ml EtOH, Method M; Sample 3=0.5% EC+14% CN+1.8% CS+0.5% AC+6% KOH+5% water+1% Glycerol+95 ml EtOH, Method M; Sample 4=0.5% EC+14% CN+1.8% CS+0.5% AC+4% KOH+5% water+1% Glycerol+95 ml EtOH, Method O; Sample 5=0.5% EC+14% CN+1.8% CS+0.5% AC+6% KOH+5% water+1% Glycerol+95 ml EtOH, Method O; Sample 6=0.5% EC+14% CN+1.8% CS+0.5% AC+2% KOH+100 ml EtOH, Method M with [NAME REDACTED] protocol; Sample 7=0.5% EC+14% CN+1.8% CS+0.5% AC+4% KOH+5% water+1% Glycerol+95 ml EtOH, Method M with [NAME REDACTED] protocol; Sample 8=0.5% EC+14% CN+1.8% CS+0.5% AC+6% KOH+5% water+1% Glycerol+95 ml EtOH, Method M with [NAME REDACTED] protocol; Sample 9=0.5% EC+14% CN+1.8% CS+0.5% AC+4% KOH+5% water+1% Glycerol+95 ml EtOH, Method O with [NAME REDACTED] protocol; Sample 10=0.5% EC+14% CN+1.8% CS+0.5% AC+6% KOH+5% water+1% Glycerol+95 ml EtOH, Method O with [NAME REDACTED] protocol; ABENA=antimicrobial glove obtained from Hartalega Holdings Berhad, used as a control.

FIG. 29: Effect on antibacterial efficacy of different coagulant formulations and different methods of coagulant and glove preparation on gram-positive S. aureus tested with a 5 minute contact time. Sample 1: 0.5% EC+14% CN+1.8% CS+0.5% AC+2% KOH+100 ml EtOH, first coagulant method, C_Method for glove preparation; Sample 2: 0.5% EC+14% CN+1.8% CS+0.5% AC+4% KOH+5% water+1% Glycerol+95 ml EtOH first coagulant method, C_Method for glove preparation; Sample 3: 0.5% EC+14% CN+1.8% CS+0.5% AC+4% KOH+5% water+1% Glycerol+95 ml EtOH, first coagulant method, C_Method for glove preparation; Sample 4: 0.5% EC+14% CN+1.8% CS+0.5% Acryloyl chloride+6% KOH+5% water+1% Glycerol+95 ml EtOH, second coagulant method, C_Method for glove preparation; Sample 5: 0.5% EC+14% CN+1.8% CS+0.5% Acryloyl chloride+6% KOH+5% water+1% Glycerol+95 ml EtOH, second coagulant method, C_Method for glove preparation; Sample 6: 0.5% EC+14% CN+1.8% CS+0.5% AC+2% KOH+100 ml EtOH, first coagulant method, H_Method for glove preparation; Sample 7: 0.5% EC+14% CN+1.8% CS+0.5% AC+4% KOH+5% water+1% Glycerol+95 ml EtOH, first coagulant method, H_Method for glove preparation; Sample 8: 0.5% EC+14% CN+1.8% CS+0.5% AC+6% KOH+5% water+1% Glycerol+95 ml EtOH, first coagulant method, H_Method for glove preparation; Sample 9: 0.5% EC+14% CN+1.8% CS+0.5% AC+4% KOH+5% water+1% Glycerol+95 ml EtOH, second coagulant method, H_Method for glove preparation; Sample 10: 0.5% EC+14% CN+1.8% CS+0.5% AC+6% KOH+5% water+1% Glycerol+95 ml EtOH, second coagulant method, H_Method for glove preparation; AB=antimicrobial glove obtained from Hartalega Holdings Berhad, used as a control.

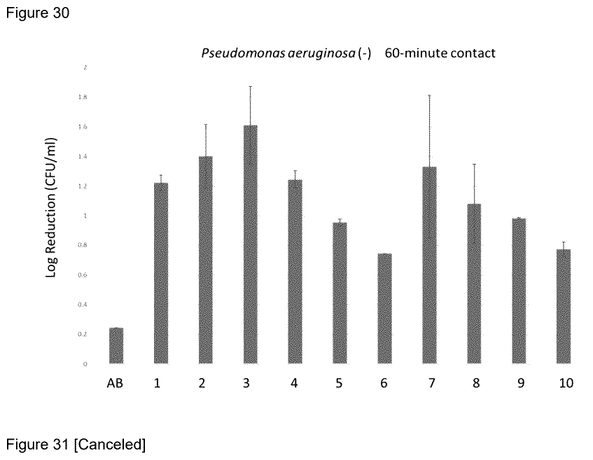

FIG. 30: Effect on antibacterial efficacy of different coagulant formulations and different methods of coagulant and glove preparation on gram-negative P. aeruginosa with a 60 minute contact time. Samples as per FIG. 29.

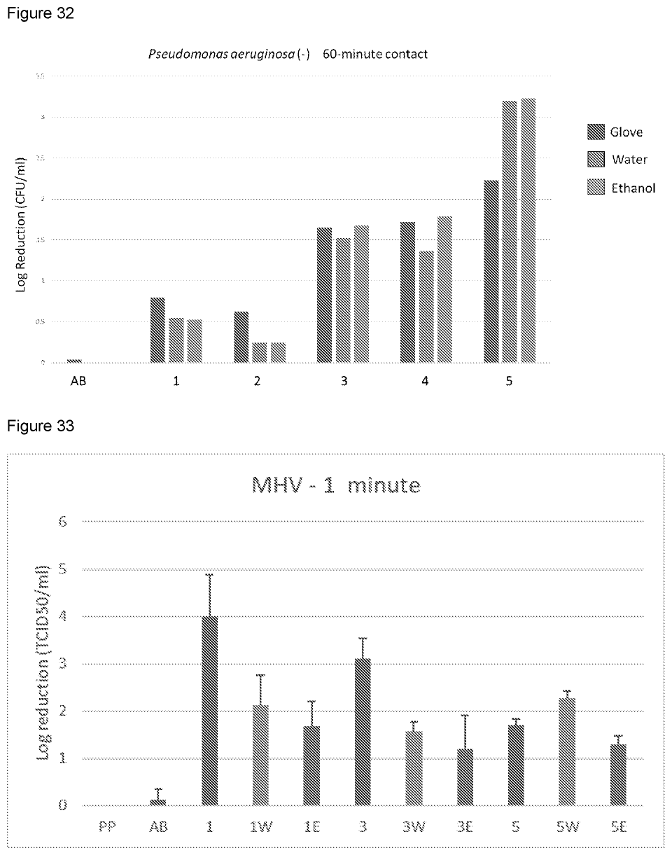

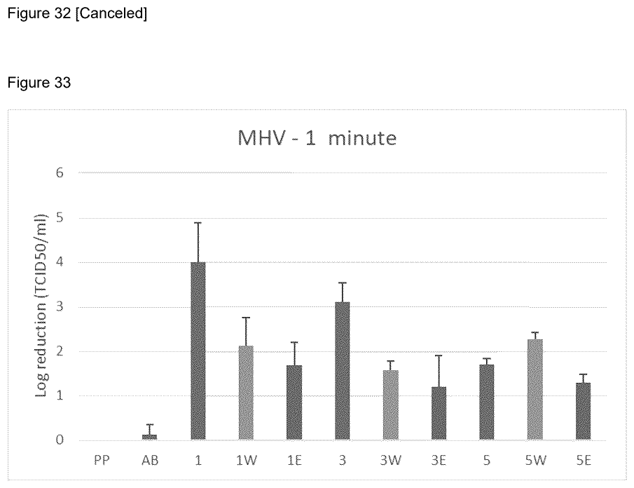

FIG. 31: Deleted FIG. 32: Deleted

FIG. 33: Effect of KOH concentration on antiviral efficacy. Coagulant formulations were prepared using two different methods and gloves were prepared using the C_Method. Sample 1: 0.5% EC+14% CN+1.8% CS+0.5% AC+2% KOH+100 ml EtOH, first coagulant preparation method, 1W=washed with water, 1E=washed with ethanol; Sample 3: 0.5% EC+14% CN+1.8% CS+0.5% AC+4% KOH+5% water+1% Glycerol+95 ml EtOH, first coagulant preparation method, 3W=washed with water, 3E=washed with ethanol; Sample 5: 0.5% EC+14% CN+1.8% CS+0.5% AC+6% KOH+5% water+1% Glycerol+95 ml EtOH, second coagulant preparation method, 5W=washed with water, 5E=washed with ethanol; PP=polypropylene film used as control; AB=antimicrobial glove obtained from Hartalega Holdings Berhad, used as a control.

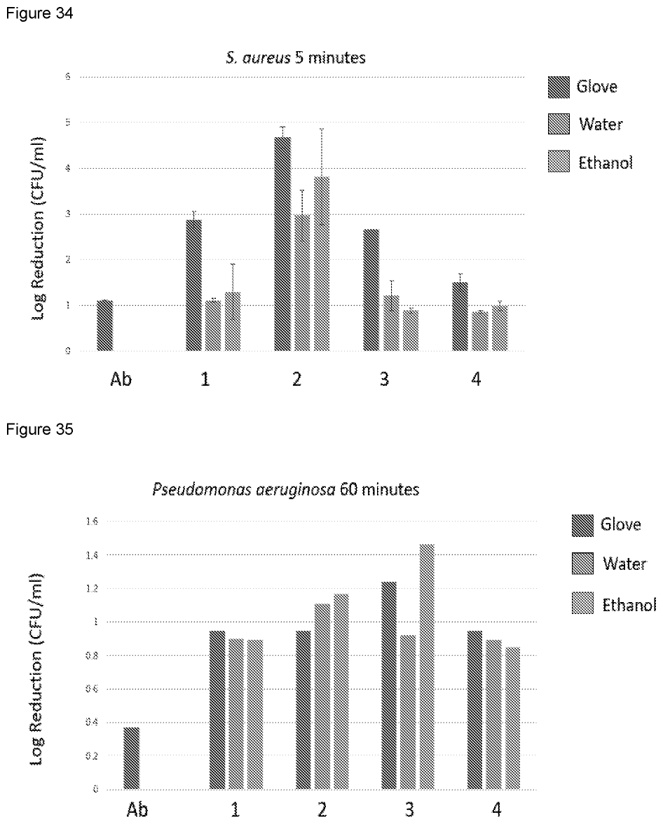

FIG. 34: Effect of the addition of glycerol to the coagulant formulation on retention of antibacterial efficacy against gram-positive P. aeruginosa (60 minute contact time) after washing. Coagulant formulations were prepared by the first method described and the gloves were prepared using the C_Method. Sample 1: 0.5% EC+14% CN+1.8% CS+0.5% AC+2% KOH+100 ml EtOH; Sample 2: 0.5% EC+14% CN+1.8% CS+0.5% AC+2% KOH+1% Glycerol+100 ml EtOH; Sample 3: 0.5% EC+14% CN+1.8% CS+0.5% AC+4% KOH+1% Glycerol+100 ml EtOH; Sample 4: 0.5% EC+14% CN+1.8% CS+0.5% AC+6% KOH+1% Glycerol+100 ml EtOH; AB=antimicrobial glove obtained from Hartalega Holdings Berhad, used as a control.

FIG. 35: Effect of the addition of glycerol to the coagulant formulation on retention of antibacterial efficacy against gram-negative S. aureus (5 minute contact time) after washing. Coagulant formulations were prepared by the first method described and the gloves were prepared using the C_Method. Samples as per FIG. 34.

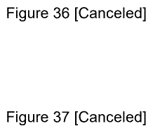

FIG. 36: Deleted.

FIG. 37: Deleted.

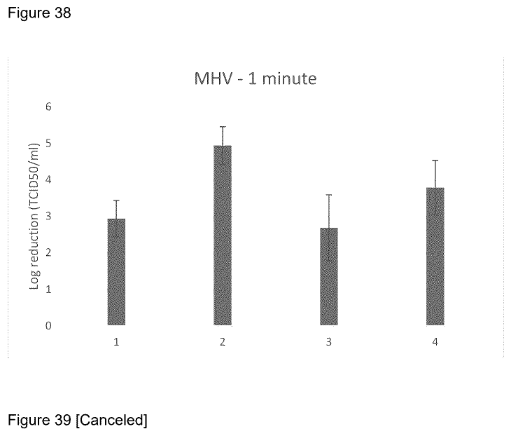

FIG. 38: Effect of the presence of Acryloyl chloride (AC) as a functionaliser on antiviral (MHV) activity. Samples are as per FIG. 36: Sample 1: 0.5% EC+14% CN+1.8% CS+0.5% AC+2% KOH+0.5% Glycerol+100 ml EtOH; Sample 2: 0.5% EC+14% CN+1.8% CS+2% KOH+0.5% Glycerol+100 ml EtOH; Sample 3: 0.5% EC+14% CN+1.8% CS+0.5% AC+2% KOH+1% Glycerol+100 ml EtOH; Sample 4: 0.5% EC+14% CN+1.8% CS+2% KOH+1% Glycerol+100 ml EtOH.

FIG. 39: Deleted.

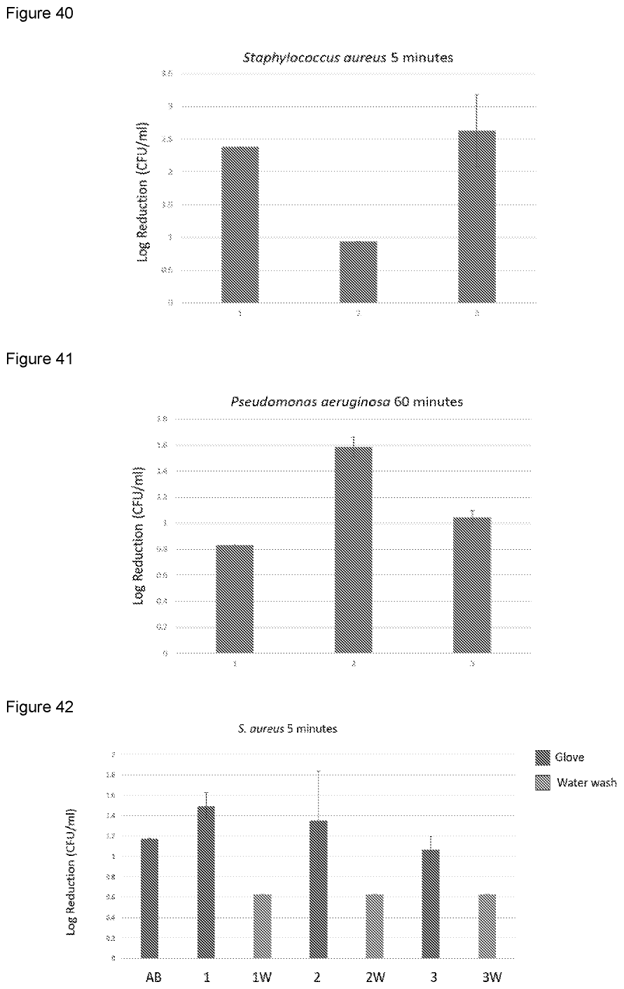

FIG. 40: Effect of a coagulant formulation including Ca(OH)₂ on gram-negative S. aureus (5 minute contact time) antibacterial activity. Sample 1: 0.5% EC+14% CN+1.8% CS+0.5% Acryloyl chloride+2% KOH+1% Glycerol+100 ml EtOH; Sample 2: 0.5% EC+0.5% AC+2% KOH+3% Ca(OH)₂₊₁% Glycerol+14% Ca(NO₃)₂+1.5% CS+95 ml Ethanol+5 ml water, Ca(OH)₂ was dissolved in water and glycerol and added in first step; Sample 3: 0.5% EC+0.5% AC+2% KOH+3% Ca(OH)₂₊₁% Glycerol+14% Ca(NO₃)₂+1.5% CS+95 ml Ethanol+5 ml water, Ca(OH)₂ was dissolved in water and glycerol and added in a second step.

FIG. 41: Effect of a coagulant formulation including Ca(OH)₂ on gram-positive P. aeruginosa (60 minute contact time). Samples are as per FIG. 40.

FIG. 42: Effects of different functionalisers on S. aureus (5 minute contact time) antibacterial efficacy after washing with water. Sample 1: 0.5% EC+14% CN+1.8% CS+2% KOH+0.5% Allyl glycydil ether+1% Glycerol+100 ml EtOH; Sample 2: 0.5% EC+14% CN+1.8% CS+2% KOH+0.5% methacrylate glycydil ether+1% Glycerol+100 ml EtOH; Sample 3: 0.5% EC+14% CN+1.8% CS+0.5% AC+2% KOH+1% Glycerol+100 ml EtOH; Sample 4: 0.5% EC+14% CN+1.8% CS+0.5% AC+4% KOH+2% Glycerol+5% Water+95 ml EtOH; AB=antimicrobial glove obtained from Hartalega Holdings Berhad, used as a control.

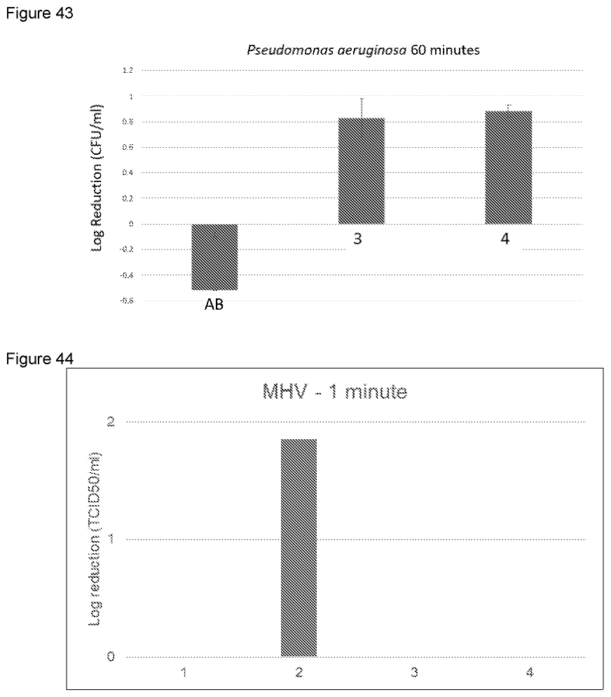

FIG. 43: Effect of increasing KOH concentration on gram-negative P. aeruginosa (60 minute contact time) activity. Sample 3: 0.5% EC+14% CN+1.8% CS+0.5% AC+2% KOH+1% Glycerol+100 ml EtOH; Sample 4: 0.5% EC+14% CN+1.8% CS+0.5% AC+4% KOH+2% Glycerol+5% Water+95 ml EtOH; AB=antimicrobial glove obtained from Hartalega Holdings Berhad, used as a control.

FIG. 44: Effect of an additional coagulant layer on antiviral activity in test samples.

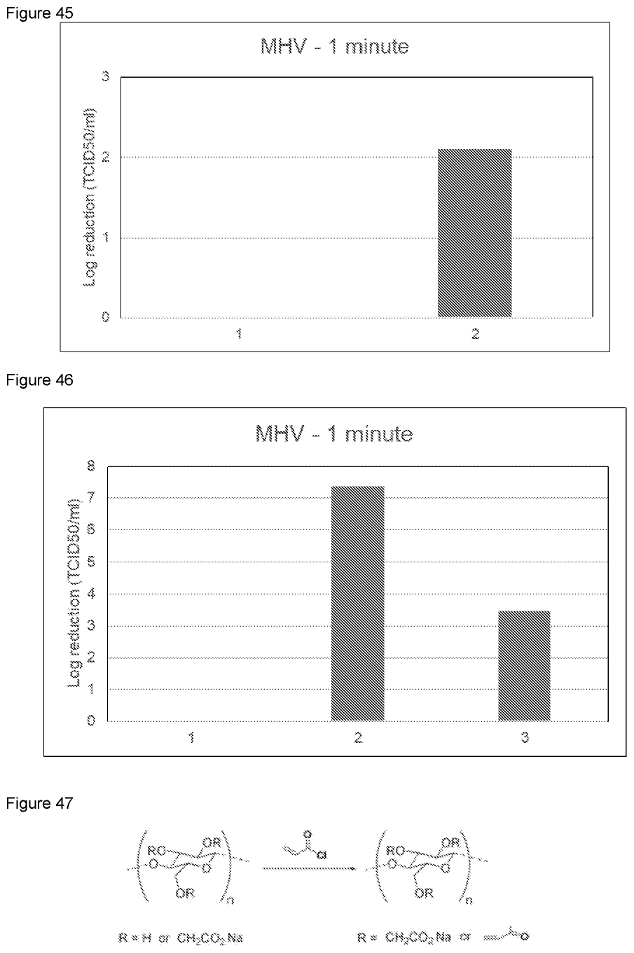

FIG. 45: Effect of two additional coagulant layers on antiviral activity in test samples.

FIG. 46: Effect of two ethanol-based coagulant layers on antiviral activity using a three-tank production method.

FIG. 47: The chemical reaction of Na-CMC with Acryloyl chloride to make functionalised Na-CMC.

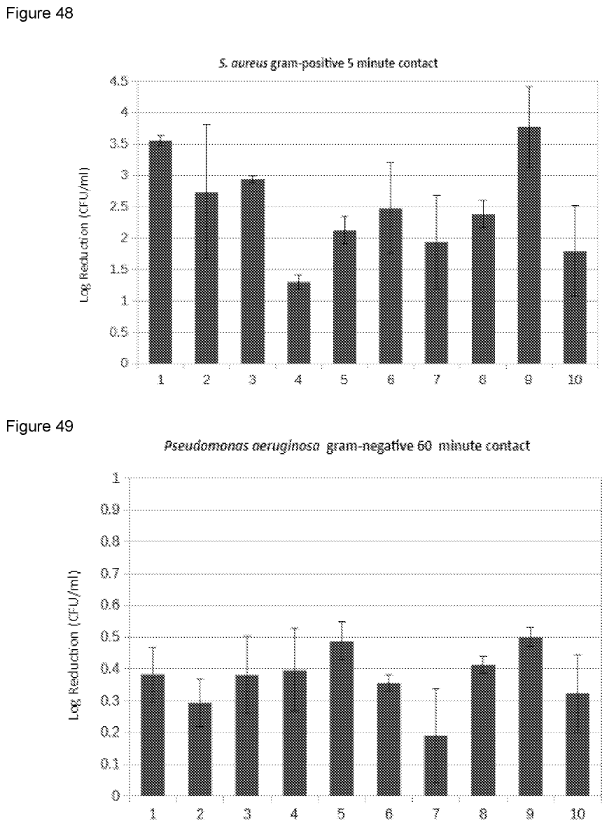

FIG. 48: The effect of curing time and temperature on antibacterial efficacy against S. aureus with a 5 minute contact time using a coagulant formulation including 2% KOH. Sample 1: 0.5% EC+0.5% AC+2% KOH+1.5% CS+14% CN+1% Glycerol+100 ml EtOH, 2 minute coagulant drying time at 100° C.; Sample 2: 0.5% EC+0.5% AC+2% KOH+0.7% CS+14% CN (+6% extra Water)+1% Glycerol+93 ml EtOH, 2 minute coagulant drying time at 100° C.; Sample 3: 0.5% EC+0.5% AC+2% KOH+1.5% CS+14% CN+1% Glycerol+100 ml EtOH, 2 minute coagulant drying time at 125° C.; Sample 4: 0.5% EC+0.5% AC+2% KOH+0.7% CS+14% CN (+6% extra Water)+1% Glycerol+93 ml EtOH, 2 minute coagulant drying time at 125° C.; Sample 5: 0.5% EC+0.5% AC+2% KOH+1.5% CS+14% CN+1% Glycerol+100 ml EtOH, 7 minute coagulant drying time at 100° C.; Sample 6: 0.5% EC+0.5% AC+2% KOH+0.7% CS+14% CN+1% Glycerol+93 ml EtOH, 7 minute coagulant drying time at 100° C.; Sample 7: 0.5% EC+0.5% AC+2% KOH+1.5% CS+14% CN+1% Glycerol+100 ml EtOH, 7 minute coagulant drying time at 125° C.; Sample 8: 0.5% EC+0.5% AC+2% KOH+0.7% CS+14% CN+1% Glycerol+93 ml EtOH, 7 minute coagulant drying time at 125° C.; Sample 9: 0.5% EC+0.5% AC+2% KOH+1.5% CS+14% CN+1% Glycerol+100 ml EtOH, 15 minute coagulant drying time at 100° C.; Sample 10: 0.5% EC+0.5% AC+2% KOH+0.7% CS+14% CN+1% Glycerol+93 ml EtOH, 15 minute coagulant drying time at 100° C.

FIG. 49: The effect of curing time and temperature on antibacterial efficacy against P. aeruginosa with a 60 minute contact time using a coagulant formulation including 2% KOH. Samples are as per FIG. 48.

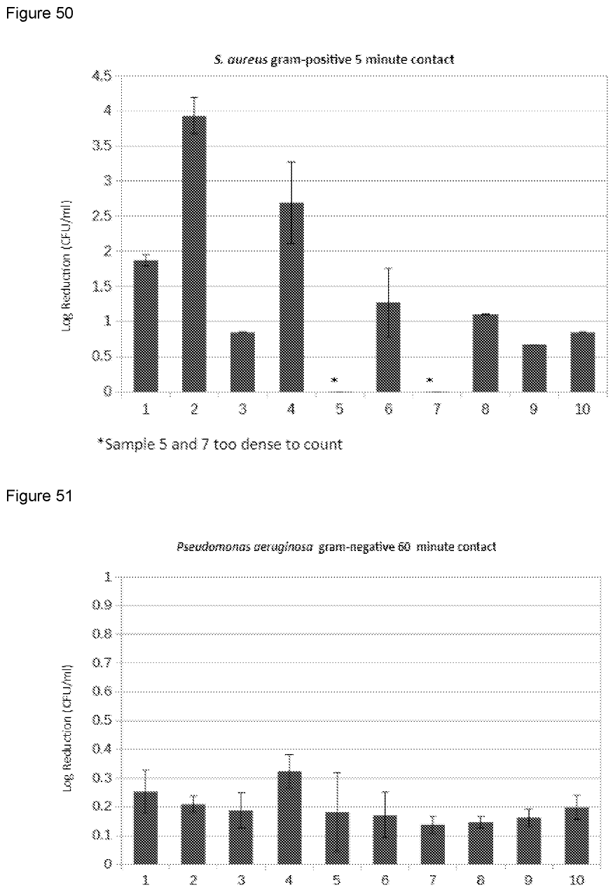

FIG. 50: The effect of curing time and temperature on antibacterial efficacy against S. aureus with a 5 minute contact time using a coagulant formulation including 4% KOH. Sample 1: 0.5% EC+0.5% AC+4% KOH+0.7% CS (+1.05% extra water)+14% CN (+6% extra water)+2% Glycerol+5% Water+88 ml EtOH, 2 minute coagulant drying time at 100° C.; Sample 2: 0.5% EC+0.5% AC+4% KOH+1.5% CS+14% CN+2% Glycerol+5% Water+95 ml EtOH, 2 minute coagulant drying time at 100° C.; Sample 3: 0.5% EC+0.5% AC+4% KOH+0.7% CS (+1.05% extra water)+14% CN (+6% extra water)+2% Glycerol+5% Water+88 ml EtOH, 2 minute coagulant drying time at 125° C.; Sample 4: 0.5% EC+0.5% AC+4% KOH+1.5% CS+14% CN+2% Glycerol+5% Water+95 ml EtOH, 2 minute coagulant drying time at 125° C.; Sample 5: 0.5% EC+0.5% AC+4% KOH+0.7% CS (+1.05% extra water)+14% CN (+6% extra water)+2% Glycerol+5% Water+88 ml EtOH, 7 minute coagulant drying time at 100° C.; Sample 6: 0.5% EC+0.5% AC+4% KOH+1.5% CS+14% CN+2% Glycerol+5% Water+95 ml EtOH, 7 minute coagulant drying time at 100° C.; Sample 7: 0.5% EC+0.5% AC+4% KOH+0.7% CS (+1.05% extra water)+14% CN (+6% extra water)+2% Glycerol+5% Water+88 ml EtOH, 7 minute coagulant drying time at 125° C.; Sample 8: 0.5% EC+0.5% AC+4% KOH+1.5% CS+14% CN+2% Glycerol+5% Water+95 ml EtOH, 7 minute coagulant drying time at 125° C.; Sample 9: 0.5% EC+0.5% AC+4% KOH+0.7% CS (+1.05% extra water)+14% CN (+6% extra water)+2% Glycerol+5% Water+88 ml EtOH, 15 minute coagulant drying time at 100° C.; Sample 10: 0.5% EC+0.5% AC+4% KOH+1.5% CS+14% CN+2% Glycerol+5% Water+95 ml EtOH, 15 minute coagulant drying time at 100° C.

FIG. 51: The effect of curing time and temperature on antibacterial efficacy against P. aeruginosa with a 60 minute contact time using a coagulant formulation including 4% KOH. Samples are as per FIG. 50.

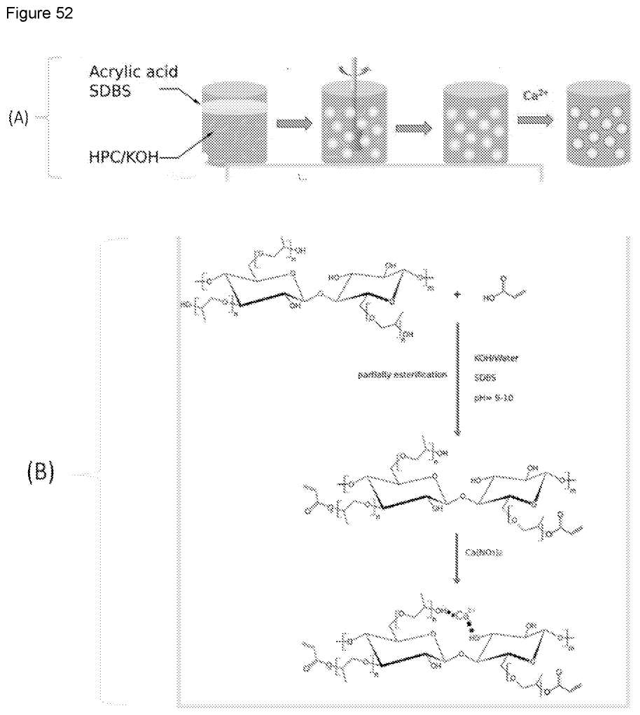

FIG. 52: FIG. 52A: schematic of the pre-microencapsulation process of a coagulant based on the coordination of deprotonated hydroxypropyl cellulose (HPC) in a microemulsion system.

FIG. 52B: Chemical reaction between HPC and acrylic acid (AAc) followed by cross-linking of HOC with Ca(NO₃)₂.

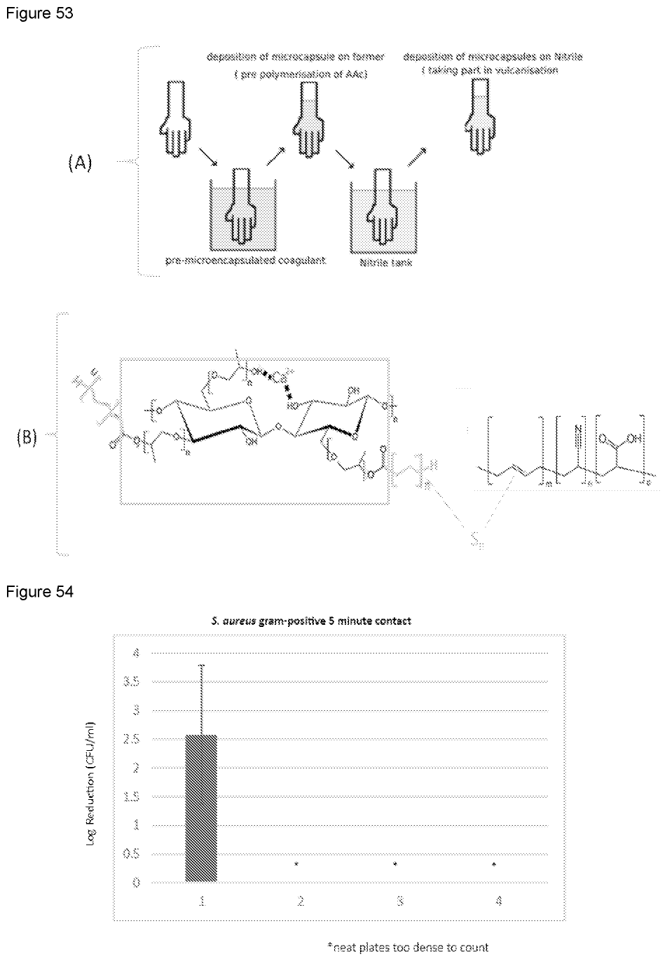

FIG. 53: FIG. 53A: schematic of the process of deposition of microcapsules on a former and nitrile during glove manufacturing. FIG. 53B: chemical reaction between microcapsules and nitrile.

FIG. 54: Effect of water-based coagulant formulations on S. aureus with a 5 minute contact time. The coagulants were dried for 2 minutes at 100° C. Sample 1: 0.5% HPC (Mw: 80 k)+4% KOH+2% Glycerol+0.5% CS (dispersion)+20% CN; Sample 2: 0.5% HPC (Mw: 80 k)+4% KOH+4% Glycerol+0.5% CS (dispersion)+20% CN; Sample 3: 0.5% HPC (Mw: 80 k)+6% KOH+2% Glycerol+0.5% CS (dispersion)+20% CN; Sample 4: 0.5% HPC (Mw: 80 k)+6% KOH+4% Glycerol+0.5% CS (dispersion)+20% CN.

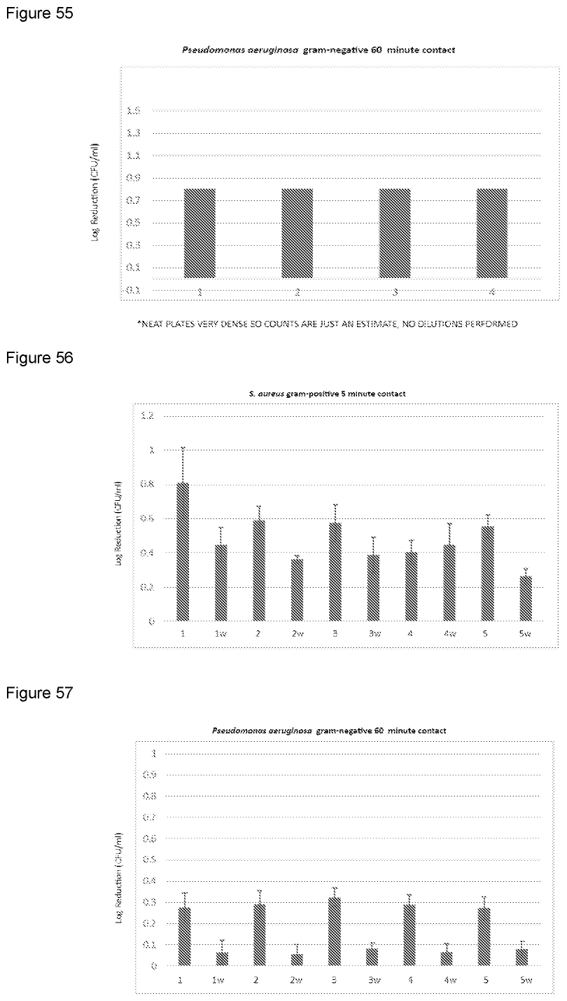

FIG. 55: Effect of water-based coagulant formulations on P. aeruginosa with a 60 minute contact time. The coagulants were dried for 2 minutes at 100° C. Samples were as per FIG. 54.

FIG. 56: Effect of washing (W) on antibacterial efficacy against S. aureus with a 5 minute contact time. The coagulants were dried for 2 minutes at 100° C. Sample 1: 0.5% HPC (Mw: 80 k)+2% KOH+1% Glycerol+0.5% CS (dispersion)+20% CN; Sample 2: 0.5% HPC (Mw: 80 k)+4% KOH+2% Glycerol+0.5% CS (dispersion)+20% CN; Sample 3: 0.5% HPC (Mw: 80 k)+4% KOH+4% Glycerol+0.5% CS (dispersion)+20% CN; Sample 4: 0.5% HPC (Mw: 80 k)+6% KOH+2% Glycerol+0.5% CS (dispersion)+20% CN; Sample 5: 0.5% HPC (Mw: 80 k)+6% KOH+4% Glycerol+0.5% CS (dispersion)+20% CN.

FIG. 57: Effect of washing (W) on antibacterial efficacy against P. aeruginosa with a 60 minute contact time. The coagulants were dried for 2 minutes at 100° C. Samples are as per FIG. 56.

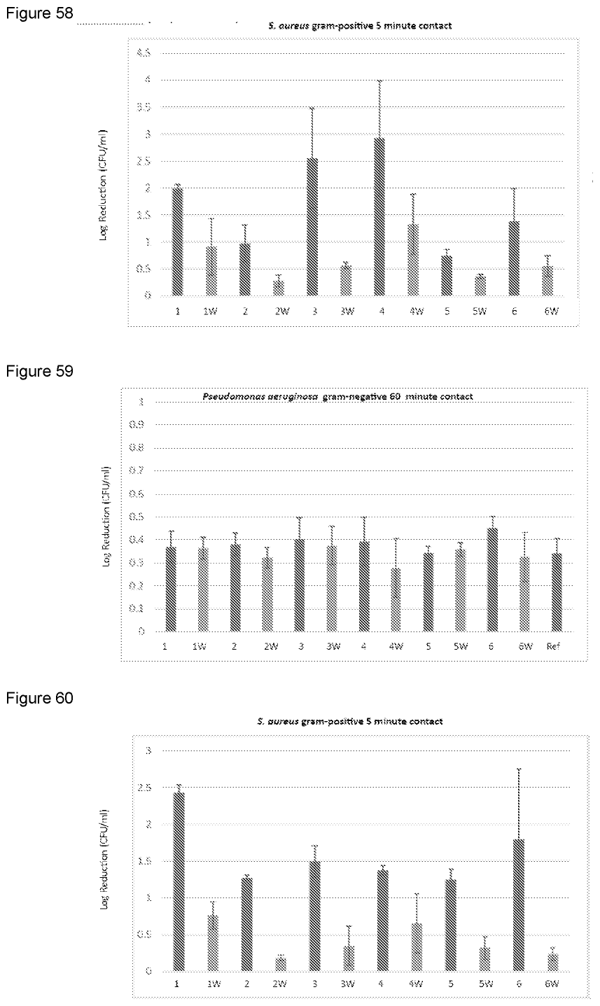

FIG. 58: Effect of changing glycerol concentration and coagulant drying temperature on antibacterial efficacy against S. aureus with a 5 minute contact time using a water-based coagulant including 0.5% HPC and 2% KOH. Sample 1: 0.5% HPC (Mw: 80 k), 2% KOH, 1% glycerol (gly), 0.5% AAc, 20% CNC, 0.5% CS, 0.01% SDBS, coagulant drying temperature 100° C.; Sample 2: 0.5% HPC (Mw: 80 k), 2% KOH, 1% gly, 0.5% AAc, 20% CNC, 0.5% CS, 0.01% SDBS, coagulant drying temperature 125° C.; Sample 3: 0.5% HPC (Mw: 80 k), 2% KOH, 1% gly, 0.5% AAc, 20% CNC, 0.5% CS, 0.01% SDBS, coagulant drying temperature 140° C.; Sample 4: 0.5% HPC (Mw: 80 k), 2% KOH, 2% gly, 0.5% AAc, 20% CNC, 0.5% CS, 0.01% SDBS, coagulant drying temperature 100° C.; Sample 5: 0.5% HPC (Mw: 80 k), 2% KOH, 2% gly, 0.5% AAc, 20% CNC, 0.5% CS, 0.01% SDBS, coagulant drying temperature 125° C.; Sample 6: 0.5% HPC (Mw: 80 k), 2% KOH, 2% gly, 0.5% AAc, 20% CNC, 0.5% CS, 0.01% SDBS, coagulant drying temperature 140° C.

FIG. 59: Effect of changing glycerol concentration and coagulant drying temperature on antibacterial efficacy against P. aeruginosa with a 60 minute contact time using a water-based coagulant including 0.5% HPC and 2% KOH. Samples as per FIG. 58.

FIG. 60: Effect of increasing KOH concentration against S. aureus with a 5 minute contact time. Sample 1: 0.5% HPC, 4% KOH, 2% glycerol (gly), 20% CNC, 0.5% CS, 0.01% SDBS, coagulant drying temperature 100° C.; Sample 2: 0.5% HPC, 4% KOH, 2% gly, 20% CNC, 0.5% CS, 0.01% SDBS, coagulant drying temperature 125° C.; Sample 3: 0.5% HPC, 4% KOH, 2% gly, 20% CNC, 0.5% CS, 0.01% SDBS, coagulant drying temperature 140° C.; Sample 4: 0.5% HPC, 4% KOH, 4% gly, 20% CNC, 0.5% CS, 0.01% SDBS, coagulant drying temperature 100° C.; Sample 5: 0.5% HPC, 4% KOH, 4% gly, 20% CNC, 0.5% CS, 0.01% SDBS, coagulant drying temperature 125° C.; Sample 6: 0.5% HPC, 4% KOH, 4% gly, 20% CNC, 0.5% CS, 0.01% SDBS, coagulant drying temperature 140° C.

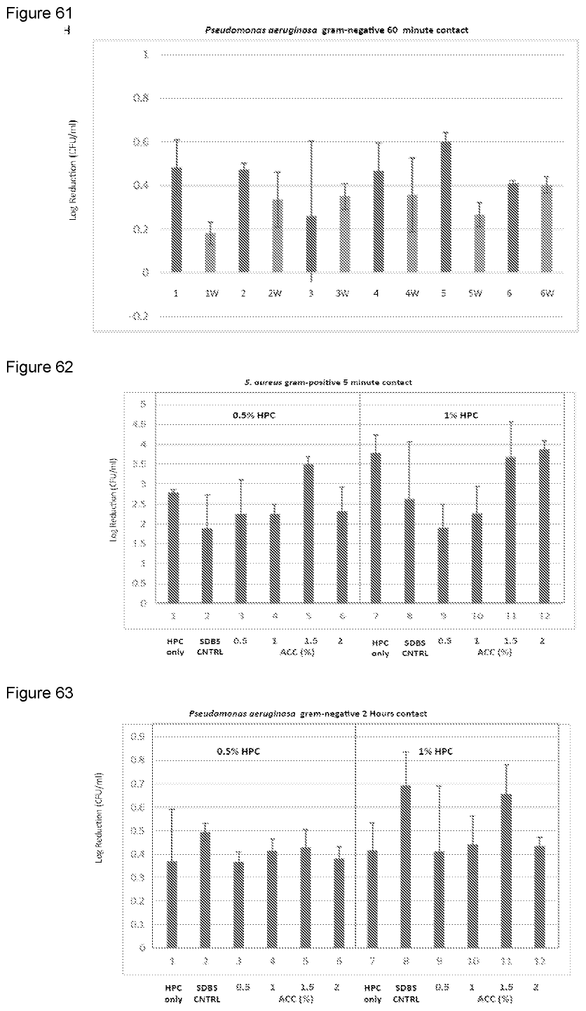

FIG. 61: Effect of increasing KOH concentration against P. aeruginosa with a 60 minute contact time. Samples are as per FIG. 60.

FIG. 62: Optimisation of HPC and functionaliser concentrations on antibacterial activity against S. aureus with a 5 minute contact time. Sample 1: 0.5% HPC, 2% KOH, 2% glycerol (gly), 20% CNC, 0.5% CS; Sample 2: 0.5% HPC, 2% KOH, 2% gly, 20% CNC, 0.5% CS, 0.01% SDBS; Sample 3: 0.5% HPC, 2% KOH, 2% gly, 20% CNC, 0.5% CS, 0.5% AAc, 0.01% SDBS; Sample 4: 0.5% HPC, 2% KOH, 2% gly, 20% CNC, 0.5% CS, 1% AAc, 0.01% SDBS; Sample 5: 0.5% HPC, 2% KOH, 2% gly, 20% CNC, 0.5% CS, 1.5% AAc, 0.01% SDBS; Sample 6: 0.5% HPC, 2% KOH, 2% gly, 20% CNC, 0.5% CS, 2% AAc, 0.01% S DBS; Sample 7: 1% HPC, 2% KOH, 2% gly, 20% CNC, 0.5% CS; Sample 8: 1% HPC, 2% KOH, 2% gly, 20% CNC, 0.5% CS, 0.01% SDBS; Sample 9: 1% HPC, 2% KOH, 2% gly, 20% CNC, 0.5% CS, 0.5% AAc, 0.01% SDBS; Sample 10: 1% HPC, 2% KOH, 2% gly, 20% CNC, 0.5% CS, 1% AAc, 0.01% SDBS; Sample 11: 1% HPC, 2% KOH, 2% gly, 20% CNC, 0.5% CS, 1.5% AAc, 0.01% SDBS; Sample 12: 1% HPC, 2% KOH, 2% gly, 20% CNC, 0.5% CS, 2% AAc, 0.01% SDBS.

FIG. 63: Optimisation of HPC and functionaliser concentrations on antibacterial activity against P. aeruginosa with a 2-hour contact time. Samples are as per FIG. 62.

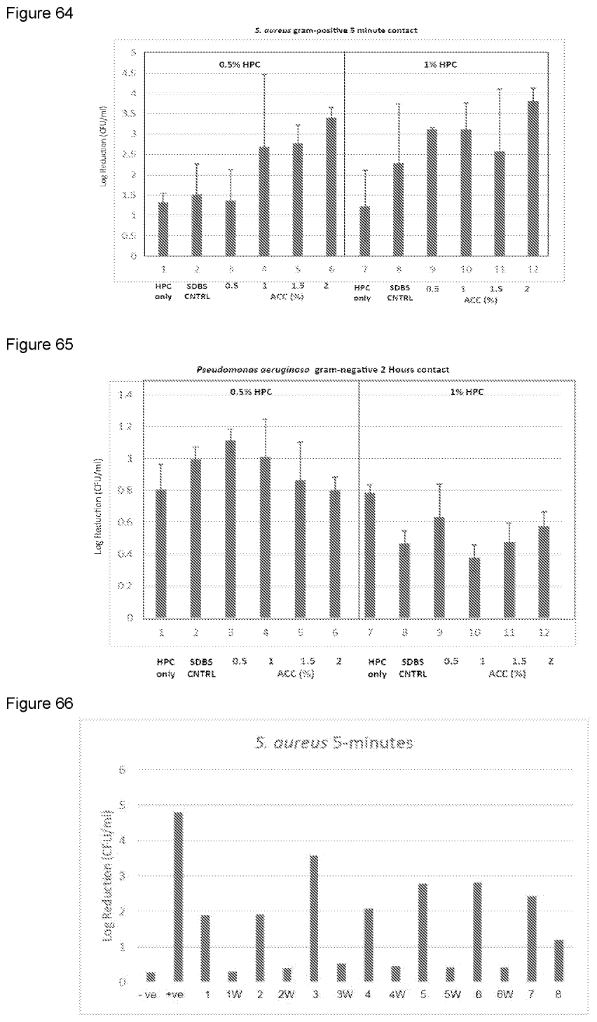

FIG. 64: Effect of 4% KOH on the antibacterial efficacy of coagulant formulations against S. aureus with a 5 minute contact time. Sample 1: 0.5% HPC, 4% KOH, 4% glycerol (gly), 20% CNC, 0.5% CS; Sample 2: 0.5% HPC, 4% KOH, 4% gly, 20% CNC, 0.5% CS, 0.01% SDBS; Sample 3: 0.5% HPC, 4% KOH, 4% gly, 20% CNC, 0.5% CS, 0.01% SDBS, 0.5% AAc; Sample 4: 0.5% HPC, 4% KOH, 4% gly, 20% CNC, 0.5% CS, 0.01% SDBS, 1% AAc; Sample 5: 0.5% HPC, 4% KOH, 4% gly, 20% CNC, 0.5% CS, 0.01% SDBS, 1.5% AAc; Sample 6: 0.5% HPC, 4% KOH, 4% gly, 20% CNC, 0.5% CS, 0.01% SDBS, 2% AAc; Sample 7: 1% HPC, 4% KOH, 4% gly, 20% CNC, 0.5% CS; Sample 8: 1% HPC, 4% KOH, 4% gly, 20% CNC, 0.5% CS, 0.01% SDBS; Sample 9: 1% HPC, 4% KOH, 4% gly, 20% CNC, 0.5% CS, 0.01% SDBS, 0.5% AAc; Sample 10: 1% HPC, 4% KOH, 4% gly, 20% CNC, 0.5% CS, 0.01% SDBS, 1% AAc; Sample 11: 1% HPC, 4% KOH, 4% gly, 20% CNC, 0.5% CS, 0.01% SDBS, 1.5% AAc; Sample 12: 1% HPC, 4% KOH, 4% gly, 20% CNC, 0.5% CS, 0.01% SDBS, 2% AAc.

FIG. 65: Effect of 4% KOH on the antibacterial efficacy of coagulant formulations against P. aeruginosa with a 2-hour contact time. Samples as per FIG. 64.

FIG. 66: Effect of washing on antibacterial activity of water-based coagulant formulations against S. aureus with a 5 minute contact time. Sample 1: 0.5% HPC, 4% KOH, 4% glycerol (gly), 20% CN, 0.5% CS; Sample 2: 0.5% HPC, 4% KOH, 4% gly, 0.01% SDBS, 2% AAc, 20% CN, 0.5% CS; Sample 3: 0.5% HPC, 4% KOH, 4% gly, 2% AAc, 20% CN, 0.5% CS; Sample 4: 1% HPC, 4% KOH, 4% gly, 20% CN, 0.5% CS; Sample 5: 1% HPC, 4% KOH, 4% gly, 0.01% SDBS, 2% AAc, 20% CN, 0.5% CS; Sample 6: 1% HPC, 4% KOH, 4% gly, 2% AAc 20% CN, 0.5% CS; Sample 7: 0.5% HPC, 4% gly, 20% CN, 0.5% CS; Sample 8: 1% HPC, 4% gly, 20% CN, 0.5% CS.

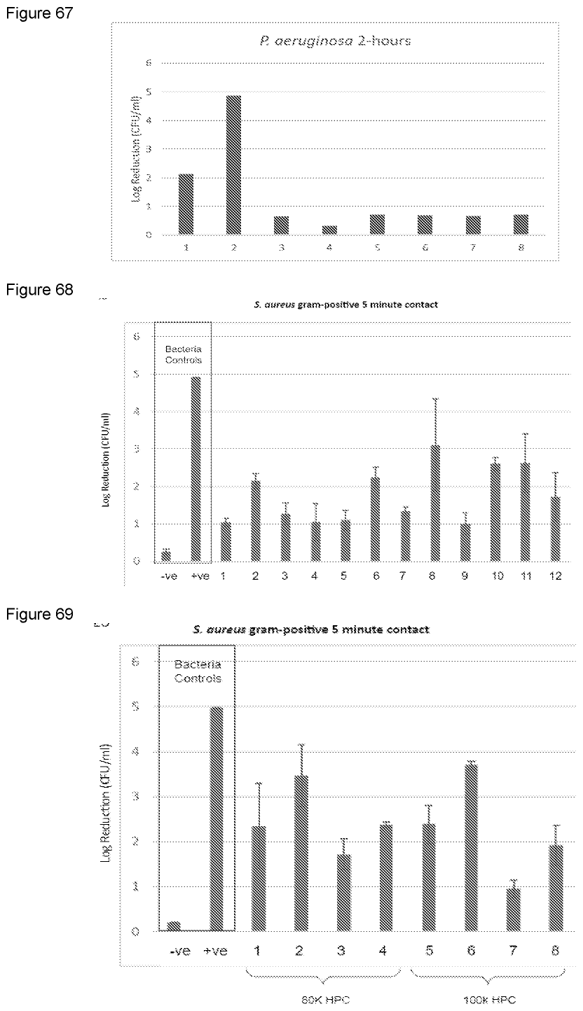

FIG. 67: Effect of washing on antibacterial activity of water-based coagulant formulations against P. aeruginosa with a 2-hour contact time. Samples as per FIG. 66.

FIG. 68: Effect on gram-positive antibacterial activity of different concentrations of HPC, the addition of a functionaliser (AAc), the addition of SDBS, the addition of glycerol and the addition of KOH. Sample 1: 0.5% HPC (Mw: 80 k)+20% CN+0.5% CS; Sample 2: 0.5% HPC (Mw: 80 k)+2% AAc+20% CN+0.5% CS; Sample 3: 0.5% HPC (Mw: 80 k)+2% KOH+20% CN+0.5% CS; Sample 4: 0.5% HPC (Mw: 80 k)+2% KOH+2% Gly+20% CN+0.5% CS; Sample 5: 0.5% HPC (Mw: 80 k)+2% KOH+2% Gly+0.01% SDBS+0.5% AAc+20% CN+0.5% CS; Sample 6: 0.5% HPC (Mw: 80 k)+2% KOH+2% Gly+0.01% SDBS+1.5% AAc+20% CN+0.5% CS; Sample 7: 1% HPC (Mw: 80 k)+20% CN+0.5% CS; Sample 8: 1% HPC (Mw: 80 k)+2% AAc+20% CN+0.5% CS; Sample 9: 1% HPC (Mw: 80 k)+2% KOH+20% CN+0.5% CS; Sample 10: 1% HPC (Mw: 80 k)+2% KOH+2% Gly+20% CN+0.5% CS; Sample 11: 1% HPC (Mw: 80 k)+2% KOH+2% gly+2% AAc+20% CN+0.5% CS; Sample 12: 1% HPC (Mw: 80 k)+2% KOH+2% Gly+0.01% SDBS+2% AAc+20% CN+0.5% CS.

FIG. 69: Comparison of 80K and 100K molecular weight HPC on antibacterial effect against S. aureus. Sample 1: 1% HPC (Mw: 80 k)+20% CN+0.5% CS; Sample 2: 1% HPC (Mw: 80 k)+2% AAc+20% CN+0.5% CS; Sample 3: 1% HPC (Mw: 80 k)+2% KOH+2% Gly+20% CN+0.5% CS; Sample 4: 1% HPC (Mw: 80 k)+2% KOH+2% Gly+2% AAc+20% CN+0.5% CS; Sample 5: 1% HPC (Mw: 100 k)+20% CN+0.5% CS; Sample 6: 1% HPC (Mw: 100 k)+2% AAc+20% CN+0.5% CS; Sample 7: 1% HPC (Mw: 100 k)+2% KOH+2% Gly+20% CN+0.5% CS; Sample 8: 1% HPC (Mw: 100 k)+2% KOH+2% Gly+2% AAc+20% CN+0.5% CS.

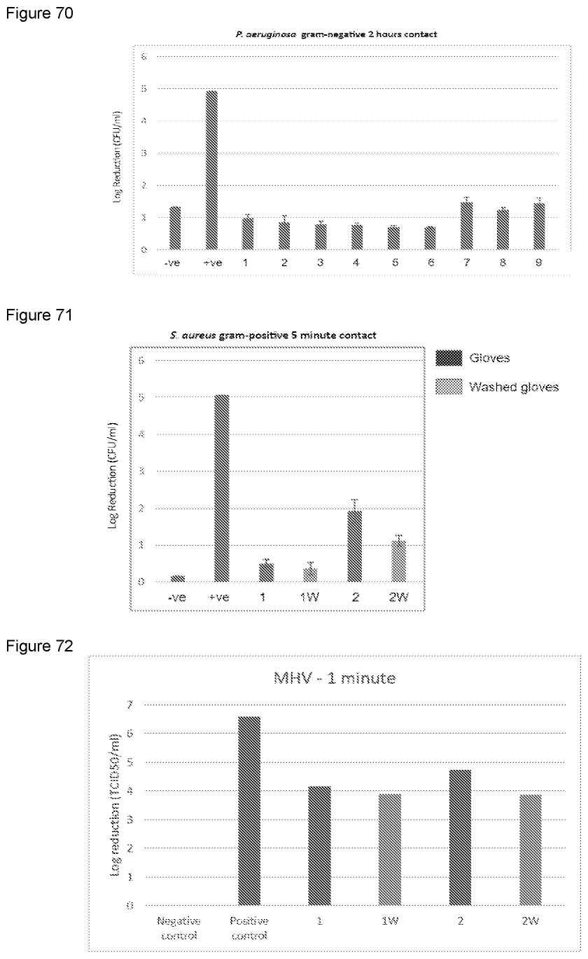

FIG. 70: The effect on antibacterial activity against gram-negative bacteria of the addition of KOH and calcium hydroxide to the coagulant formulations. All HPC used had a molecular weight of 100 k. Sample 1: 1% HPC+20% CN+0.5% CS; Sample 2: 1% HPC+2% AAc+20% CN+0.5% CS; Sample 3: 1% HPC+2% KOH+20% CN+0.5% CS; Sample 4: 1% HPC+2% KOH+2% AAc+20% CN+0.5% CS; Sample 5: 1% HPC+4% KOH+20% CN+0.5% CS; Sample 6: 1% HPC+4% KOH+2% AAc+20% CN+0.5% CS; Sample 7: 1% HPC+4% Ca(OH)₂₊₂₀% CN+1% CS; Sample 8: 1% HPC+1% HOCl+20% CN+1% CS; Sample 9: 1% HPC+4% Ca(OH)₂₊₂% AAc+20% CN+1% CS.

FIG. 71: Effect of the addition of functionaliser AAc on antibacterial (gram-positive) efficacy before and after gloves were washed. All HPC used had a molecular weight of 100 k. Sample 1 1% HPC+20% CN+0.5% CS; Sample 2: 1% HPC+2% AAc+20% CN+0.5% CS.

FIG. 72: Effect of the addition of functionaliser AAc on antiviral activity before and after gloves were washed. Samples are as per FIG. 71.

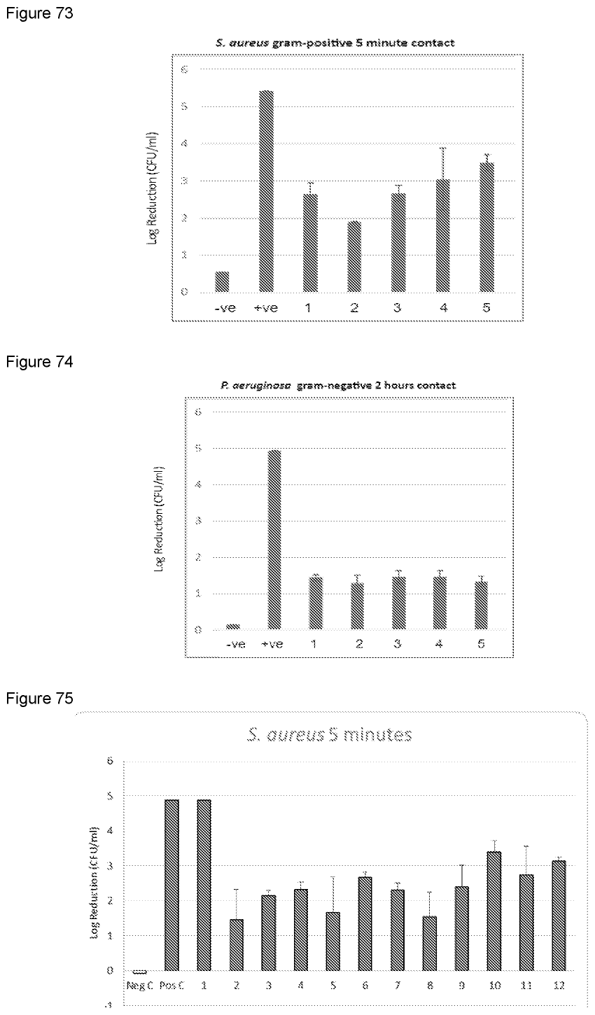

FIG. 73: Effect of a nonionic polyoxyethylene surfactant on antibacterial activity against S. aureus with a 5 minute contact time. All HPC used had a molecular weight of 100 k. Sample 1: 1% HPC+20% CN+0.5% CS; Sample 2: 1% HPC+20% CN+1% CS; Sample 3: 1% HPC+2% AAc+20% CN+1% CS; Sample 4: 1% HPC+0.1% Brij™ 35+20% CN+1% CS; Sample 5: 1% HPC+0.1% Brij™ 35+2% AAc+20% CN+1% CS.

FIG. 74: Effect of a non-ionic polyoxyethylene surfactant on antibacterial activity against P. aeruginosa with a 120 minute contact time. Samples as per FIG. 73.

FIG. 75: Effect of changes in coagulant temperature and coagulant drying temperature on antibacterial efficacy against S. aureus with a 5 minute contact time. Sample 1: 20% CN+1% CS; Sample 2: 1% HPC+20% CN+1% CS; Sample 3: 1% HPC+2% AAc+20% CN+1% CS; Sample 4: 1% HPC+20% CN+1% CS; Sample 5: 1% HPC (Mw: 100 k)+2% AAc+20% CN+1% CS; Sample 6: 1% HPC (Mw: 100 k)+20% CN+1% CS; Sample 7: 1% HPC (Mw: 100 k)+2% AAc+20% CN+1% CS; Sample 8: 1% HPC (Mw: 100 k)+20% CN+1% CS; Sample 9: 1% HPC (Mw: 100 k)+2% AAc+20% CN+1% CS; Sample 10: 1% HPC (Mw: 100 k)+20% CN+1% CS; Sample 11: 1% HPC (Mw: 100 k)+2% AAc+20% CN+1% CS; Sample 12: 1% HPC (Mw: 100 k)+2% AAc+20% CN+1% CS.

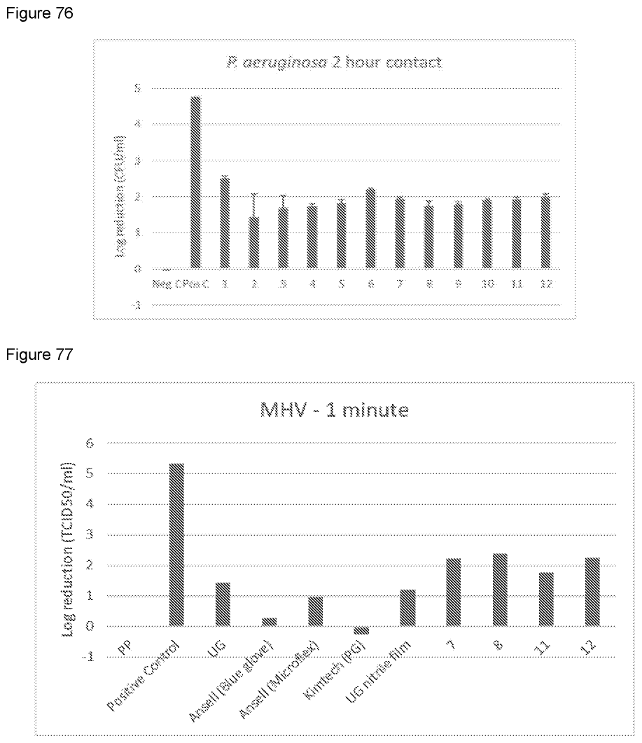

FIG. 76: Effect of changes in coagulant temperature and coagulant drying temperature on antibacterial efficacy against P. aeruginosa with a 2-hour contact time. Samples as per FIG. 73.

FIG. 77: Antiviral efficacy of water-based coagulant formulations. Sample 7: 14% CN+0.5% CS; Sample 8: 20% CN+0.5% CS; Sample 11: 1% HPC (Mw: 100 k)+20% CN+1% CS; Sample 12: 1% HPC (Mw: 100 k)+2% AAc+20% CN+1% CS.

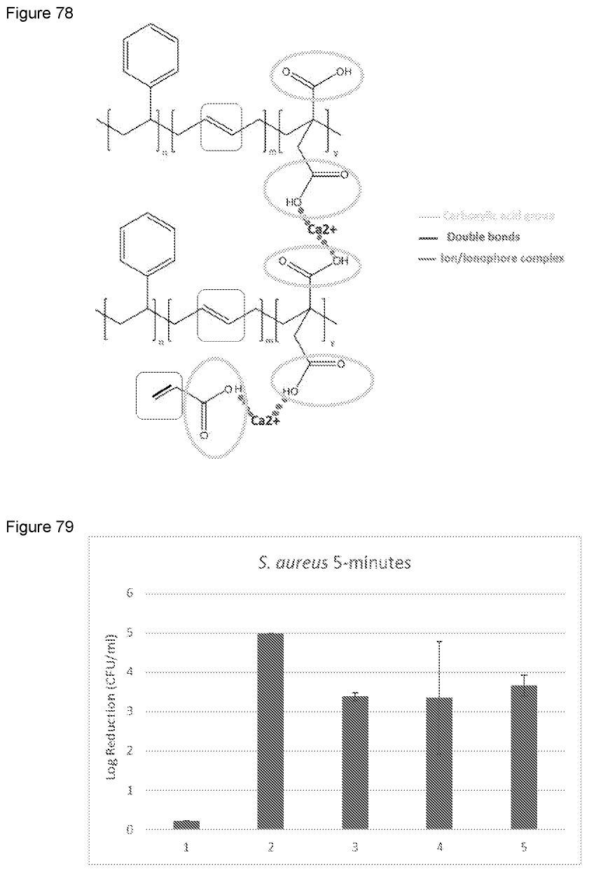

FIG. 78: Schematic showing calcium ions coordination with AAc and SB latex in coagulant and potential double bonds for crosslinking during vulcanisation (curing process).

FIG. 79: Antibacterial efficacy of water-based coagulant formulations using SBR and AAc. Sample 1: Negative control; Sample 2: positive control; Sample 3: 1% Everbuild SB+20% CN+0.5% CS; Sample 4: 1% Everbuild SB+2% AAc+20% CN+0.5% CS; Sample 5: 1% Everbuild SB+20% CN+0.5% CS.

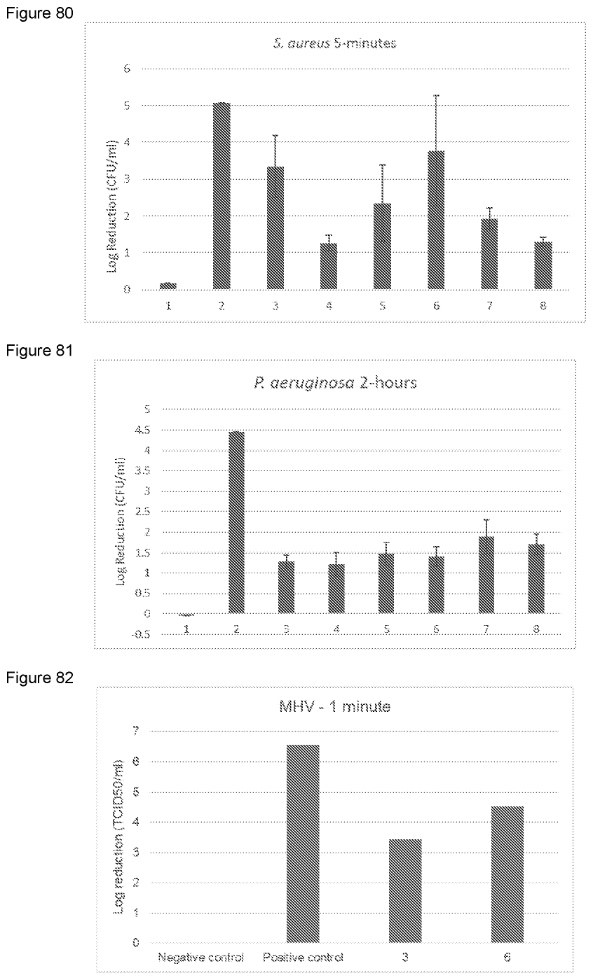

FIG. 80: Effect on antibacterial efficacy against S. aureus of the addition of AAc and KOH to a 1% Everbuild SBR coagulant formulations. Sample 1: Negative control; Sample 2: positive control; Sample 3: 1% Everbuild SB+20% CN+0.5% CS; Sample 4: 1% Everbuild SB+2% KOH+20% CN+0.5% CS; Sample 5: 1% Everbuild SB+4% KOH+20% CN+0.5% CS; Sample 6: 1% Everbuild SB+2% AAc+20% CN+0.5% CS; Sample 7: 1% Everbuild SB+2% AAc+2% KOH+20% CN+0.5% CS; Sample 8: 1% Everbuild SB+2% AAc+4% KOH+20% CN+0.5% CS.

FIG. 81: Effect on antibacterial efficacy against P. aeruginosa of the addition of AAc and KOH to a 1% Everbuild SBR coagulant formulation. Samples are as per FIG. 80.

FIG. 82: Effect on antiviral efficacy of the addition of AAc and KOH to a 1% Everbuild SBR coagulant formulation. Samples are as per FIG. 81.

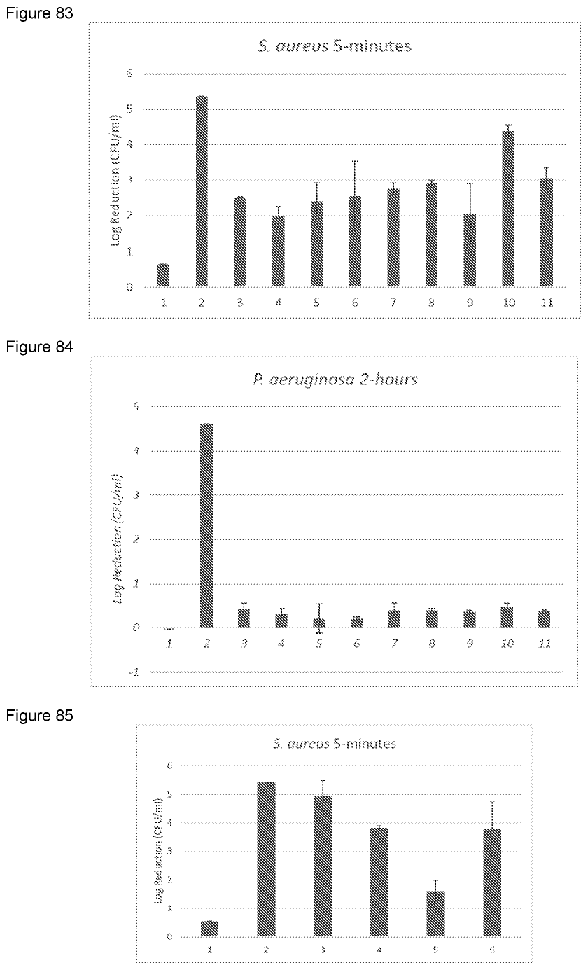

FIG. 83: Effect on antibacterial efficacy against S. aureus of the addition of the nonionic polyoxyethylene surfactant, Brij™ 35, and different percentages of SBR in the coagulant. Sample 1: Negative control; Sample 2: positive control; Sample 3: 1% Everbuild SB+20% CN+0.5% CS; Sample 4: 1% Everbuild SB+20% CN+1% CS; Sample 5: 1% Everbuild SB+0.1% Brij™ 35+20% CN+1% CS; Sample 6: 1% Everbuild SB+2% AAc+20% CN+1% CS; Sample 7: 1% Everbuild SB+2% AAc+0.1% Brij™ 35+20% CN+1% CS; Sample 8: 2% Everbuild SB+20% CN+1% CS; Sample 9: 2% Everbuild SB+0.1% Brij™ 35+20% CN+1% CS; Sample 10: 2% Everbuild SB+2% AAc+20% CN+1% CS; Sample 11: 2% Everbuild SB+2% AAc+0.1% Brij™ 35+20% CN+1% CS.

FIG. 84: Effect on antibacterial efficacy against P. aeruginosa of the addition of the nonionic polyoxyethylene surfactant, Brij™ 35, and different percentages of SBR in the coagulant. Samples are as per FIG. 83.

FIG. 85: Effect on antibacterial efficacy against S. aureus of coagulant formulations including 2% Everbuild SB formulations with varied percentages of CS and coagulant drying time. Sample 1: Negative control; Sample 2: positive control; Sample 3: 2% Everbuild SB+2% AAc+20% CN+1% CS, 50 second dry time; Sample 4: 2% Everbuild SB+2% AAc+20% CN+1% CS, 2 minute dry time; Sample 5: 2% Everbuild SB+2% AAc+20% CN+0.5% CS, 50 second dry time; Sample 6: 1% Everbuild SB+2% AAc+20% CN+0.5% CS, 50 second dry time.

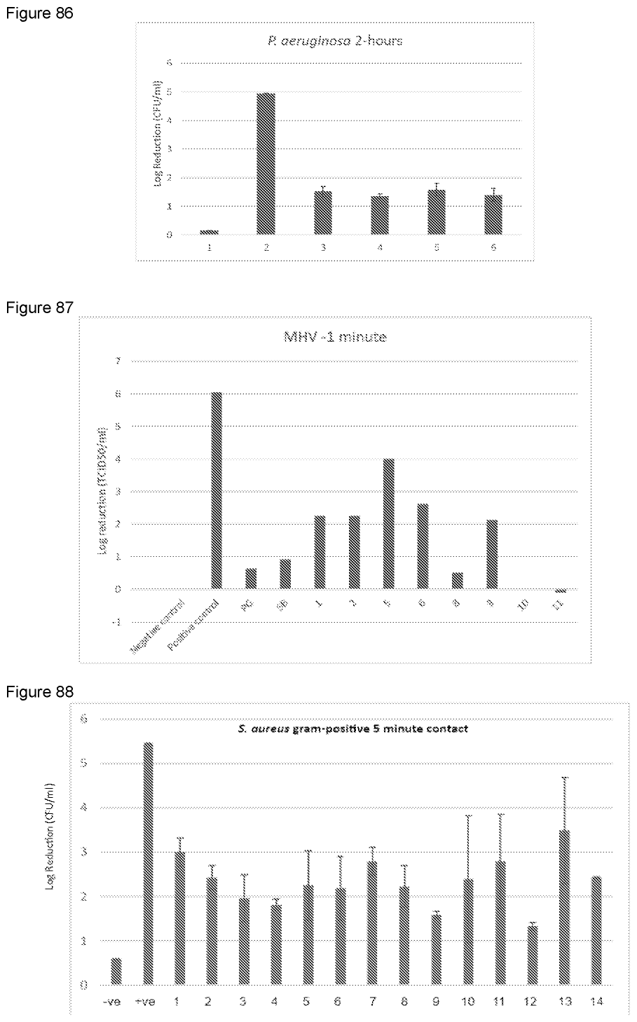

FIG. 86: Effect on antibacterial efficacy against P. aeruginosa of coagulant formulations including 2% Everbuild SB formulations with varied percentages of CS and coagulant drying time. Samples are as per FIG. 85.

FIG. 87: Effect of coagulant formulations including SBR on antiviral efficacy. Sample 1: Uniglove Nitrile film; Sample 2: Uniglove Nitrile film+commercial wash; Sample 5: 20% CN+1% CS; Sample 6: 1% Everbuild SB+20% CN+1% CS; Sample 8: Synthomer Nitrile; Sample 9: Synthomer Nitrile+commercial wash; Sample 10: 20% CN+1% CS; Sample 11: 1% Everbuild SB+20% CN+1% CS; PG: Purple glove; SB: 1% Everbuild SB.

FIG. 88: Effect on antibacterial efficacy against S. aureus on coagulant temperature, coagulant drying temperature, and percentage of CS in SBR coagulant formulations. Sample 1: Negative control; Sample 2: positive control; Sample 3: 1% Everbuild SB+2% AAc+20% CN+1% CS, 25° C. coagulant temperature, 2 minute dry time; Sample 4: 1% Everbuild SB+2% AAc+20% CN+0.5% CS, 25° C. coagulant temperature, 2 minute dry time; Sample 5: 1% Everbuild SB+2% AAc+20% CN+1% CS, 25° C. coagulant temperature, 50 second dry time; Sample 6: 1% Everbuild SB+2% AAc+20% CN+1% CS, 35° C. coagulant temperature, 50 second dry time; Sample 7: 1% Everbuild SB+2% AAc+20% CN+0.5% CS, 25° C. coagulant temperature, 50 second dry time; Sample 8: 1% Everbuild SB+2% AAc+20% CN+0.5% CS, 35° C. coagulant temperature, 50 second dry time; Sample 9: 2% Everbuild SB+2% AAc+20% CN+1% CS, 25° C. coagulant temperature, 2 minute dry time; Sample 10: 2% Everbuild SB+2% AAc+20% CN+0.5% CS, 25° C. coagulant temperature, 2 minute dry time; Sample 11: 2% Everbuild SB+2% AAc+20% CN+1% CS, 25° C. coagulant temperature, 50 second dry time; Sample 12: 2% Everbuild SB+2% AAc+20% CN+1% CS, 35° C. coagulant temperature, 50 second dry time; Sample 13: 2% Everbuild SB+2% AAc+20% CN+0.5% CS, 25° C. coagulant temperature, 50 second dry time; Sample 14: 2% Everbuild SB+2% AAc+20% CN+0.5% CS, 35° C. coagulant temperature, 50 second dry time.

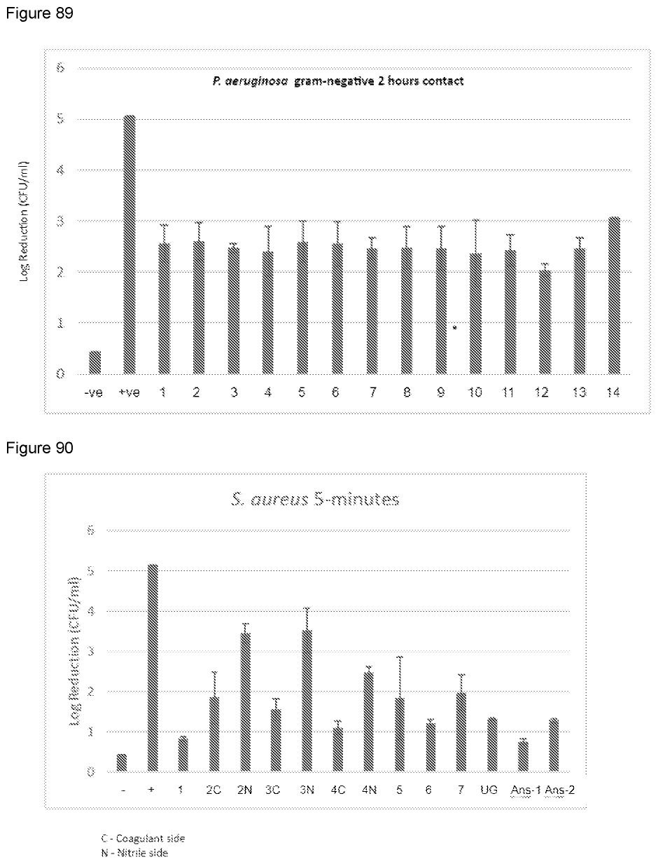

FIG. 89: Effect on antibacterial efficacy against P. aeruginosa on coagulant temperature, coagulant drying temperature, and percentage of CS in SBR coagulant formulations. Samples are as per FIG. 88.

FIG. 90: Antibacterial effect of Uniglove nitrile with and without antimicrobial coagulant formulations on S. aureus. Sample 1: Nitrile film (No coagulant); Sample 2: 20% CN+0.5% CS; Sample 3: 1% Everbuild SB+2% AAc+20% CN+0.5% CS; Sample 4: 2% Everbuild SB+2% AAc+20% CN+1% CS; Sample 5: 14% CN+0.5% CS; Sample 6: 1% Everbuild SB+2% AAc+14% CN+0.5% CS; Sample 7: 2% Everbuild SB+2% AAc+14% CN+1% CS; Ug: Uniglove antimicrobial glove; Ans 1: Ansell examination glove; Ans 2: Ansell MicroFlex examination glove.

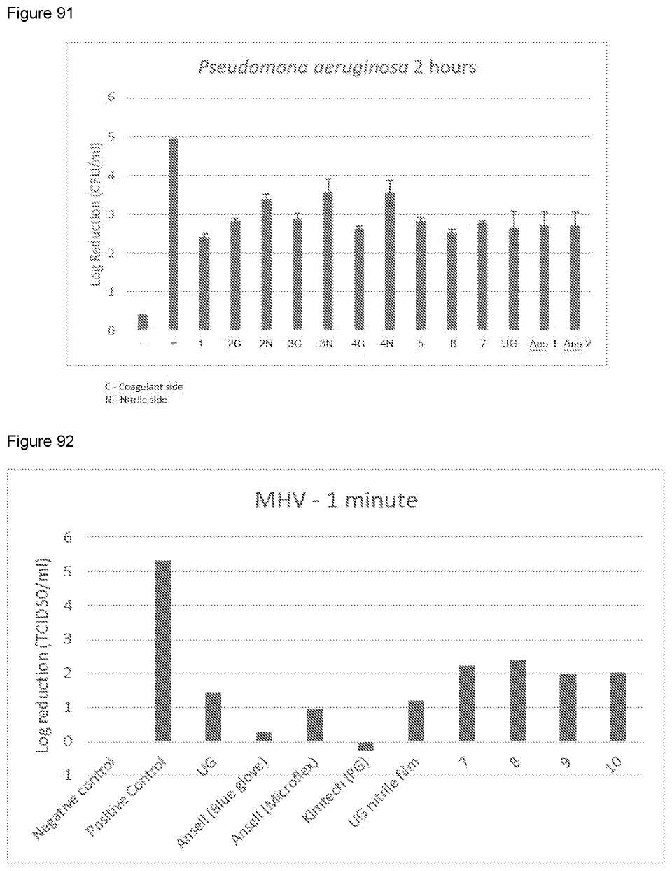

FIG. 91: Antibacterial effect of Uniglove nitrile with and without antimicrobial coagulant formulations on P. aeruginosa. Samples as per FIG. 90.

FIG. 92: Effect on antiviral efficacy of Uniglove nitrile with and without antimicrobial coagulant formulations on S. aureus. Ug: Uniglove antimicrobial glove; Sample 7: 14% CN+0.5% CS; Sample 8: 20% CN+0.5% CS; Sample 9: 1% SBR+2% AAc+20% CN+0.5% CS; Sample 10: 2% SBR+2% AAc+20% CN+1% CS.

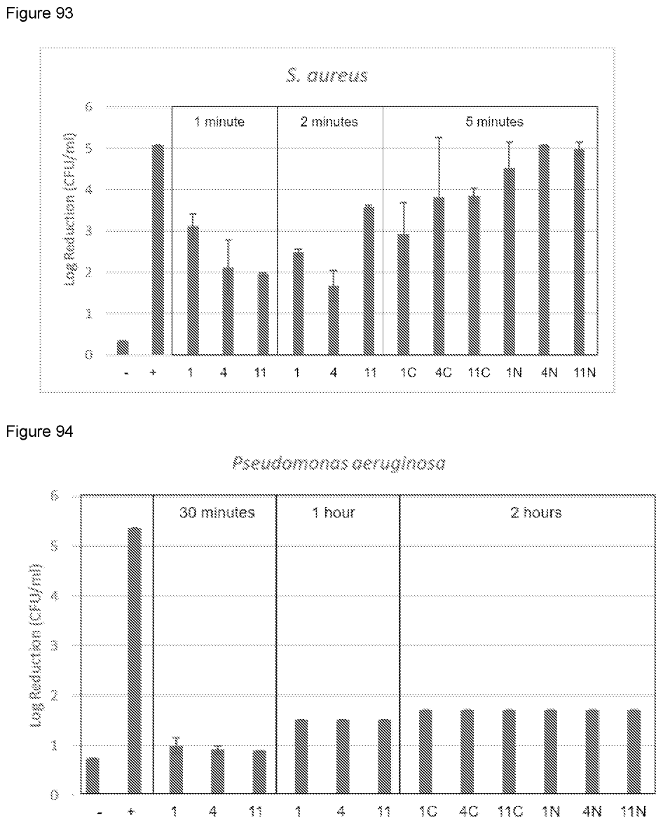

FIG. 93: Effect on antibacterial efficacy on varying dwell times against S. aureus. Sample 1: 20% CN+1% CS; Sample 4: 1% Everbuild SB+2% AAc+20% CN+1% CS; Sample 11: 2% Everbuild SB+2% AAc+20% CN+1% CS; C=coagulant side; N=nitrile side.

FIG. 94: Effect on antibacterial efficacy on varying dwell times against P. aeruginosa. Samples as per FIG. 93.

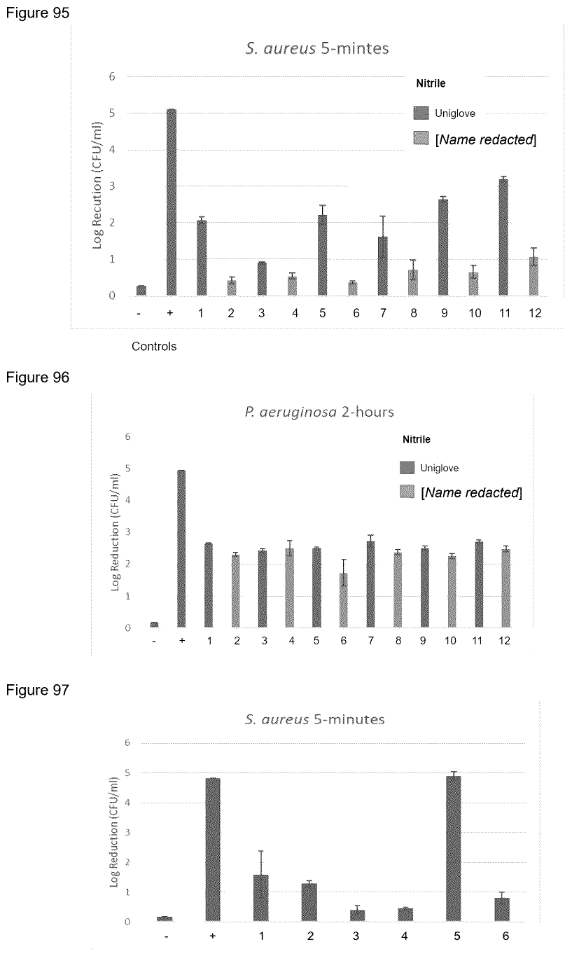

FIG. 95: Effect on antibacterial efficacy against S. aureus of coagulant formulations including SB latex and nitrile from different sources. Sample 1: 20% CN, Uniglove nitrile; Sample 2: 20% CN, [NAME REDACTED] nitrile; Sample 3: 20% CN+1% CS, Uniglove nitrile; Sample 4: 20% CN+1% CS, [NAME REDACTED] nitrile; Sample 5: 1% Everbuild SB+2% AAc+20% CN+1% CS, Uniglove nitrile; Sample 6: 1% Everbuild SB+2% AAc+20% CN+1% CS, [NAME REDACTED] nitrile; Sample 7: 1% KUMHO SB+2% AAc+20% CN+1% CS, Uniglove nitrile; Sample 8: 1% KUMHO SB+2% AAc+20% CN+1% CS, [NAME REDACTED] nitrile; Sample 9: 2% Everbuild SB+2% AAc+20% CN+1% CS, Uniglove nitrile; Sample 10: 2% Everbuild SB+2% AAc+20% CN+1% CS, [NAME REDACTED] nitrile; Sample 11: 2% KUMHO SB+2% AAc+20% CN+1% CS, Uniglove nitrile; Sample 12: 2% KUMHO SB+2% AAc+20% CN+1% CS, [NAME REDACTED] nitrile.

FIG. 96: Effect on antibacterial efficacy against P. aeruginosa of coagulant formulations including SB latex and nitrile from different sources. Samples as per FIG. 95.

FIG. 97: Effect of the pre-leaching step optionally included in the glove manufacturing process and replacing the pre-leaching water bath with a Ca(OH)₂ aqueous solution bath on antibacterial efficacy against S. aureus. Sample 1: 1% KUMHO SB+2% AAc+20% CN+1% CS with [NAME REDACTED] nitrile and no pre-leaching step; Sample 2: 1% KUMHO SB+2% AAc+20% CN+1% CS with [NAME REDACTED] nitrile and a pre-leaching step using a 50° C. water bath; Sample 3: 1% KUMHO SB+2% AAc+20% CN+1% CS with [NAME REDACTED] nitrile and a pre-leaching step using a 50° C., Ca(OH)₂ aqueous solution bath; Sample 4: 1% KUMHO SB+2% AAc+20% CN+1% CS with Synthomer nitrile and a pre-leaching step using a 50° C., Ca(OH)₂ aqueous solution bath; Sample 5: 1% KUMHO SB+2% AAc+20% CN+1% CS with Uniglove nitrile and no pre-leaching step; Sample 6: 1% KUMHO SB+2% AAc+20% CN+1% CS with Uniglove nitrile and a pre-leaching step using a 50° C., Ca(OH)₂ aqueous solution bath.

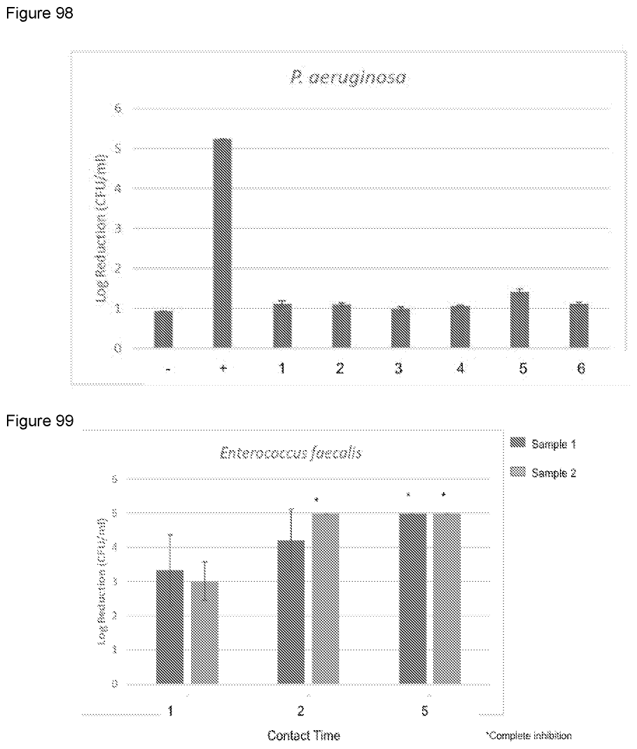

FIG. 98: Effect of the pre-leaching step optionally included in the glove manufacturing process and replacing the pre-leaching water bath with a Ca(OH)₂ aqueous solution bath on antibacterial efficacy against P. aeruginosa. Sample as per FIG. 97.

FIG. 99: Effect of SB-based coagulant formulations on the antibacterial efficacy against Enterococcus faecalis with increasing contact time. Sample 1: 20% CN+1% CS; Sample 2: 1% KUMHO SB+2% AAc+20% CN+1% CS.

### METHODS

### Antibacterial Testing Protocols

Antibacterial studies were performed against Staphylococcus aureus NCTC 10788, Staphylococcus aureus NCTC 8325, Escherichia coli NCTC 12241, Pseudomonas aeruginosa NCTC 13628, Pseudomonas aeruginosa PA01 and Enterococcus faecalis NCTC 13763 according to ASTM D7907 on samples as described below.

Bacteria were streaked from −80° C. stocks on appropriate nutrient-rich growth agar and incubated for 24 hours at 37° C. prior to testing to allow for colony growth. To prepare the cell suspension for testing, 5-10 colonies were selected with a sterile loop and were mixed into 5 ml of Phosphate buffer saline (PBS). Suspension optical density was measured at 625 nm and adjusted to 0.5 McFarland standard (OD625). The suspension was diluted 1 in 2 with liquid media (Tryptic soya broth (TSB) or Mueller Hinton Broth (MHB), to give a 20 μl inoculum containing 10⁶ colony forming units (CFU). In replicate, the bacteria suspension was serially diluted in liquid media and plated on agar media (Tryptic Soya agar (TSA) or Mueller Hinton agar (MHA) to confirm initial CFU/ml. Dilutions were also made in the neutralisation solution that is used during testing (Dey and Engley broth, liquid media with Tween 80, or liquid media with arabic gum) as an additional control.

During challenge testing, a 20 μl sample of the bacterial suspension was placed onto each sample, and a glass coverslip placed on top with sterile tweezers. Samples were left for the contact-time period (from 1-minute to 2-hours) and then transferred into 10 ml of neutralisation solution and agitated (via inversion, or vortexing for 15 or 30 seconds) to neutralise the solution and re-suspend any viable bacteria cells. Samples were serially diluted with replicates and incubated at 37° C. for 24 hours. Colonies were counted manually, and the average Log 10 of the CFU/mL was calculated. The log reduction was calculated by subtracting the log number of colonies obtained from the test sample from either the control sample or the initial inoculum CFU/ml). During testing, various controls were set alongside the test samples; negative experimental control to ensure viability of bacteria during testing (polypropylene sheet or glass slide); commercially available glove inoculated and immediately neutralised to ensure sufficient recover of bacteria during testing, and a positive control (glove sprayed with 20K ppm HOCl).

To further investigate the leaching of antimicrobial material from the surface of the glove, a ‘Zone of Inhibition’ method was developed. A lawn of bacteria was created by spreading 100 μl of a 10⁷ CFU/ml inoculum of Staphylococcus aureus. A small 1 cm by 1 cm piece of glove was placed onto the plate, and incubated for 24 hours at 37° C. Zones of inhibition were categorised and graded using the following criteria: leaching score 1—no leaching, no zone of inhibition around glove; leaching score 2—minimal leaching, very small zone of inhibition around glove; leaching score 3—slight leaching, small inhibition zone around glove and leaching score 4—leaching, large zone of inhibition around glove.

### Washing Protocol for Efficacy Testing

To assess the retention of antibacterial activity after gloves come into contact with water or other solvents such as ethanol, gloves were washed after the manufacturing process. Gloves samples of 2.5 cm by 2.5 cm were placed in a 6-well plate and submerged in 2 ml of sterile deionized water or 99.6% pure ethanol for 5 minutes (sometimes referred to as CodiKoat method or C_method), at 40° C. with agitation (100 rpm). Gloves were removed and dried at 50° C. for 15 minutes.

### Example 1—Antimicrobial Coagulant Formulations

A number of formulations were designed for antimicrobial coagulant solutions. Ingredients of a commercial coagulant solution (Unigloves Ltd) used unless specified otherwise were:

| | |
|---|---|
| Calcium nitrate | 14% |
| Calcium stearate | 1.8% |
| Wetting agent surfactant: | 0.1-0.5% |
| Water | Rest (>83.7%) |

Pigmented and Unpigmented nitrile solutions had the following composition: 45% acrylonitrile-butadiene methacrylic acid copolymer and 55% water.

A cell viability assay, adapted from ISO 21702:2019 “Measurement of antiviral activity on plastics and other non-porous surfaces”, was used to test antiviral activity and is described below:

Formulations were tested for their effectiveness in inactivating murine hepatitis virus (MHV) in 1 minute of contact time using L929 mouse fibroblast cells.

The cells were seeded in 96 well plates at 5×10⁵ cells/ml, 100 μl per well, which gave ˜1×10⁶ cells the next day after being incubated at 37° C. overnight.

Virus was used at 10⁷ PFU/ml. One hundred μl of the virus stock was placed on each sample and incubated for 1 minute at room temperature (25° C.)

Each sample was tested in triplicate. A no-virus, negative control, and a virus-only positive control were included in testing.

For serial dilutions, 225 μl×7 (in triplicate) of complete Dulbecco's Modified Eagle Medium (cDMEM) was added to rows B-H of the 96 well plate per sample to be tested.

One hundred μl of medium (for cytotoxicity observations) or virus was placed onto each 2.5 cm×2.5 cm test sample in 6 well plates, along with an untreated sample exposed to medium or virus. A coverslip (2.2 cm×2.2 cm) was then placed on each sample and these were incubated at room temperature for the duration of the contact time (1 min).

Samples and the coverslips exposed to 100 μl of medium or virus were then transferred into each of the pre-prepared cDMEM containing 50 ml Falcon tube.

The Falcon tubes were vortexed for 5 seconds 3 times in order to recover the virus from the specimens. Then, 250 μl of each of the above was added to row A of the pre-prepared 96 well dilution plates. To perform the serial dilutions; 25 μl was taken from row A into row B of the dilutions and mixed well by pipetting. Then 25 μl of row B was taken and added to row C. Mixing and transferring were repeated to the next row for a total of 8 concentrations to give a 10 fold dilution.

Twenty μl of serially diluted MHV or control samples from the plates were directly transferred onto cells (‘test plate’) in quadruplicate and mixed by pipetting gently. Cells were then incubated for 48 hours. Cell infection phenotype as cell death and cytopathic effect (CPE) was observed under a benchtop light microscope (20× magnification) at 48 hours post infection (hpi) intervals.

The antiviral effects of ethyl cellulose were investigated as follows:
1) Sample 1=control coagulant (14% calcium nitrate+1.8% calcium stearate). As the control, the sample was prepared using the commercial coagulant solution.
2) Sample 2=25K ppm hypochlorous acid (HOCl) in the coagulant (14% calcium nitrate+1.8% calcium stearate+0.5% plasticiser). Sample 2 was prepared as another control by dissolving 2.5 Sanitab™ tablets (sodium dichloroisocyanurate-NaDCC) in 100 ml of commercial coagulant and 0.5 gram dibutyl sebacate (DBS) as the plasticiser.
3) Sample 3=0.8% ethyl cellulose (EC)+0.5% plasticiser+14% calcium nitrate+1.8% calcium stearate. A 1.065% stock solution of EC in methanol was prepared by dissolving 1.065 gram of EC in 100 ml methanol. Separately, 0.5 gram DBS (as the plasticiser), 10.35 gram calcium nitrate and 1.3 gram calcium stearate was added to 25 ml of the commercial coagulant solution and dissolved completely and then 75 ml of the EC stock solution was add very slowly 2 ml/min to the 25 ml of the new coagulant solution whilst stirring at 1000 rpm.
4) Sample 4=1.65% EC+0.5% plasticiser+14% calcium nitrate+1.8% calcium stearate. A 2.2% stock solution of EC in methanol was prepared by dissolving 2.2 gram of EC in 100 ml methanol. Separately, 0.5 gram DBS (as the plasticiser), 10.35 gram calcium nitrate (CN) and 1.3 gram calcium stearate (CS) was added to 25 ml of the commercial coagulant solution and dissolved completely and then 75 ml of EC stock solution was add very slowly 2 ml/min to the 25 ml of the new coagulant solution whilst stirring at 1000 rpm.
5) Sample 5=3.3% EC+0.5% plasticiser+14% CN+1.8% calcium stearate. A 4.4% stock solution of EC in methanol was prepared by dissolving 4.4 gram of EC in 100 ml methanol. 0.5 gram DBS (as the plasticiser), 10.35 gram CN and 1.3 gram CS was added to 25 ml of the commercially available coagulant solution and dissolved completely and then 75 ml of EC stock solution was add very slowly 2 ml/min to the 25 ml of new coagulant solution whilst stirring at 1000 rpm.

All formable materials were prepared by immersing a pre-warmed glass bottle in a 100 ml coagulant tank for 1 min. The resulting layer of coagulant was dried in an oven at 100° C. for 1 min, then immersed in a 100 ml nitrile tank for 2 minutes. Then the bottle was placed in the oven at 100° C. for 30 minutes and then taken out to cool before the resulting material layer was peeled off gently.

As seen in FIG. 2, a correlation was observed between antiviral activity and EC concentration, The results of this experiment indicated that the higher the EC concentration, the higher the antiviral effect, suggesting that EC has a key role in the high antiviral activity observed.

Since the exposed side of the gloves is the coagulant side (rather than the nitrile side), of particular interest was the interaction of EC and the coagulant ingredients. However, the coagulant is mainly composed of water and the only non-water ingredients include calcium nitrate (CN), calcium stearate (CS) and wetting agents. Wetting agents are only present at 0.1-0.5% concentration, and calcium stearate is insoluble in water/ethanol. As a result, it was speculated that CS was unlikely to be reacting with EC. The only remaining ingredient that had a high chance of interaction with EC was CN as it is also greatly soluble in ethanol. Therefore, the interaction between EC and calcium ions was investigated.

It was hypothesised that inclusion of EC in the coagulant formulation creates EC/calcium ion complexes. This results in an increase in the lipophilic nature of calcium ions thereby increasing the interaction between the EC/Ca ion complexes and the viral and bacterial cells. In turn, this should allow the complexes to penetrate and cross the viral/bacterial lipid bilayer cell membrane more freely, thereby damaging the cell membrane and hence destroying and/or significantly reducing cell growth. Compounds that facilitate transmission of an ion (e.g. calcium) across a lipid barrier (as in a cell membrane) by combining with the ion or by increasing the permeability of the barrier to it are generally known as “ionophores”. In other words, an ionophore is a chemical species that reversibly binds ions.

Other active ionophore:ion complexes other than an EC/Ca complex that may be considered as additives are complexes made with EC and ions such as Na⁺, K⁺, Mn²⁺, Ca²⁺, Mg²⁺, Sr²⁺, Ba²⁺, Zn²⁺, Fe²⁺. Other polymer ionophores other than EC are also of interest, such as cellulose, methyl cellulose, hydroxypropyl cellulose (HPC), cellulose acetate and cellulose acetate butyrate, Cellulose nitrate, Cellulose triacetate, Ethylene/vinyl acetate, Poly(acrylic acid), Poly(methyl methacrylate), poly (2-phenyl-2-oxazoline), polyethylene oxide (PEO), poly(2-hydroxyethyl methacrylate), poly (1,2 butylene glycol) (PBG), Poly(propylene oxide), polyacrylonitrile, polyvinyl chloride, polyvinylidene fluoride, Poly(vinyl acetate) and combinations thereof. Interestingly, Mohammad et al ((2018) Journal of Electronic Materials, 47, p. 2954-2963) describe the characterisation and testing of ethyl cellulose-calcium (II) hydrogen phosphate (EC-CaHPO₄) composites, using sol-gel synthesis method, in which antibacterial properties were also observed.

During the early optimisation experiments, an in-house ethanol-based coagulant solution was made, based on the commercial coagulant solution which contained 14% CN, 1.8% CS and low amounts of wetting agents. The primary motivation behind this was that EC is not water soluble and had to be dissolved in ethanol and then mixed with the water based commercial coagulant solution step by step to obtain the desired final in-house coagulant. However, this process was slow and complicated. Since all of the ingredients in the commercial coagulant are ethanol soluble, an ethanol-based coagulant solution was created that contained EC, 14% CN, 1.8% CS and wetting agents to start with. The theory behind this is that the use of an ethanol-based solution would eliminate the complications arising as a result of step-by-step mixing of solutions and, more importantly, all chemicals could be mixed in one step and in one tank which would be faster and technically easier for upscaling and production.

Another optimisation that was performed was to improve the mechanical properties of the gloves in terms of stretchability and flexibility. In the first step of the processing of the gloves, the added EC in coagulant formed a thin film on the surface of the former. After dipping in the nitrile and then the full processing of the resulting material, the film of EC caused the formation of a separate layer above the nitrile layer. However, EC is a rather rigid polymer compared to the very flexible nitrile polymer and hence it required optimisation for improved mechanical compatibility with the nitrile polymer. Deteriorated mechanical properties of the resulting material was observed in the early batches as the material would more easily break, or even the EC polymer layer could be seen to come off from the surface of the material. Hence, the concentration of EC in the formulation was optimised and plasticisers, such as dibutyl sebacate (DBS), were also included in the formulation to improve flexibility. EC concentration was gradually lowered to 0.5%-1% to find a good compromise between antimicrobial activity, film forming but also stretchability/flexibility. Moreover, the concentration of plasticiser was optimised in the range of 0% to 1% (0%, 0.33%, 0.66% and 1%).
1) Sample 1=Commercial coagulant: 14% CN+1.8% CS as previously described
2) Sample 2=0.5% EC+1% plasticiser+14% CN+1.8% CS+100 ml ethanol (EtOH). In a 200 ml beaker, 1 g of DBS (plasticiser) was dissolved in 100 ml EtOH whilst stirring. Then, 0.5 gram EC was added step by step until all the EC was dissolved completely. 14 g of CN was then added to the coagulant solution followed by 1.8 gram CS while the coagulant was stirred at 1000 rpm.
3) Sample 3=0.5% EC+14% CN+1.8% CS+100 ml EtOH.
4) Sample 4=0.5% EC+0.33% plasticiser+14% CN+1.8% CS+100 ml EtOH.
5) Sample 5=0.5% EC+0.66% plasticiser+14% CN+1.8% CS+100 ml EtOH.

All materials were prepared by immersing a pre warmed glass bottle in 100 ml coagulant tank for 1 min. The resulting layer of coagulant was dried in an oven at 100° C. for 1 min, then immersed in a 100 ml nitrile tank for 2 minutes. The bottle was then placed in the oven at 100° C. for 15 minutes and taken out to be cooled before the resulting material was peeled off gently.

FIG. 3 shows that the inclusion of plasticiser at the concentrations tested (0-1%) had no significant effect on the antimicrobial activity and therefore can be included in the formulation if required for stretchability/flexibility purposes.

Following the above optimisations, an important concern of material transfer/leaching had to be addressed. The motivation was twofold. A significant reduction in antimicrobial activity had been observed following washing of samples with either water or ethanol and this is important as this greatly reduces the effective antimicrobial lifetime of the glove. This could also lead to material transfer/leach which would be undesirable in the medical, surgical or catering settings. However, there is usually a compromise between the availability of active agents that are free and able to interact with the virus/bacteria and material transfer, which depends on how strongly active agents are trapped/bonded to the polymer matrix. Hence, optimising the formulation to achieve a controlled release of active ingredients and to identify a balance between high antimicrobial activity and material transfer, which in turn dictates the antimicrobial lifetime and stability, was looked into. This method was inspired by the controlled drug release concept in pharmacological drug delivery such as use of micellar drug delivery complexes.

Analysis and microscopic investigations of the prepared samples revealed that the primary reason for leaching of the coating materials and washing away from the surface was due to the low chemical compatibility between nitrile and EC polymer. In simple terms, the adhesion and bonding between nitrile polymer layer and EC layer is not strong enough. In addition, the solubility and robustness of the EC polymer layer itself is an important factor in controlling material transfer/release. The latter has been optimised by the use of specific molecular weight polymers, cross-linking (e.g. thermal cross linking) and also by optimising the amount and level of curing and drying of the glove samples (i.e. drying duration and temperature). However, the former aspect, which is the adhesion between the EC polymer layer (which contains the EC/Ca complex within its matrix) and the nitrile layer, is more complex.

During the manufacturing process, once the glove formers are dipped into the nitrile tank, they have to go through a chemical process which converts rubber into cross-linked polymer. This process is known as vulcanisation. Vulcanisation agents such as sulphur are also included which help form bridges between individual polymer molecules when heated. Often a catalyst and initiator are also added to accelerate the vulcanisation process (commonly zinc oxide). The cross-linked elastomers have much improved mechanical properties. In fact, un-vulcanised rubber has poor mechanical properties and is not very durable. The vulcanisation renders the glove stronger and hence higher elasticity and stress retention is expected from the glove due to increased covalent bonding between the polymer chain.

A hypothesis was tested to investigate whether the reason that the EC and nitrile layers do not make a strong adhesion or chemical bond is because EC polymers inherently lack the necessary functional groups that can participate in the vulcanisation process. It was envisaged that if an appropriate functional group could be attached to EC then, in theory, it should be possible to make the functionalised EC polymer participate in the vulcanisation process and create a chemical bond with the nitrile polymer.

An appropriate functional group that could react with a vulcanisation agent, such as sulphur, and/or create a chemical covalent bond with the nitrile rubber, is acrylate—other appropriate functional groups could include vinyls and methacrylates. As a result, the EC polymer was functionalised by the reaction of the free hydroxyl group of the EC with acryloyl chloride in the alcoholic solution of KOH via an esterification reaction at an ambient temperature. The functionalised EC could now either make a reaction with the sulphur vulcanisation agent or make a chemically covalent bond with nitrile rubber, in turn becoming crosslinked to the nitrile rubber during vulcanisation and making a uniform layer of cross-linked EC/nitrile polymers to create a strong adhesion. FIGS. 4 and 5 illustrate the chemical reactions.

### Antiviral Effect:

1) Sample 1=Polypropylene plastic sheets
2) Sample 2=1% EC+14% CN+1.8% CS+2% AC+4% KOH+100 ml EtOH. In a 400 ml beaker, 8 g of KOH was dissolved in 200 ml ethanol (EtOH) before 2 g EC was added to the solution. When all of the EC was dissolved, 4 g acryloyl chloride (AC) was added dropwise and the solution stirred overnight. Then 28 g CN was added to the coagulant solution and, when dissolved completely, 3 g CS was added whilst the coagulant was stirred at 1000 rpm.
3) Sample 3=1% EC+14% CN+1.8% CS+3% AC+6% KOH+100 ml EtOH. In a 400 ml beaker, 12 g of KOH was dissolved in 200 ml EtOH before 2 g EC was added to the solution. When all of the EC was dissolved, 6 g AC was added dropwise and the solution stirred overnight. Then 28 g CN was added to the coagulant solution and, when dissolved completely, 3 g CS was added whilst the coagulant was stirred at 1000 rpm.
4) Sample 4=1% EC+14% CN+1.8% CS+2% AC+4% KOH+100 ml EtOH+ [CPC (0.05%)+Ascorbic Acid (0.05%)+Citric acid (0.05%)]. 100 ml of Sample 2 solution was taken and CPC (0.05 gram)+Ascorbic Acid (0.05 gram)+Citric acid (0.05 gram) were added and all materials dissolved in the solution.
5) Sample 5=1% EC+14% CN+1.8% CS+3% AC+6% KOH+100 ml EtOH)+ [CPC (0.05%)+Ascorbic Acid (0.05%)+Citric acid (0.05%)]. 100 ml of Sample 3 solution was taken and CPC (0.05 gram)+Ascorbic Acid (0.05 gram)+Citric acid (0.05 gram) were added and all materials dissolved in the solution.

The samples were prepared by immersing a pre-warmed glass bottle in 100 ml of the corresponding coagulant tank for 1 min. The resulting layer of coagulant was dried in an oven at 100° C. for 15 min to form a clear coagulant layer, then immersed in a 100 ml nitrile tank for 2 minutes. Then the bottle was placed in the oven at 100° C. for 15 minutes and then taken out to cool before the resulting material was peeled off gently.

As can be seen from FIG. 6, the samples demonstrated significantly high antiviral results, even after washing with either water or ethanol. This corresponds to the addition of functionaliser to the formulation which helps with the strong adhesion of ionophore polymer and the substrate polymer (nitrile) which, in turn, increases the stability of the coating against external factors such as sweat, washing and friction.

### Antibacterial Effect:

1) Sample 1=Commercially available purple gloves.
2) Sample 2=0.5% EC+0% plasticiser+14% CN+1.8% CS+0.5% AC+0.6% KOH+100 ml EtOH. In a 200 ml beaker, 0.6 g KOH was dissolved in 100 ml EtOH then 0.5 g EC was added to the solution. When all the EC was dissolved 0.5 g AC was added dropwise and the solution stirred overnight. Then 14 g CN was added to the coagulant solution and dissolved completely and then 1.8 g CS was added whilst stirred at 1000 rpm.
3) Sample 3=0.5% EC+0% plasticiser+14% CN+1.8% CS+1% AC+1.5% KOH+100 ml EtOH. In a 200 ml beaker, 1.6 g KOH was dissolved in 100 ml EtOH then 0.5 gram EC was added to the solution. When all the EC was dissolved 1 g AC was added dropwise and the solution was stirred overnight. Then 14 g CN was added to the coagulant solution and dissolved completely and then 1.8 g CS added whilst stirred at 1000 rpm.
4) Sample 4=0.5% EC+0.5% plasticiser+14% CN+1.8% CS+0.5% AC+0.6% KOH+100 ml EtOH. In a 200 ml beaker, 0.6 g KOH was dissolved in 100 ml EtOH then 0.5 g EC was added to the solution. When all the EC was dissolved 0.5 g AC was added dropwise and the solution was stirred overnight. Then 500 μL dibutyl sebacate (plasticiser) was dissolved completely in the solution whilst stirring. Then 14 g CN was added to the coagulant solution and dissolved completely and then 1.8 g CS added whilst the stirred at 1000 rpm.
5) Sample 5=0.5% EC+0% plasticiser+14% CN+1.8% CS+0.5% AC+0.6% KOH+0.5% polydimethylsiloxane (PDMS)+100 ml EtOH. In a 200 ml beaker, 0.6 g KOH was dissolved in 100 ml EtOH before 0.5 g EC was added to the solution. When all the EC was dissolved, 0.5 g AC was added dropwise and the solution was stirred overnight. Then 500 μL PDMS (as a plasticiser) was dissolved completely in the solution whilst stirring. Then 14 g CN was added to the coagulant solution and dissolved completely before 1.8 g CS added whilst stirred at 1000 rpm.

The samples were prepared by immersing a pre-warmed glass bottle in 100 ml of the corresponding coagulant tank for 1 min. The resulting layer of coagulant was dried in the oven at 100° C. for 15 min to form a clear coagulant layer, then immersed in a 100 ml nitrile tank for 2 minutes. Then the bottle was placed in the oven at 100° C. for 15 minutes and then taken out to cool before the resulting material was peeled off gently.

As can be seen from FIG. 7, the antibacterial activity of the materials was significant even after washing with water, demonstrating the enhancement in stability of the coating due to the presence of the functionaliser. Out of the test samples, the sample with 0.5% EC and 0.5% acryloyl chloride had superior antimicrobial activity before and after washing.

Furthermore, improvement of the antimicrobial action of the ionophore:ion complexes utilised in the coagulant formulation was investigated by using higher charged ions such as aluminium 3+, Fe 3+, chromium 3+, bismuth 3+ or manganese. Manganese ions are present, commonly with a charge of 2+. However, because it is a transitional metal, other oxidation states also exist, including +3, +4, +6, and +7, such as permanganate compounds. Other oxidation states generally from −3 to +7 have also been observed. Aluminium nitrate, which creates the ionophore compound of EC/Al, was tested at concentrations from 0.5%-12% as an example.

### Antiviral Effect:

1) Sample 1=Polypropylene plastic sheets.
2) Sample 2=0.75% EC+14% CN+1.8% CS+1.5% AC+4% KOH+1500 ppm HOCl+100 ml EtOH. In a 200 ml beaker, 4 g KOH was dissolved in 200 ml EtOH then 0.75 g EC was added to the solution. When all the EC was dissolved 1.5 g AC was added dropwise and the solution was stirred overnight. Then 14 g CN was added to the coagulant solution and dissolved completely and then 1.8 g CS was added whilst stirred at 1000 rpm. Then 2 ml of a HOCl aqueous stock solution (100K) was added. 100,000 ppm HOCl concentration in coagulant was achieved by dissolving ten Sanitab™ tablets that were powdered with mortar and added gradually in 100 ml of coagulant solution.
3) Sample 3=1% EC+12% Al(NO₃)₃+14% CN+1.8% CS+1% AC+3% KOH+1500 ppm HOCl+100 ml EtOH. In a 200 ml beaker, 4 g KOH was dissolved in 200 ml EtOH before 0.75 g EC was added to the solution. When all the EC was dissolved, 1.5 g AC was added dropwise and the solution was stirred overnight. 14 g CN and 12 g Al(NO₃)₃ were then added to the coagulant solution and dissolved completely before 1.8 g CS was added whilst stirred at 1000 rpm. Then 2 ml of a HOCl aqueous stock solution (100K) was added.

The samples were prepared by immersing a pre-warmed glass bottle in 100 ml of the corresponding coagulant tank for 1 min. The resulting layer of coagulant was dried in the oven at 100° C. for 15 min to form a clear coagulant layer, then immersed in a 100 ml nitrile tank for 2 minutes. The bottle was then placed in the oven at 100° C. for 15 minutes, taken out to cool and the resulting material peeled off gently.

As can be seen from FIG. 8, the sample which included EC/Ca and an additional polymeric ionophore:ion complex of EC/Al (Sample 3) demonstrated superior antimicrobial activity compared to the sample with only EC/Ca polymeric ionophore:ion complex (Sample 2). This result suggests the enhancement in antimicrobial activity by the addition of an extra lipophilic polymeric ionophore:ion complex.

### Antibacterial Effect:

1) Sample PG (control): Commercially available purple gloves.
2) Sample 1: 0.5% EC+0.5% Al(NO₃)₃+14% CN+1.8% CS+0.5% acryloyl chloride+1.5% KOH+100 ml EtOH. In a 200 ml beaker, 1.5 g KOH was dissolved in 200 ml EtOH before 0.5 g EC was added to the solution. When all the EC was dissolved, 0.5 g AC was added dropwise and the solution was stirred overnight. 14 g CN and 0.5 g Al(NO₃)₃ were then added to the coagulant solution and dissolved completely before 1.8 g CS was added whilst stirred at 1000 rpm.
3) Sample 2: 0.5% EC+1% Al(NO₃)₃+14% CN+1.8% CS+0.5% AC+1.5% KOH+100 ml EtOH. Same as Sample 1 above except that 1 g Al(NO₃)₃ was added to the coagulant solution.
4) Sample 3: 0.5% EC+3% Al(NO₃)₃+14% CN+1.8% CS+0.5% AC+1.5% KOH+100 ml EtOH. Same as sample 1 above except that 3 g Al(NO₃)₃ was added to the coagulant solution.

As can be seen from FIG. 9, different concentrations of the additional polymeric ionophore:ion complex (EC/Al) were tested (0.5%-3%) and, interestingly, the sample with the lowest concentration demonstrated the highest antibacterial activity, suggesting the existence of an optimal concentration.

The above experiments investigated improvements to antimicrobial gloves in terms of maintaining a high antibacterial activity whilst minimising leaching following contact or wash, which is vital for the correct functioning of the glove. Formulations utilising EC were the most difficult samples to work with in terms of viral recovery. Samples with coagulant coatings including EC demonstrated reduced surface tension, hence virus suspension, would spread out on the surface of the samples (and at times drip from the side of the test sample) so the recovery was not complete, and the reliability of the experiments compromised. As a result, the viral testing protocol was optimised and modified through many rounds of testing and iteration in a reliable manner and as close as possible to the ISO standard.

### Example 2—Antibacterial (Gram-Negative & Gram-Positive) Coagulant Formulations

The following experiments were carried out based on the following coagulant formulation:
0.5% ethyl cellulose (EC)+0.5% acryloyl chloride+2% KOH+14% Ca(NO₃)₂+1.8% calcium stearate

This formulation was selected because the properties of the resulting gloves (antimicrobial performance for gram-positive bacteria and virus), and the quality of the glove material (material transfer and mechanical appearance) were the best among other formulations tested.

The coagulant formulation was performed in two steps:

### 1. Functionalisation of Ethyl Cellulose

This step was started by dissolving 2% potassium hydroxide (KOH) in ethanol to prepare an alkaline solution. Then, 0.5% ethyl cellulose (EC) was added to the solution: while EC dissolves in the solution, the hydroxyl group of EC converts to negative oxygen.

Once the EC had dissolved completely, 0.5% Acryloyl chloride as the functionaliser was added dropwise to the solution. The solution was stirred overnight to complete the reaction. As illustrated in the chemical scheme of FIG. 10, the potassium chloride (KCl) is the side product of this reaction. When the reaction is completed, the functionalised EC remains as the colloidal dispersion in the solution mixture.

### 2. Addition of Coagulant and Releasing Agents

On day 2, 14% Calcium nitrate was added to the dispersion formed in step 1 and allowed to dissolve completely. A percentage of Ca²⁺ ions will make a lipophilic complex with EC and the remaining Ca²⁺ ions will stay as the coagulation agent in the dispersion. Then, 1.8% Calcium stearate (as the anti-tack agent to aid release of the material from the former after manufacturing) was added slowly to the mixture and the mixture was stirred for a few hours to create a homogenous coagulant solution (dispersion) ready for a nitrile glove manufacturing process.

Despite the good quality of the resulting gloves, their antimicrobial activity against gram-negative bacteria was weaker compared to gram-positive bacteria. As a result, it was decided to add different types of antimicrobial agents to the coagulant formulations.

Among these additives, higher percentages of KOH (4% or 6%) in coagulant formulations (as an effective agent against gram-negative bacteria) showed the best results. 8% KOH was also tested and showed enhanced antimicrobial activity, albeit with some reduction in the quality of the final glove material.

Materials made with coagulant formulations including 4% or 6% KOH also showed some reduction in mechanical properties and qualities. The extra KOH can react with Ca(NO₃)₂ and create insoluble Ca(OH)₂ in the coagulant which is seen as a solid sediment in the coagulant. This sediment makes the coagulant non-homogenous and remains on the glove former. It also causes pinholes and powdery residues on the prepared gloves. Ca(OH)₂ or slaked lime is extremely insoluble in ethanolic solution and is only slightly soluble in water.

In contrast, the addition of extra KOH to the coagulant is believed to create a poly-electrolyte dispersion of different ions and salts in solution, which may lead to some reversible ion exchange reactions.

The homogeneity of coagulant is an important parameter on glove quality and a major challenge is to dissolve the Ca(OH)₂ in the coagulant formulation. As a result, the aim of the following experiments was to identify effective solvents for dissolving Ca(OH)₂ in a coagulant formulation.

### Experiment 1

### Materials and Methods for the Most Effective Samples:

Coagulant Formulation Sample 8: 0.5% EC+14% CN+1.8% CS+0.5% AC+4% KOH+0.5% Al(NO₃)₃+100 ml EtOH:

In a 250 ml beaker, 4 g KOH was dissolved in 100 ml EtOH and 0.5 g EC was then added to the solution. When all EC was dissolved, 0.5 g liquid AC was added dropwise and the solution was stirred overnight. 14 g CN and 0.5 g Al(NO₃)₃ were then added to the solution and, when dissolved completely, 1.8 g CS was added while the coagulant was stirred at 1000 rpm.

Coagulant Formulation Sample 9=0.5% EC+14% CN+1.8% CS+0.5% AC+8% KOH+0.5% Al(NO₃)₃+100 ml EtOH:

In a 250 ml beaker, 8 g KOH was dissolved in 100 ml EtOH and 0.5 g EC was then added to the solution. Once all EC was dissolved, 0.5 g liquid AC was added dropwise and the solution was stirred overnight. 14 g CN and 0.5 g Al(NO₃)₃ were then added to the solution and, once dissolved completely, 1.8 g CS was added while the coagulant was stirred at 1000 rpm.

Coagulant Formulation sample 17: 0.5% HPC+14% CN+1.8% CS+0.5% AC+4% KOH+0.5% Al(NO₃)₃+1% Eugenol+100 ml EtOH:

In a 250 ml beaker, 4 g KOH was dissolved in 100 ml EtOH before 0.5 g hydroxypropyl cellulose (HPC) was added to the solution. Once all HPC was dissolved, 0.5 g liquid AC was added dropwise and the solution was stirred overnight. 14 g CN, 0.5 g Al(NO₃)₃ and 1 g eugenol were added to the solution and, once dissolved completely, 1.8 g CS was then added while the coagulant was stirred at 1000 rpm.

Coagulant Formulation sample 18: 0.5% EC+14% CN+1.8% CS+0.5% AC+4% KOH+0.5% Al(NO₃)₃+1% Eugenol+100 ml EtOH:

In a 250 ml beaker, 4 g KOH was dissolved in 100 ml EtOH and 0.5 g EC was then added to the solution. Once all EC was dissolved, 0.5 g liquid AC was added dropwise and the solution was stirred overnight. 14 g CN, 0.5 g Al(NO₃)₃ and 1 g eugenol were added to the solution and, once dissolved completely, 1.8 g CS was added while the coagulant was stirred at 1000 rpm.

### Glove Production

Nitrile gloves samples were prepared by immersing a pre-warmed glass bottle former in a 100 ml coagulant tank for 1 min. The resulting layer of coagulant was dried in an oven at 100° C. for 15 min to form a clear coagulant layer, then immersed in a 100 ml nitrile tank for 2 minutes. Nitrile compound was obtained from Unigloves (UK) Ltd. The bottle former was then placed in an oven at 100° C. for 15 minutes. After cooling, the resulting material was peeled off gently and the inner layer was placed face upwards in a Petri dish for antimicrobial testing as described hereinabove. In addition, a thin polypropylene film was prepared by hot pressing and used as a control for all gloves samples.

### Results:

In this experiment different agents with potential antimicrobial activity were devised and tested to improve antibacterial activity specifically against gram-negative bacteria. Agents included citric acid, hypochlorous acid, dimethylaminoethyl acrylate (DA) monomer alone and also mixed with ascorbic acid, EDTA, eugenol and increased levels of KOH. The polymer in the polymeric ionophore:ion complex was also changed to HPC as a more amphiphilic polymer rather than EC.

FIGS. 11, 12 and 13 show the results for Coagulant Formulation Sample numbers 3 to 9 and FIGS. 14 and 15 show the results for Coagulant Formulation Sample numbers 17 and 18. Results for Coagulant Formulation Sample Nos 10 to 16 are not shown. It can be seen from the figures that, of the different formulations tested, the ones with higher levels of KOH and samples containing eugenol demonstrated the highest antibacterial activity against gram-negative bacteria. Activity against gram-positive bacteria was lower for the samples containing higher KOH relative to the samples containing eugenol.

### Conclusions:

Samples with a higher percentage of KOH provided very good antibacterial activity against gram-negative E. coli in 60 minutes, with complete inhibition achieved with 8% KOH and almost 1-log reduction in 5 minutes. However, the gloves looked slightly powdery.

Samples with 4% KOH showed nearly complete inhibition in 60 minutes and the material had a better appearance and quality. Results were lower with gram-positive S. aureus and all formulations showed similar inhibition. This may have been caused by an older batch of nitrile as subsequent experiments showed that there was generally a trend for lower antimicrobial activity with older, and perhaps expired, nitriles. Also there seemed to be a neutral to weak negative trend for gram-positive inhibition with higher KOH, so an optimal point needed to be identified that provides acceptable inhibition for both gram-positive and gram-negative bacteria.

Other samples with promising results were those that included eugenol.

### Experiment 2

### Materials and Methods for Some Coagulant Formulations Tested:

Coagulant sample 1: 0.5% EC+14% CN+1.8% CS+0.5% AC+2% KOH+100 ml EtOH:

In a 250 ml beaker, 14 g CN was added to 100 ml of an EC stock solution and the mixture was stirred until all components were dissolved completely. 1.8 g CS was then added while the coagulant was stirred at 1000 rpm.

Coagulant sample 2: 0.5% EC+14% CN+1.8% CS+0.5% AC+2% KOH+0.5% Al(NO₃)₃+100 ml EtOH:

In a 250 ml beaker, 14 g CN and 0.5 g Al(NO₃)₃ were added to 100 ml of an EC stock solution and the mixture was stirred until all components were dissolved completely. 1.8 g CS added then added while the coagulant was stirred at 1000 rpm.

Coagulant sample 3: 0.5% EC+14% CN+1.8% CS+0.5% AC+5% KOH+100 ml EtOH:

In a 250 ml beaker, 5 g KOH was dissolved in 100 ml EtOH before 0.5 g EC was added to the solution. Once all the EC was dissolved, 0.5 g liquid AC was added dropwise and the solution was stirred overnight. 14 g CN was then added to the solution and, once dissolved completely, 1.8 g CS added while the coagulant was stirred at 1000 rpm.
Sample 1: 0.5% EC+14% CN+1.8% CS+0.5% AC+2% KOH+100 ml EtOH
Sample 2: 0.5% EC+14% CN+1.8% CS+0.5% AC+2% KOH+0.5% Al(NO₃)₃+100 ml EtOH
Sample 3: 0.5% EC+14% CN+1.8% CS+0.5% AC+5% KOH+100 ml EtOH
Sample 4: 0.5% EC+14% CN+1.8% CS+0.5% AC+5% KOH+0.5% Al(NO₃)₃+100 ml EtOH
Sample 5: 0.5% EC+14% CN+1.8% CS+0.5% AC+5% KOH+1% NaOH+100 ml EtOH
Sample 6: 0.4% HPC+0.1% EC+14% CN+1.8% CS+0.5% AC+2% KOH+100 ml EtOH
Sample 7: 0.4% HPC+0.1% EC+14% CN+1.8% CS+0.5% AC+2% KOH+0.5% Al(NO₃)₃+100 ml EtOH
Sample 8: 0.4% HPC+0.1% EC+14% CN+1.8% CS+0.5% AC+5% KOH+100 ml EtOH
Sample 9: 0.4% HPC+0.1% EC+14% CN+1.8% CS+0.5% AC+5% KOH+0.5% Al(NO₃)₃+100 ml EtOH
Sample 10: 0.4% HPC+0.1% EC+14% CN+1.8% CS+0.5% AC+5% KOH+1% NaOH+100 ml EtOH
Sample 11: 0.4% HPC+0.1% EC+14% CN+1.8% CS+0.5% AC+5% KOH+1% Eugenol+100 ml EtOH
Sample 12: 0.4% Branched Polyethylenimine+0.1% EC+14% CN+1.8% CS+0.1% AC+2% KOH+100 ml EtOH
Sample 13: 0.4% Branched Polyethylenimine+0.1% EC+14% CN+1.8% CS+0.1% AC+5% KOH+100 ml EtOH.

### Glove Production

Nitrile glove samples were prepared as per the previous experiment.

### Results:

In this experiment, samples with higher KOH levels were tested again due to the promise that was observed in previous experiment. In addition, other formulations with potential antimicrobial activity were devised and tested to improve antibacterial activity specifically against gram-negative bacteria. Formulations included having a cationic surfactant (polymer) in the polymeric ionophore:ion complex to create a positive ionophore: negative ion complex as opposed to the usual negative ionophore: positive ion complex. Other formulations included having a more hydrophilic polymer (HPC) in addition to the usual EC polymer.

FIGS. 16 and 17 show the results of all samples tested, from which samples containing 5% KOH demonstrated the best activity. These samples demonstrated above 4 log reduction in 5 min against gram-positive bacteria and about 3 log in 60 mins against gram-negative bacteria.

### Conclusions:

Sample containing 5% KOH made with fresh nitrile displayed acceptable inhibition of bacterial growth for both gram-positive (above 4 log in 5 min) and also gram-negative (about 3 log in 60 mins) bacteria.

### Experiment 3

The following experiment tested the formulation from Experiment 2 for shorter bacterial contact time-points.

### Materials and Methods for the Most Promising Coagulant Formulation Tested:

### Coagulant Sample 4: 0.5% EC+14% CN+1.8% CS+0.5% AC+5% KOH+100 ml EtOH:

In a 250 ml beaker, 5 g KOH was dissolved in 100 ml EthOH before 0.5 g EC was added to the solution. Once all EC was dissolved, 0.5 g liquid AC was added dropwise, and the solution was stirred overnight. 14 g CN was added to the solution and, once dissolved completely, 1.8 g CS was added while the coagulant was stirred at 1000 rpm.

### Results:

In this experiment, the best performing sample from the previous experiment (sample containing 5% KOH) was used to test antibacterial activity at a shorter contact time-point (15 min). The formulation containing positive ionophore: negative ion was also tested on its own without the inclusion of the usual negative ionophore: positive ion complex.

FIGS. 18 and 19 show the results of all six formulations tested and, as can be seen, the results in this experiment were not promising: the sample containing 5% KOH did not display as strong antibacterial action as was seen in the previous experiment. This level of variability could be attributed to the challenges such as the side reactions. Another speculation is that, at high KOH concentrations, the coagulant solution may reach saturation of a side product which may cause inhomogeneities in the solution which may, in turn, cause inconsistencies between samples.

### Conclusions:

Sample containing 5% KOH did not demonstrate the similar antimicrobial activity as the previous experiment and this level of variability was attributed to the challenges such as the side reactions that were mentioned earlier in the report. Another speculation is that at high KOH concentrations the coagulant solution may reach saturation of a side product which may cause inhomogeneities in the solution which may in turn cause inconsistencies between samples.

### Experiment 4

Different formulations based on acrylation of EC, and different percentages of KOH with and without Al(NO₃)₃, were prepared to see whether the antibacterial activity of the nitrile material could be increased against both gram-negative and gram-positive bacteria. In addition, 5% water was added in some formulations to test whether the homogeneity of the coagulant solution could be increased by dissolving the Ca(OH)₂ by-product. Time periods of 5 min and 15 min were chosen as drying times of coagulant on the former to see whether there was any effect of drying time on the quality of gloves.

### Coagulant Preparation:

1. 0.5% EC+14% CN+1.8% CS+0.5% AC+4% KOH+0% water+100 ml EtOH; 5 min coagulant drying time

In a 250 ml beaker, 4 g KOH was dissolved in 100 ml EtOHI before 0.5 g EC was added to the solution. Once all EC was dissolved, 0.5 g liquid AC was added dropwise and the solution was stirred overnight. 14 g CN was added to the solution and, once dissolved completely, 1.8 g CS was added while the coagulant was stirred at 1000 rpm.

2. 0.5% EC+14% CN+1.8% CS+0.5% AC+4% KOH+5% water+95 ml EtOH; 5 min coagulant drying time

In a 250 ml beaker, 4 g KOH was dissolved in 95 ml EtOH before 0.5 g EC was added to the solution. Once all EC was dissolved, 0.5 g liquid AC was added dropwise, and the solutions were stirred overnight. 14 g CN and 5 ml double distilled water were added to the solution and, once dissolved completely, 1.8 g CS was added while the coagulant was stirred at 1000 rpm.

3. 0.5% EC+14% CN+1.8% CS+0.5% AC+4% KOH+0.5% Al(NO₃)₃+0% water+100 ml EtOH; 5 min coagulant drying time

In a 250 ml beaker, 4 g KOH was dissolved in 100 ml EtOH before 0.5 g EC was added to the solution. Once all EC was dissolved, 0.5 g liquid AC was added dropwise and the solution was stirred overnight. 14 g CN and 0.5 g Al(NO₃)₃ were added to the solution and, when dissolved completely, 1.8 g CS was added while the coagulant was stirred at 1000 rpm.

4. 0.5% EC+14% CN+1.8% CS+0.5% AC+4% KOH+0.5% Al(NO₃)₃+5% water+95 ml EtOH; 5 min coagulant drying time

In a 250 ml beaker, 4 gm KOH was dissolved in 95 ml EtOH before 0.5 g EC was added to the solution. Once all EC was dissolved, 0.5 g liquid AC was added dropwise and the solution was stirred overnight. 14 g CN, 0.5 g Al(NO₃) 3 and 5 ml double distilled water were added to the solution and, when dissolved completely, 1.8 g CS was added while the coagulant was stirred at 1000 rpm.

5. 0.5% EC+14% CN+1.8% CS+0.5% AC+4% KOH+0% water+100 ml EtOH; 15 min coagulant drying time

### Coagulant Preparation as Per Sample 1

6. 0.5% EC+14% CN+1.8% CS+0.5% AC+4% KOH+5% water+95 ml EtOH; 15 min drying time of coagulant

### Coagulant Preparation as Per Sample 2

7. 0.5% EC+14% CN+1.8% CS+0.5% AC+4% KOH+0.5% Al(NO₃)₃+0% water+100 ml EtOH; 15 min coagulant drying time

### Coagulant Preparation as Per Sample 3

8. 0.5% EC+14% CN+1.8% CS+0.5% AC+4% KOH+0.5% Al(NO₃)₃+5% water+95 ml EtOH; 15 min coagulant drying time

### Coagulant Preparation as Per Sample 4

9. 0.5% EC+14% CN+1.8% CS+0.5% AC+6% KOH+0% water+100 ml EtOH; 5 min drying time of coagulant

In a 250 ml beaker, 6 g KOH was dissolved in 100 ml EtOH before 0.5 g EC was added to the solution. Once all EC was dissolved, 0.5 g liquid AC was added dropwise, and the solution was stirred overnight. 14 g CN was added to the solution and, when dissolved completely, 1.8 g CS was added while the coagulant was stirred at 1000 rpm.

10. 0.5% EC+14% CN+1.8% CS+0.5% AC+6% KOH+5% water+95 ml EtOH; 5 min coagulant drying time

In a 250 ml beaker, 6 g KOH was dissolved in 95 ml EtOH before 0.5 g EC was added to the solution. Once all EC was dissolved, 0.5 g liquid AC was added dropwise and the solution was stirred overnight. 14 g CN and 5 ml double distilled water were added to the solution and, when dissolved completely, 1.8 g CS was added while the coagulant was stirred at 1000 rpm.

11. 0.5% EC+14% CN+1.8% CS+0.5% AC+6% KOH+0.5% Al(NO₃)₃+0% water+100 ml EtOH; 5 min coagulant drying time

In a 250 ml beaker, 6 g KOH was dissolved in 100 ml EtOH before 0.5 g EC was added to the solution. Once all EC was dissolved, 0.5 g liquid AC was added dropwise and the solution was stirred overnight. 14 g CN and 0.5 g Al(NO₃)₃ were added to the solution and, once dissolved completely, 1.8 g CS was added while the coagulant was stirred at 1000 rpm.

12. 0.5% EC+14% CN+1.8% CS+0.5% AC+6% KOH+0.5% Al(NO₃)₃+5% water+95 ml EtOH; 5 min coagulant drying time

In a 250 ml beaker, 6 g KOH was dissolved in 95 ml EtOH before 0.5 g EC was added to the solution. Once all EC was dissolved, 0.5 g liquid AC was added dropwise and the solution was stirred overnight. 14 g CN, 0.5 g Al(NO₃)₃ and 5 ml double distilled water were added to the solution and, once dissolved completely, 1.8 g CS was added while the coagulant was stirred at 1000 rpm.

13. 0.5% EC+14% CN+1.8% CS+0.5% AC+6% KOH+0% water+100 ml EtOH; 15 min coagulant drying time

### Coagulant Preparation as Per Sample 9

14. 0.5% EC+14% CN+1.8% CS+0.5% AC+6% KOH+5% water+95 ml EtOH; 15 min coagulant drying time

### Coagulant Preparation as Per Sample 10

15. 0.5% EC+14% CN+1.8% CS+0.5% AC+4% KOH+0.5% Al(NO₃)₃+0% water+100 ml EtOH; 15 min coagulant drying time

### Coagulant Preparation as Per Sample 11

16. 0.5% EC+14% CN+1.8% CS+0.5% AC+6% KOH+0.5% Al(NO₃)₃+5% water+95 ml EtOH; 15 min coagulant drying time

### Coagulant Preparation as Per Sample 12

TABLE 1
Summary of formulations:

| | Water:Ethanol | KOH | Al(NO₃)₃ | Coagulant drying |
|---|---|---|---|---|
| Sample No | (%) | (%) | (%) | time (min) |
| 1 | 0:100 | 4 | 0 | 5 |
| 2 | 5:95 | 4 | 0 | 5 |
| 3 | 0:100 | 4 | 0.5 | 5 |
| 4 | 5:95 | 4 | 0.5 | 5 |
| 5 | 0:100 | 4 | 0 | 15 |
| 6 | 5:95 | 4 | 0 | 15 |
| 7 | 0:100 | 4 | 0.5 | 15 |
| 8 | 5:95 | 4 | 0.5 | 15 |
| 9 | 0:100 | 6 | 0 | 5 |
| 10 | 5:95 | 6 | 0 | 5 |
| 11 | 0:100 | 6 | 0.5 | 5 |
| 12 | 5:95 | 6 | 0.5 | 5 |
| 13 | 0:100 | 6 | 0 | 15 |
| 14 | 5:95 | 6 | 0 | 15 |
| 15 | 0:100 | 6 | 0.5 | 15 |
| 16 | 5:95 | 6 | 0.5 | 15 |

### Glove Preparation

Samples were prepared as described in the previous experiments with 5 min and 15 min drying times selected for coagulants.

### Results:

Since the samples containing higher KOH levels demonstrated the superior antibacterial activity against gram-negative bacteria in the previous experiments overall, it was sought to improve the homogeneity of the coagulant solution in this experiment to improve the mechanical properties of the gloves and also to improve consistency and reduce variability in the samples. Therefore, different percentages of KOH with and without Al(NO₃)₃ were prepared in solutions containing 5% water to increase the homogeneity of the coagulant solution by dissolving the Ca(OH)₂ by-product. Five min and 15 min drying times of coagulant on the former were also tested to see the effect of drying time on the quality of the gloves.

While the glove quality was much improved with the addition of water in the coagulant, the antimicrobial activity was not significantly different (see FIGS. 21 (S. aureus) and 22 (E. coli)).

The samples with 6% of KOH showed micro pinholes on the surface of gloves, as did the samples with 4% of KOH without water. An obvious improvement was seen in the samples that included 5% water compared to 0% water.

Inhibition of S. aureus was less across all formulations (FIG. 21). The small increase in efficacy from sample 13 onwards is likely due to the use of a new batch of neutralisation broth during testing which was still warm and was therefore more harsh to the cells. A consistent drop was seen in antibacterial activity with the addition of aluminium to the formulation, for both gram-positive and gram-negative results. 4% KOH samples show low inhibition around 1 log for E. coli in 60 minutes (FIG. 22). Full inhibition was achieved with 6% KOH in samples 9 and 13, and one of the two sample 10 replicates showed full inhibition. The homogeneity of the solutions and the quality of the gloves were generally improved with the addition of water.

### Experiment 5

The aim of this experiment was to investigate the role of water and glycerol as solvents of the coagulant formulation by-product Ca(OH)₂. Ca(OH)₂ is known to be soluble in glycerol, water, and some strong acids.

### Coagulant Preparation:

Coagulant formulations were prepared as per previous experiments. Calcium silicate, as a gram-negative antimicrobial agent, was added with calcium nitrate to some formulations.

TABLE 2
Summary of coagulant formulations. All formulations included
14% calcium nitrate and 1.8% calcium stearate:

| | Ethanol | Water | Glycerol | KOH | Calcium | | Coagulant | | *Material |
|---|---|---|---|---|---|---|---|---|---|
| Sample | (%) | (%) | (%) | (%) | silicate (%) | EC:AC(%) | drying time | | transfer |
| 1a | 100 | 0 | 0 | 2 | 0 | 0.5:0.5 | 5 | min | NO |
| 1b | 100 | 0 | 0 | 2 | 0 | 0.5:0.5 | 15 | min | NO |
| 1c | 100 | 0 | 0 | 2 | 1 | 0.5:0.5 | 5 | min | NO |
| 1d | 100 | 0 | 0 | 2 | 1 | 0.5:0.5 | 15 | min | YES/LESS |
| 2a | 94 | 5 | 1 | 4 | 0 | 0.5:0.5 | 5 | min | YES/LESS |
| 2b | 94 | 5 | 1 | 4 | 0 | 0.5:0.5 | 15 | min | YES/MORE |
| 2c | 94 | 5 | 1 | 4 | 1 | 0.5:0.5 | 5 | min | YES/MORE |
| 2d | 94 | 5 | 1 | 4 | 1 | 0.5:0.5 | 15 | min | YES/MANY |
| | | | | | | | | | MORE |
| 3a | 98 | 0 | 2 | 4 | 0 | 0.5:0.5 | 5 | min | NO |
| 3b | 98 | 0 | 2 | 4 | 0 | 0.5:0.5 | 15 | min | NO |
| 3c | 98 | 0 | 2 | 4 | 1 | 0.5:0.5 | 5 | min | YES/LESS |
| 3d | 98 | 0 | 2 | 4 | 1 | 0.5:0.5 | 15 | min | YES/MANY |
| | | | | | | | | | MORE |
| 4a | 94 | 5 | 1 | 5 | 0 | 0.5:0.5 | 5 | min | NO |
| 4b | 94 | 5 | 1 | 5 | 0 | 0.5:0.5 | 15 | min | YES/LESS |
| 4c | 94 | 5 | 1 | 5 | 1 | 0.5:0.5 | 5 | min | YES/MANY |
| | | | | | | | | | MORE |
| 4d | 94 | 5 | 1 | 5 | 1 | 0.5:0.5 | 15 | min | YES/MANY |
| | | | | | | | | | MORE |
| 5a | 98 | 0 | 2 | 5 | 0 | 0.5:0.5 | 5 | min | YES/MANY |
| | | | | | | | | | MORE |
| 5b | 98 | 0 | 2 | 5 | 0 | 0.5:0.5 | 15 | min | YES/MANY |
| | | | | | | | | | MORE |
| 5c | 98 | 0 | 2 | 5 | 1 | 0.5:0.5 | 5 | min | YES/MANY |
| | | | | | | | | | MORE |
| 5d | 98 | 0 | 2 | 5 | 1 | 0.5:0.5 | 15 | min | YES/MANY |
| | | | | | | | | | MORE |
| 6a | 94 | 5 | 1 | 6 | 0 | 0.5:0.5 | 5 | min | YES/MANY |
| | | | | | | | | | MORE |
| 6b | 94 | 5 | 1 | 6 | 0 | 0.5:0.5 | 15 | min | YES/MANY |
| | | | | | | | | | MORE |
| 6c | 94 | 5 | 1 | 6 | 1 | 0.5:0.5 | 5 | min | YES/MANY |
| | | | | | | | | | MORE |
| 6d | 94 | 5 | 1 | 6 | 1 | 0.5:0.5 | 15 | min | YES/MANY |
| | | | | | | | | | MORE |
| 7a | 98 | 0 | 2 | 6 | 0 | 0.5:0.5 | 5 | min | YES/MANY |
| | | | | | | | | | MORE |
| 7b | 98 | 0 | 2 | 6 | 0 | 0.5:0.5 | 15 | min | YES/MANY |
| | | | | | | | | | MORE |
| 7c | 98 | 0 | 2 | 6 | 1 | 0.5:0.5 | 5 | min | YES/MANY |
| | | | | | | | | | MORE |
| 7d | 98 | 0 | 2 | 6 | 1 | 0.5:0.5 | 15 | min | YES/MANY |

MORE
*Material transfer = Debris/material transfer was seen under the microscope around the bacterial cells when there was leaching.

### Glove Preparation:

The gloves were prepared as described in previous experiments except that nitrile compound was obtained from [NAME REDACTED]. Based on sample quality, only samples 1B, 1D, 2B, 2D, 4B, 4D, 6B, 6D were tested.

As shown in FIG. 23, sample 6B showed the highest log reduction, with one replicate very close to complete inhibition (one plate blank, one plate 2 colonies). In this experiment, complete inhibition would be around 3.8 log, due to the loss of viability of gram-negative bacteria on abiotic surfaces during the 60-minute contact time of the glass-slide control.

The homogeneity of the solutions and the quality of the gloves were generally improved following the water and/or glycerol additions.

### Experiment 6

Three fresh batches of nitrile compounds (A1, A2, and A3) were prepared by the following method, to assess compatibility with coagulant and other nitrile types:

### Day 0.

300 ml of Latex solution was poured into a 500 ml beaker and stirred for 30 min gently at 200 rpm. The pH was then adjusted to 9 by adding ammonium hydroxide drop by drop (3 ml).
After 1 hour, in a separate beaker, 16.5 g composite solution (provided by [NAME REDACTED] including an accelerator, vulcanisation agent, catalyst and dye) was diluted in 16.5 g double distilled water. The composite solution was added to the latex slowly while the latex was stirred gently at 500 rpm and the solution was kept under stirring overnight.

### Day 1.

25 ml water was added to the latex solution gently then the pH was checked. If the pH was around 10, there was no need to add any extra ammonium hydroxide. The solution was kept under stirred overnight.

### Day 2.

The solution was ready to use after 2 days of maturation.

### Coagulant Formulations:

Sample 1: 0.5% EC+14% CN+1.8% CS+0.5% AC+2% KOH+0% water+100 ml EtOH:

In a 250 ml beaker, 2 g KOH was dissolved in 100 ml EtOH before 0.5 g EC was added to the solution. Once all EC was dissolved, 0.5 g liquid AC was added dropwise and the solution was stirred overnight. 14 g CN was added to the solution and, once completely dissolved, 1.8 g CS was added while the coagulant was stirred at 1000 rpm.

Sample 2: 0.5% EC+14% CN+1.8% CS+0.5% AC+4% KOH+5% water+1% Glycerol+95 ml EtOH:

In a 250 ml beaker, 4 g KOH was dissolved in 95 ml EtOH before 0.5 g EC was added to the solution. Once all EC was dissolved, 0.5 g liquid AC was added dropwise and the solution was stirred overnight. 14 g CN, 1 g Glycerol and 5 ml double distilled water were added to the solution and, when completely dissolved, 1.8 g CS was added while the coagulant was stirred at 1000 rpm.

Sample 3: 0.5% EC+14% CN+1.8% CS+0.5% AC+6% KOH+5% water+1% Glycerol+95 ml EtOH:

In a 250 ml beaker, 6 g KOH was dissolved in 95 ml EtOH before 0.5 g EC was added to the solution. Once all EC was dissolved, 0.5 g liquid AC was added dropwise and the solution was stirred overnight. 14 g CN, 5 ml double distilled water and 1 g Glycerol were added to the solution and, once completely dissolved, 1.8 g CS was added while the coagulant was stirred at 1000 rpm.

Sample 4: 0.5% EC+14% CN+1.8% CS+0.5% AC+4% KOH+0% water+1% Glycerol+95 ml EtOH:

In a 250 ml beaker, 4 g KOH was dissolved in 95 ml EtOH before 0.5 g EC was added to the solution. Once all EC was dissolved, 0.5 g liquid AC was added dropwise, and the solution was stirred overnight. 14 g CN, 1 g Glycerol and 5 ml double distilled water were added to the solution and, when completely dissolved, 1.8 g CS was added while the coagulant was stirred at 1000 rpm.

Sample 5: 0.5% EC+14% CN+1.8% CS+0.5% AC+6% KOH+0% water+1% Glycerol+95 ml EtOH:

In a 250 ml beaker, 6 g KOH was dissolved in 95 ml EtOH before 0.5 g EC was added to the solution. Once all EC was dissolved, 0.5 g liquid AC was added dropwise, and the solution was stirred overnight. 14 g CN, 5 ml double distilled water and 1 g Glycerol were added to the solution and, when dissolved completely, 1.8 g CS was added while the coagulant was stirred at 1000 rpm.

### The Glove Preparation:

Each coagulant was used for four types of Nitriles—A0 (original batch of nitrile compound provided by [NAME REDACTED], denoted as sample 1 in FIGS. 24 and 25) and A1, A2 and A3 batches—so 20 pieces of glove material samples were prepared. The samples without water in the formulation were not tested for antibacterial activity due to their lower visual quality.

### Antibacterial Test Results:

Antibacterial effect was testing with ASTM method A in which:
Gram-negative Escherichia coli NCTC 12241 were tested with 60-minute contact times.
Gram-Positive Staphylococcus aureus NCTC 10788 were tested with 5-minute contact time. To confirm gram-positive results and as a biological check for the performance of NCTC 10788, the alternative Staphylococcus aureus strain NCTC 8325 was also tested for one nitrile type.

Most formulations showed complete inhibition of Staphylococcus aureus NCTC 10788 (FIG. 24). The alternative strain (FIG. 26) also showed a good log reduction. However, the 6% KOH was slightly more variable, possibly due to pin holes on the surface of the glove because one replicate achieved complete inhibition.

FIG. 25 shows the antibacterial activity of samples containing either 2%, 4% or 6% KOH. Since the original [NAME REDACTED] nitrile A0 (Sample 1 in this figure) demonstrated lower antibacterial activity compared to the Unigloves nitrile, speculation was raised as to the role of nitrile in the antibacterial activity. Hence different nitrile formulations were obtained from [NAME REDACTED]. Only samples containing 6% KOH managed to reach inhibitions such as those seen with Unigloves nitrile (2% KOH).

### Conclusions:

6% KOH showed the highest log reduction in gram-negative bacteria in a 60 minute time period, with the original nitrile and nitrile A1 showed acceptable gram-positive inhibition. However, there were still quality issues with these glove materials as there were pinholes.

### Experiment 7

The aim of this experiment was to test different protocols of coagulant preparation to improve the homogeneity of the coagulant solution further.

### Coagulant Preparation:

Table 3 sets out the coagulant formulations tested, all of which were prepared by the same methods as previous experiments. KOH was selected as an antibacterial agent against gram-negative bacteria and was added using two different methods to obtain the most homogenic coagulant mixture.

### Method M:

In a 250 ml beaker, 6 g KOH was dissolved in 95 ml EtOH before 0.5 g EC was added to the solution. Once all EC was dissolved, 0.5 g liquid AC was added dropwise, and the solution was stirred overnight. 14 g CN, 5 ml double distilled water and 1 g glycerol were added to the solution and, when dissolved completely, 1.8 g CS was added while the coagulant was stirred at 1000 rpm.

### Method O:

In a 250 ml beaker, 2 g KOH was dissolved in 95 ml EtOH before 0.5 g EC was added to the solution. Once all EC was dissolved, 0.5 g liquid AC was added dropwise, and the solution was stirred overnight. 14 g CN and the remaining amount of KOH (see table below) were dissolved in 5 ml water and 1 gram of Glycerol, before being added to the KOH/EtOH/acryloyl chloride solution. When dissolved completely, 1.8 g CS was added while the coagulant was stirred at 1000 rpm.

TABLE 3
Summary of coagulant formulations. All formulations included
14% w/v calcium nitrate and 1.8% w/v calcium stearate:

| Sample | Nitrile | Ethanol (%) | KOH (%) | EC:AC (%) | Glycerol:water (%) |
|---|---|---|---|---|---|
| 1) Control A₀ | A0 | 100 | 0 | 0 | 0 |
| 2) Control A₁ | A1 | 100 | 0 | 0 | 0 |
| 3) 2% A₀ | A0 | 100 | 2 | 0.5:0.5 | 0:0 |
| 4) 2% A₁ | A1 | 100 | 2 | 0.5:0.5 | 0:0 |
| 5) 4% A₀ | A0 | 95 | 4 | 0.5:0.5 | 1:5 |
| M method | | | | | |
| 6) 4% A₀ | A0 | 95 | 4 | 0.5:0.5 | 1:5 |
| O method | | | | | |
| 7) 4% A₁ | A1 | 95 | 4 | 0.5:0.5 | 1:5 |
| M method | | | | | |
| 8) 4% A₁ | A1 | 95 | 4 | 0.5:0.5 | 1:5 |
| O method | | | | | |
| 9) 6% A₀ | A0 | 95 | 6 | 0.5:0.5 | 1:5 |
| M method | | | | | |
| 10) 6% A₀ | A0 | 95 | 6 | 0.5:0.5 | 1:5 |
| O method | | | | | |
| 11) 6% A₁ | A1 | 95 | 6 | 0.5:0.5 | 1:5 |
| M method | | | | | |
| 12) 6% A₁ | A1 | 95 | 6 | 0.5:0.5 | 1:5 |
| O method | | | | | |

As seen in FIG. 27, the base formulation with 2% KOH (sample 3) showed an antibacterial effect of around 3.5 log reduction, suggesting there may have been some deterioration in the nitriles. However, three of the four formulations with 6% KOH achieved complete inhibition, (denoted by * in the Figure). The 6% KOH samples showed the highest log reduction for gram-negative, but show slightly lower antibacterial effect when prepared with method O and the A1 nitrile compound. Sample 11 was variable although one replicate was very close to complete inhibition with one and two colonies on the duplicate agar plates.

The above formulations were used to prepare nitrile glove material as described in previous experiments. However, in addition to the above methods, materials prepared also by a commercial manufacturing protocol were also prepared and compared. The commercial method is described below:
a) The former was cleaned using cleaning soap and hot water before being put in an oven to warm up to a temperature before dipping of about 60±2° C.
b) The former was dipped into the coagulant tank for 14 seconds and then put into a drying oven at 130° C. for 5 min. The former was taken out from the oven and allowed to cool down to 65° C.
c) The former was dipped into a Nitrile tank for 18 seconds to form a layer of nitrile film. Then the former with wet nitrile film was dipped into a water tank at 55° C. for 84 seconds. The wet gel film was put in the oven at 110° C. for 20 minutes to remove water and to vulcanize the glove. The former was removed from the oven and left to cool down.
d) Once cool, the material was gently peeled off the former and the inner layer was put face upwards for antimicrobial testing.

To further address concerns that material is leaching out from the glove, a protocol based on a zone-of-inhibition test was conducted (see methods sections for details). Leaching was investigated for different gloves and, on average, the gloves prepared using the [NAME REDACTED] protocol demonstrated lower leaching scores. However, as shown in FIG. 28 and Table 4, this was variable across different coagulant formulations.

TABLE 4

| | Average leaching score |
|---|---|
| Sample | (1 = none, 4 = max) |
| Abena | 1 |
| 1 | 1.5 |
| 2 | 2.5 |
| 3 | 2.5 |
| 4 | 3 |
| 5 | 3.5 |
| 6 | 2 |
| 7 | 1.5 |
| 8 | 1.5 |
| 9 | 4 |
| 10 | 2 |

In this set of experiments, the most effective solvents for dissolving Ca(OH)₂ in coagulant formulation were found to be water and glycerol. The experiments showed that the addition of 1% Glycerol and 5% water helped dissolve the Ca(OH)₂ and have no effect on the dispersibility of functionalised EC and other ions in coagulant.

### Experiment 8

The aim of this experiment was to compare two different methods of manufacturing gloves and compare antibacterial efficacy.

### First Method for Coagulant Preparation:

In a 250 ml beaker, the desired amount of KOH was dissolved in Ethanol then 0.5 gram EC was added to the solution. When all EC was dissolved 0.5 gram liquid Acryloyl chloride was added dropwise, and the solution was stirred overnight. Then the desired amount CN was added to the solution and when dissolved completely the desired amount of glycerol was added to the solution dropwise, and then the desired amount CS was added while the coagulant was stirred at 1000 rpm.

### Second Method for Coagulant Preparation:

In a 250 ml beaker, half of the desired amount of KOH was dissolved in 95 ml Ethanol then 0.5 gram EC was added to the solution. When all EC was dissolved 0.5 gram liquid Acryloyl chloride was added dropwise, and the solution was stirred overnight. Then the desired amount CN was added to the solution and when dissolved completely the rest of KOH, and the desired amount of glycerol were dissolved in 5 ml water and added to the solution dropwise, and then the desired amount of CS was added while the coagulant was stirred 1000 rpm.

The coagulants were sieved before glove processing to be sure there were not any large particles to prevent pinholes and sediments on gloves.

Glove Preparation with C_Method:

The gloves samples were prepared by immersing a pre-warmed glass bottle in a 100 ml coagulant tank for 1 min. The layer of coagulant was dried in an oven at 100° C. for 15 min to form a clear coagulant layer, then immersed in a 100 ml nitrile tank for 2 minutes. Then the bottle was placed in an oven at 100° C. for 15 minutes and then taken out to cool before the glove layer was peeled off gently and the inner layer as the upside was placed in a Petri dish for antimicrobial testing. Also, PP thin film was prepared by hot pressing and was used as the control for all glove samples.

Glove Preparation with H_Method:

The former was cleaned using cleaning soap and hot water. The former was put in the oven to warm and its temperature before dipping was around 60±2° C. The former was dipped into the coagulant tank for 14 seconds. Then the former was put into a drying oven at 130° C. for 5 min. The former was taken out from the oven and allowed to cool down to 65° C. Then the former was dipped into the Nitrile tank for 18 seconds to form a layer of nitrile film. Then the former with wet nitrile film was dipped into a 55° C. water tank for 84 seconds. The wet gel film was put in the oven at 110° C. for 20 minutes to remove water and to vulcanize the glove. Then the former was taken from the oven and left to cool down, the glove was peeled gently, and the inner layer was put upward for further microbial tastings.

Glove Samples were Prepared with Either the C_Method or the H_Method and the Following Coagulant Formulations:

TABLE 5

| | | Method of coagulant/ |
|---|---|---|
| | Coagulant formulation | glove preparation |
| 1 | 0.5% EC + 14% CN + 1.8% CS + 0.5% AC + 2% KOH + 100 | 1st coagulant method |
| | ml EtOH | C_Method for gloves |
| 2 | 0.5% EC + 14% CN + 1.8% CS + 0.5% AC + 4% KOH + 5% | 1st coagulant method |
| | water + 1% Glycerol + 95 ml EtOH | C_Method for gloves |
| 3 | 0.5% EC + 14% CN + 1.8% CS + 0.5% AC + 6% KOH + 5% | 1st coagulant method |
| | water + 1% Glycerol + 95 ml EtOH | C_Method for gloves |
| 4 | 0.5% EC + 14% CN + 1.8% CS + 0.5% AC + 4% KOH + 5% | 2nd coagulant method |
| | water + 1% Glycerol + 95 ml EtOH | C_Method for gloves |
| 5 | 0.5% EC + 14% CN + 1.8% CS + 0.5% AC + 6% KOH + 5% | 2nd coagulant method |
| | water + 1% Glycerol + 95 ml EtOH | C_Method for gloves |
| 6 | 0.5% EC + 14% CN + 1.8% CS + 0.5% ACe + 2% KOH + | 1st coagulant method |
| | 100 ml EtOH | H_Method for gloves |
| 7 | 0.5% EC + 14% CN + 1.8% CS + 0.5% AC + 4% KOH + 5% | 1st coagulant method |
| | water + 1% Glycerol + 95 ml EtOH | H_Method for gloves |
| 8 | 0.5% EC + 14% CN + 1.8% CS + 0.5% AC + 6% KOH + 5% | 1st coagulant method |
| | water + 1% Glycerol + 95 ml EtOH | H_Method for gloves |
| 9 | 0.5% EC + 14% CN + 1.8% CS + 0.5% AC + 4% KOH + 5% | 2nd coagulant method |
| | water + 1% Glycerol + 95 ml EtOH | H_Method for gloves |
| 10 | 0.5% EC + 14% CN + 1.8% CS + 0.5% AC + 6% KOH + 5% | 2nd coagulant method |
| | water + 1% Glycerol + 95 ml EtOH | H_Method for gloves |

Antibacterial testing was performed in triplicate, with gram-negative strain Pseudomonas aeruginosa PA01 with a 60-minute contact and gram-positive strain Staphylococcus aureus NCTC 10788 tested with a 5-minute contact time.

Results are shown in FIGS. 29 and 30. No clear trends were observed to determine which, if either, method gave the best antibacterial efficacy against both gram-positive and gram-negative bacteria.

### Experiment 9

### Deleted

### Experiment 10

The aim of this experiment was to determine an effective KOH concentration to be added to the EC formulation and its effect on antiviral efficacy. Following samples were tested with and without water and ethanol wash.

Coagulant formulations were prepared using the two different methods set out in Experiment 8, and the glove preparation for all samples was the C_Method.

TABLE 7

| | | Method of coagulant |
|---|---|---|
| | Coagulant formulation | preparation |
| 1 | 0.5% EC + 14% CN + 1.8% CS + 0.5% AC + 2% KOH + | First coagulant method |
| | 100 ml EtOH | |
| 2 | 0.5% EC + 14% CN + 1.8% CS + 0.5% AC + 6% KOH + | First coagulant method |
| | 5% water + 1% Glycerol + 95 ml EtOH | |
| 3 | 0.5% EC + 14% CN + 1.8% CS + 0.5% AC + 6% KOH + | Second coagulant method |
| | 5% water + 1% Glycerol + 95 ml EtOH | |

Controls: PP film; Abena glove

As shown in FIG. 33, the addition of 2% KOH to the ethanol based coagulant showed the best antiviral efficacy at around 4 log (99.99%). Both water and ethanol wash of the samples reduced the antiviral activity, except for the 6% KOH containing sample that was washed with water.

### Experiment 11

The aim of this experiment was to investigate whether the addition of glycerol to the base formulation helps retain antibacterial efficacy after washing.

The coagulant formulations set out below were prepared by the first method and the gloves were prepared by the C_method:

TABLE 8

| | Coagulant formulation |
|---|---|
| 1 | 0.5% EC + 14% CN + 1.8% CS + 0.5% AC + 2% KOH + 100 ml EtOH |
| 2 | 0.5% EC + 14% CN + 1.8% CS + 0.5% AC + 2% KOH + 1% Glycerol + 100 ml EtOH |
| 3 | 0.5% EC + 14% CN + 1.8% CS + 0.5% AC + 4% KOH + 1% Glycerol + 100 ml EtOH |
| 4 | 0.5% EC + 14% CN + 1.8% CS + 0.5% AC + 6% KOH + 1% Glycerol + 100 ml EtOH |

Control = Abena glove

As shown in FIGS. 34 and 35, the addition of glycerol to the coagulant formulation decreased the efficacy of the base formulation against gram-positive bacteria and showed no improvement for gram-negative bacteria.

### Experiment 12

The aim of this experiment was to optimise a coagulant formulation including 2% KOH and to investigate the effect of Acryloyl chloride (AC) on antiviral activity.

Samples were tested for antiviral activity.

The coagulant formulations set out in Table 9 were prepared with the first method described above, and gloves were prepared using the C_Method.

TABLE 9

| | Coagulant formulation |
|---|---|
| 1 | 0.5% EC + 14% CN + 1.8% CS + 0.5% AC + 2% KOH + 0.5% |
| | Glycerol + 100 ml EtOH |
| 2 | 0.5% EC + 14% CN + 1.8% CS + 2% KOH + 0.5% Glycerol + |
| | 100 ml EtOH |
| 3 | 0.5% EC + 14% CN + 1.8% CS + 0.5% AC + 2% KOH + 1% |
| | Glycerol + 100 ml EtOH |
| 4 | 0.5% EC + 14% CN + 1.8% CS + 2% KOH + 1% Glycerol + |
| | 100 ml EtOH |

Control = PP film.

FIG. 38 shows the effect of the presence of acryloyl chloride on antiviral efficacy.

Omitting the functionaliser with 2% KOH appeared to boost the antiviral activity of the coagulant formulations, particularly in the presence of 0.5% glycerol.

### Experiment 13

The aim of this experiment was to assess whether a coagulant formulation including Ca(OH)₂ has enhanced gram-positive antibacterial activity and increased activity against gram-negative bacteria.

The coagulant formulations set out in Table 10 were prepared using the first method and the gloves were prepared using the C_Method.

TABLE 10

| | Coagulant formulation | Method of adding Ca(OH)₂ |
|---|---|---|
| 1 | 0.5% EC + 14% CN + 1.8% CS + 0.5% AC + 2% KOH + | — |
| | 1% Glycerol + 100 ml EtOH | |
| 2 | 0.5% EC + 0.5% AC + 2% KOH + 3% Ca(OH)₂ + 1% | Ca(OH)₂ was dissolved in water |
| | Glycerol + 14% Ca(NO₃)₂ + 1.5% CS + 95 ml EtOH + | and glycerol and added in first |
| | 5 ml water | step |
| 3 | 0.5% EC + 0.5% AC + 2% KOH + 3% Ca(OH)₂ + 1% | Ca(OH)₂ was dissolved in water |
| | Glycerol 14% Ca(NO₃)₂ + 1.5% CS + 95 ml EtOH + | and glycerol and added in second |
| | 5 ml water | step |

As shown in FIGS. 40 and 41, the addition of Ca(OH)₂ in the first step increased efficacy against gram-negative bacteria compared to the base formulation, but decreased efficacy against gram-positive bacteria. The converse is found when Ca(OH)₂ was added in the second step.

### Experiment 14

The aim of this experiment was to test the effects of different functionalisers particularly to assess whether antibacterial efficacy after washing with water could be enhanced.

The coagulants set out in Table 11 were formulated using the first method and gloves were prepared using the C_Method.

TABLE 11

| | Coagulant formulation |
|---|---|
| 1 | 0.5% EC + 14% CN + 1.8% CS + 2% KOH + 0.5% Allyl glycydil |
| | ether + 1% Glycerol + 100 ml EtOH |
| 2 | 0.5% EC + 14% CN + 1.8% CS + 2% KOH + 0.5% methacrylate |
| | glycydil ether + 1% Glycerol + 100 ml EtOH |
| 3 | 0.5% EC + 14% CN + 1.8% CS + 0.5% Acryloyl chloride + 2% |
| | KOH + 1% Glycerol + 100 ml EtOH |
| 4 | 0.5% EC + 14% CN + 1.8% CS + 0.5% Acryloyl chloride + 4% |
| | KOH + 2% Glycerol + 5% Water + 95 ml EtOH |

Samples 1, 2 and 3 were tested against gram-positive bacteria before and after washing to see the effect of a different functionaliser. Samples 3 and 4 only were tested with gram-negative to investigate further the enhancement of gram-negative activity by increasing KOH concentration.

As seen in FIGS. 42 and 43, changing functionaliser showed no improvement in gram-positive antibacterial activity after washing. Results were also similar between different KOH concentrations when tested against gram-negative bacteria.

### Example 3—Dipping Methods

The primary objective of the following experiments was to consider other steps that could be added to improve the glove production process. A new approach of having a third and/or fourth tank, which would hold additional formulations into which the formers would be dipped prior to the coagulant and nitrile tanks.

A series of formulations were tested as listed below to see whether the compatibility and bonding between the layers could be improved. The former was dipped into an extra tank that contained a solution of 0.5% Sodium carboxymethyl cellulose (Na-CMC) and dried prior to being dipped into the normal coagulant and dried, followed by dipping into Nitrile and drying.
1) Sample 1: Control material made using Commercial Coagulant (14% calcium nitrate (CN)+1.8% calcium stearate) as previously described.
2) Sample 2: First layer=3% CMC+25 Kppm HOCl+0.1% plasticiser+1% Calcium stearate; second layer=commercial coagulant+0.5% Na-CMC; third layer=nitrile. 3 gram Na-CMC (MW: 90K) was dissolved in 100 ml distilled water to obtain a 3% Na-CMC solution. 1 gram of calcium stearate, 100 μl of dibutyl sebacate as the plasticiser, and 2.5 Sanitab tablets were added to the solution and stirred until all ingredients were dissolved completely. A glass bottle was warmed by placing it in the oven at 100° C. for a few mins and then immersed in the CMC tank for 1 min and then placed in the oven at 100° C. for 10 min to be dried completely. Separately, the coagulant tank was prepared by dissolving 0.5 gram of Na-CMC in 100 ml commercial coagulant. The bottle was immersed in this 100 ml of 0.5% CMC coagulant tank for 30 sec, placed in the oven at 100° C. for 1 minute and then immersed in a nitrile tank for 1 min. Finally, the bottle was placed in the oven at 100° C. for 15 min for the final drying stage. Then the bottle was taken out from the oven and the resulting material was peeled off gently.
3) Sample 3: First layer=4% CMC+40K ppm HOCl+0.1% plasticiser+1% Calcium stearate; second layer=commercial coagulant+0.5% Na-CMC; third layer=nitrile. 4 gram Na-CMC (MW: 90K) was dissolved in 100 ml distilled water to obtain a 3% Na-CMC solution. 1 gram of calcium stearate, 100 μl of dibutyl sebacate as the plasticiser, and four Sanitab tablets were added to the solution and stirred until all ingredients were dissolved completely. A glass bottle was warmed by placing it in the oven at 100° C. for a few mins, immersed in the CMC tank for 1 min and then placed in the oven at 100° C. for 10 min to be dried completely. Separately, the coagulant tank was prepared by dissolving 0.5 gram of Na-CMC in 100 ml commercial coagulant. The bottle was immersed in this 100 ml of 0.5% CMC coagulant tank for 30 sec, placed in the oven at 100° C. for 1 minute and then immersed in a nitrile tank for 1 min. Finally, the bottle was placed in the oven at 100° C. for 15 min for the final drying stage. Then the bottle was taken out from the oven and the resulting material was peeled off gently.
4) Sample 4: First layer=4% CMC+0.1% plasticiser+1% Calcium stearate; second layer=commercial coagulant+0.5% Na-CMC; third layer=nitrile. 4 gram Na-CMC (MW: 90K) was dissolved in 100 ml distilled water to obtain a 3% Na-CMC solution. 1 gram of calcium stearate and 100 μl of dibutyl sebacate as the plasticiser were added to the solution and stirred until all ingredients were dissolved completely. A glass bottle was warmed by placing it in the oven at 100° C. for 10 mins and then immersed in the CMC tank for 1 min before being placed in the oven at 100° C. for 10 mins to be dried completely. Separately, the coagulant tank was prepared by dissolving 0.5 gram of Na-CMC in 100 ml commercial coagulant. The bottle was immersed in this 100 ml of 0.5% CMC coagulant tank for 30 sec, placed in the oven at 100° C. for 1 minute before being immersed in a nitrile tank for 1 min. Finally, the bottle was placed in the oven at 100° C. for 15 min for the final drying stage. Then the bottle was taken out from the oven and the resulting material was peeled off gently.

As shown in FIG. 44, Sample 2 was the only sample that demonstrated antimicrobial activity, although not significantly. The weak antimicrobial results were attributed to dissolution of the first layer of coagulant, which contains the active agent, into the second layer coagulant tank as described previously.

A four-tank method was then investigated in which a combination of CMC and EC was included in a second insulating layer to increase the compatibility and as a ‘bridge’ between the first layer polymer and the nitrile polymers. The formulations below were prepared and tested:
1) Sample 1: Control material made using Commercial Coagulant (14% calcium nitrate (CN)+1.8% calcium stearate) as previously described.
2) Sample 2: First layer=0.5% Na-CMC+25 Kppm HOCl+0.1% plasticiser+0.1% Calcium stearate; Second layer=0.5% Na-CMC+1.065% EC+25K HOCl+0.1% plasticiser; third layer=commercial coagulant+0.5% Na-CMC; fourth layer=nitrile. 0.5 gram of Na-CMC (MW: 700K) was dissolved in 25 ml of distilled water. 0.1 g calcium stearate, 100 μl dibutyl sebacate as the plasticiser, and 2.5 Sanitab tablets were added to the solution and stirred until all ingredients were dissolved completely. Separately, a stock solution of EC in ethanol was prepared by dissolving 2.2 g EC in 100 ml ethanol. 75 ml EC stock solution was added drop by drop to the first solution whilst stirred at 1000 rpm to obtain a homogenous suspension. A glass bottle was placed in the oven at 100° C. for a few mins to be warmed and was then immersed in the first tank containing CMC for 1 min before being placed in the oven at 100° C. for 10 min to be dried completely. The bottle was then immersed for a 1 min in the EC mixture tank and dried in the 100° C. oven for 1 min. Separately, the coagulant tank was prepared by dissolving 0.5 g Na-CMC in 100 ml commercial coagulant. The bottle was immersed in 100 ml of this solution for 30 sec and then placed in the oven at 100° C. for 1 minute before being immersed in a nitrile tank for 1 min. Finally, the bottle was placed in the oven at 100° C. for 15 min for final drying. The bottle was taken out from the oven and the resulting material was peeled off gently.

As seen in FIG. 45, the test sample displayed a 2 log viral reduction in 1 min contact time. The results of these experiments were promising as 2 log viral reduction was observed in 1 min contact time. No significant dissolution of the first layer following dipping into the second insulating layer was observed, hence it was concluded that having an insulating layer is important in the synthesis of gloves in this setting.

As mentioned in Example 1, an ethanol-based coagulant was prepared which had the capability of dissolving ethyl cellulose. The following experiments sought to mix the second insulating layer tank and the coagulant solution tank as they were both ethanol-based now and could be mixed effectively. This would significantly make the production process simpler by removing the need for four tanks. A series of formulations were prepared as follows based on this plan:
1) Sample 1: Control material made using Commercial Coagulant (14% calcium nitrate (CN)+1.8% calcium stearate) as previously described.
2) Sample 2: First layer=1% Na-CMC+25 Kppm HOCl+0.1% plasticiser; second layer coagulant=2.2% EC+14% CN+0.5% PEG+0.1% plasticiser; third layer=commercial nitrile. 1 gram of Na-CMC (MW: 700K) was dissolved in 100 ml distilled water to obtain 1% Na-CMC solution. 100 μl dibutyl sebacate as the plasticiser and 2.5 Sanitab tablets were added to the solution and stirred until all ingredients were dissolved completely. A glass bottle was placed in an oven at 100° C. for a few mins to be warmed and was then immersed in the CMC tank for 1 min. The bottle was then placed in the oven at 100° C. for 10 min to be dried completely. Separately, the coagulant tank was prepared by dissolving 2.2 g EC, 14 g CN, 0.5 g polyethylene glycol (PEG; MW: 1000) and 100 μl dibutyl sebacate in 100 ml absolute ethanol. The bottle was immersed in 100 ml of new coagulant tank for 30 sec, placed in the oven at 100° C. for 1 minute to dry and then immersed in the nitrile tank for 1 min. Finally, the bottle was placed in the oven at 100° C. for 15 min for final drying. Once dry, the bottle was taken out from the oven and the resulting material was peeled off gently.
3) Sample 3: First layer=1% Na-CMC+25 Kppm HOCl+0.1% plasticiser; second layer coagulant=2.2% EC+14% CN+0.5% PEG+0.1% plasticiser; third layer=0.5% Na-CMC+nitrile). 1 g Na-CMC (MW: 700K) was dissolved in 100 ml distilled water to obtain 1% Na-CMC solution. 100 μl dibutyl sebacate as the plasticiser and 2.5 Sanitab tablets were added to the solution and stirred until all ingredients were dissolved completely. A glass bottle was placed in the oven at 100° C. for a few mins to be warmed then immersed in the CMC tank for 1 min before being placed in the oven at 100° C. for 10 min to be dried completely. Separately, the coagulant tank was prepared by dissolving 2.2 g EC, 14 g CN, 0.5 g PEG (MW: 1000) and 100 μl dibutyl sebacate in 100 ml absolute EtOH. The bottle was immersed in 100 ml of new coagulant tank for 30 sec, placed in the oven at 100° C. for 1 minute, and then immersed in 100 ml nitrile tank which included 0.5 g dissolved Na-CMC for 1 min. Finally, the bottle was placed in the oven at 100° C. for 15 min for final drying. Once dry, the bottle was taken out from the oven and the resulting material was peeled off gently.

As seen in FIG. 46, both test samples demonstrated high antiviral results in 1 min contact time.

The coagulant formulations tested above, which now contained EC in addition to the usual ingredients of 14% CN, 1.8% CS and wetting agents, had a good performance as an insulating layer and no significant dissolution of the first layer in the second insulating/coagulant layer was observed, which was a significant improvement. More than 6 log viral reduction in 1 min contact time was also seen for Sample 2.

It had been appreciated from the experiments in Example 1 that washing of the samples with either water or ethanol would lead to material transfer and leaching of the antimicrobial agents and therefore they would deteriorate in antiviral action. In order to enhance the adhesion and bonding of the first (antimicrobial) layer to the second/third coagulant and nitrile layers, a similar approach to that discussed in Example 1 was used, namely to functionalise the polymers without functional groups in the formulation (i.e. CMC and EC) so that the chemical entities could participate in the vulcanisation process and create strong bond and adhesion between the layers. The formulations are described below:

### Coagulant Preparation:

First Layer: 0.5% Na-CMC+1% KOH+0.5% functionaliser+1% HOCl

0.5 gram Na-CMC (700K) was dissolved in water followed by 1 gram KOH in the solution. After dissolving completely, 0.5 gram acryloyl chloride was added drop by drop to the solution which was stirred overnight. One Sanitab tablet was then added to the solution. FIG. 47 shows the chemical reaction of Na-CMC with acryloyl chloride to make functionalised Na-CMC.

Second layer: 0.5% EC+14% CN+1% Acryloyl chloride+2% KOH+100 ml EtOH

In a 200 ml beaker, 1 gram KOH was dissolved in 100 ml ethanol before 0.5 gram EC was added to the solution. When all the EC was dissolved, 0.5 g AC was added dropwise and the solution stirred overnight. Then 14 g CN was added to the coagulant solution and stirred at 1500 rpm.

### Glove Processing

Once the solutions above were prepared, gloves samples were prepared by immersing a pre-warmed glass bottle in 100 ml of the first solution (first layer tank) for 1 min. The first layer was dried in the oven at 100° C. for 15 min to form a clear coagulant layer. The bottle was then immersed in the second coagulant tank for 2 mins, placed in the oven at 100° C. for 15 minutes, and then immersed in a nitrile tank for 2 min before being placed in the oven at 100° C. for 15 min.

On taking the bottle out of the oven the resulting material was peeled off gently and placed in a Petri dish for antimicrobial testing.

The above experiment was repeated using a commercial water-based coagulant lacking EC, but the film formation was not sufficient. As a result, this emphasised that the existence of EC was necessary for the compatibility between the CMC polymer and the nitrile polymers as a bridge between the two.

### Example 4—Cure Time for Glove Manufacture

Efficiencies in commercial manufacturing processes are always being sought and time for certain processes is one such area of interest. As a result, the following experiment compared the effect of different cure times and cure temperatures of samples made with a coagulant formulation as set out in Table 12 including 2% KOH or Table 13 including 4% KOH.

Coagulant formulations were prepared with the first method set out above and gloves were made using the C_Method described herein above.

TABLE 12

| | | coagulant drying |
|---|---|---|
| | Coagulant formulation | time/temp. |
| 1 | 0.5% EC + 0.5% AC + 2% KOH + 1.5% CS + 14% CN + 1% | 2 minute/100° C. |
| | Glycerol + 100 ml Ethanol | |
| 2 | 0.5% EC + 0.5% AC + 2% KOH + 0.7% CS + 14% CN (+6% | 2 minute/100° C. |
| | extra Water) + 1% Glycerol + 93 ml Ethanol | |
| 3 | 0.5% EC + 0.5% AC + 2% KOH + 1.5% CS + 14% CN + 1% | 2 minute/125° C. |
| | Glycerol + 100 ml Ethanol | |
| 4 | 0.5% EC + 0.5% AC + 2% KOH + 0.7% CS + 14% CN (+6% | 2 minute/125° C. |
| | extra Water) + 1% Glycerol + 93 ml Ethanol | |
| 5 | 0.5% EC + 0.5% AC + 2% KOH + 1.5% CS + 14% CN + 1% | 7 minute/100° C. |
| | Glycerol + 100 ml Ethanol | |
| 6 | 0.5% EC + 0.5% AC + 2% KOH + 0.7% CS + 14% CN + 1% | 7 minute/100° C. |
| | Glycerol + 93 ml Ethanol | |
| 7 | 0.5% EC + 0.5% AC + 2% KOH + 1.5% CS + 14% CN + 1% | 7 minute/125° C. |
| | Glycerol + 100 ml Ethanol | |
| 8 | 0.5% EC + 0.5% AC + 2% KOH + 0.7% CS + 14% CN + 1% | 7 minute/125° C. |
| | Glycerol + 93 ml Ethanol | |
| 9 | 0.5% EC + 0.5% AC + 2% KOH + 1.5% CS + 14% CN + 1% | 15 minute/100° C. |
| | Glycerol + 100 ml Ethanol | |
| 10 | 0.5% EC + 0.5% AC + 2% KOH + 0.7% CS + 14% CN + 1% | 15 minute/100° C. |
| | Glycerol + 93 ml Ethanol | |

TABLE 13

| | | coagulant drying |
|---|---|---|
| | Coagulant formulation | time / temp. |
| 1 | 0.5% EC + 0.5% AC + 4% KOH + 0.7% CS (+1.05% extra water) + | |
| | 14% CN (+6% extra water) + 2% Glycerol + 5% Water + 88 ml | |
| | Ethanol | |
| 2 | 0.5% EC + 0.5% AC + 4% KOH + 1.5% CS + 14% CN + 2% | 2 minute/100° C. |
| | Glycerol + 5% Water + 95 ml Ethanol | |
| 3 | 0.5% EC + 0.5% AC + 4% KOH + 0.7% CS (+1.05% extra water) + | 2 minute/125° C. |
| | 14% CN (+6% extra water) + 2% Glycerol + 5% Water + 88 ml | |
| | Ethanol | |
| 4 | 0.5% EC + 0.5% AC + 4% KOH + 1.5% CS + 14% CN + 2% | 2 minute/125° C. |
| | Glycerol + 5% Water + 95 ml Ethanol | |
| 5 | 0.5% EC + 0.5% AC + 4% KOH + 0.7% CS (+1.05% extra water) + | 7 minute/100° C. |
| | 14% CN (+6% extra water) + 2% Glycerol + 5% Water + 88 ml | |
| | Ethanol | |
| 6 | 0.5% EC + 0.5% AC + 4% KOH + 1.5% CS + 14% CN + 2% | 7 minute/100° C. |
| | Glycerol + 5% Water + 95 ml Ethanol | |
| 7 | 0.5% EC + 0.5% AC + 4% KOH + 0.7% CS (+1.05% extra water) + | 7 minute/125° C. |
| | 14% CN (+6% extra water) + 2% Glycerol + 5% Water + 88 ml | |
| | Ethanol | |
| 8 | 0.5% EC + 0.5% AC + 4% KOH + 1.5% CS + 14% CN + 2% | 7 minute/125° C. |
| | Glycerol + 5% Water + 95 ml Ethanol | |
| 9 | 0.5% EC + 0.5% AC + 4% KOH + 0.7% CS (+1.05% extra water) + | 15 minute/100° C. |
| | 14% CN (+6% extra water) + 2% Glycerol + 5% Water + 88 ml | |
| | Ethanol | |
| 10 | 0.5% EC + 0.5% AC + 4% KOH + 1.5% CS + 14% CN + 2% | 15 minute/100° C. |
| | Glycerol + 5% Water + 95 ml Ethanol | |

Whole gloves were prepared and samples were taken from fingers for testing. Bacteria recovery and material neutralisation was conducted with 15 seconds vortex at 2000 rpm for 2% KOH samples and gram-positive testing for 4% KOH, and 30 seconds at 3000 rpm for gram-negative 4% KOH samples.

As can be seen in FIGS. 48 to 51, the overall trend of the results suggested that decreasing the curing time increased the antibacterial efficacy against gram-positive bacteria for both 2 and 4% KOH formulations.

### Example 5—Water-Based Coagulant Formulations

This series of experiments developed water-based coagulant formulations as an alternative to the ethanol-based formulations described above. In particular, formulations based on Hydroxypropyl cellulose (HPC) were selected for development.

### HPC-Based Coagulant Materials

### Materials Used for the Preparation of the Coagulant Formulations:

All chemicals for coagulant preparation were purchased either from Sigma Aldrich, APC Pure or Fisher. The materials were used as received without any further purification.
Hydroxypropyl cellulose (HPC); average Mw ˜100,000, powder, 20 mesh particle size (99% through)
Hydroxypropyl cellulose (HPC); average Mw ˜80,000, average Mn ˜10,000, powder, 20 mesh particle size (99% through)
Acrylic acid (Aac) anhydrous, contains 200 ppm MEHQ as inhibitor, 99%-Sodium Dodecyl Benzene Sulphonate (SDBS); % 80±2 Apparent Density g/cm3 0.25-0.35
Deionised Water (d.d. water)
Potassium hydroxide (KOH); ACS reagent, ≥85%, pellets
Glycerol (Gly); ACS reagent, ≥99.5%
Calcium nitrate tetrahydrate (CN), 98%
Calcium stearate (CS) dispersion (40%); 6.6-7.4% Ca basis

*Calcium stearate (CS) as water dispersion (40%), was obtained from [NAME REDACTED]. Calcium nitrate tetrahydrate crystals (CNC) (70%), provided by [NAME REDACTED], were used in some experiments.

TABLE 15

| Materials of Coagulant | Chemical structure |
|---|---|
| Brij ™ 35 (Non ionic surfactant) | 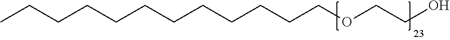 |
| Hydroxypropyl cellulose (HPC polymer) | 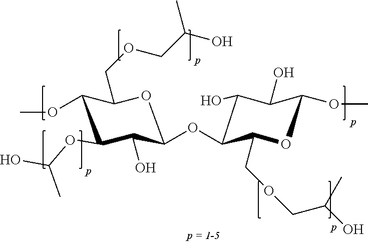 |
| Acrylic acid (AAc_functionaliser) | 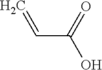 |
| Calcium nitrate tetrahydrate | Ca(NO₃)₂.4H₂O |
| (CN_coagulation agent) | |
| Calcium Stearate (CS_anti tack agent_former releasing agent) | 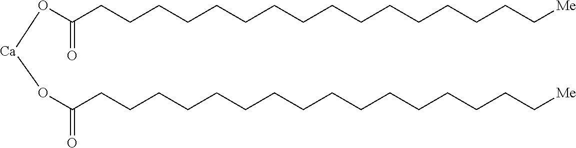 |

### Coagulant Preparation:

Different formulations were prepared in coagulant tanks to prepare different glove formulations whose efficacy was compared. The mechanism of antimicrobial action of the gloves was also investigated, as well as optimising the concentration of each material in the formulation to obtain the best quality gloves in terms of antimicrobial activity and mechanical properties:

In a 2000 ml beaker equipped with a magnetic stirrer bar, the required amount of KOH was dissolved in 1500 ml d.d. water before the required amount of HPC was added gradually to the solution. When all the HPC was dissolved, the required amount of SDBS was added to the solution. Then, the required amount of liquid AAc was added dropwise, and the solution was stirred for 1 hr. The required amount of CN was then added to the solution. Once these components had dissolved completely, the required amounts of Gly and CS were added to the solution. The coagulant mixture was stirred fast for more than 3 hours.

All concentrations mentioned in the tables below were calculated based on the equation of (g/ml)×100. For example, 1% HPC means 1 g of HPC in 100 ml water or, alternatively, 15 g of HPC in 1500 ml water.

### Nitrile Materials

### Materials Used for Preparation of Nitrile Materials:

Nitrile latex solution (NBR); 45% acrylonitrile-co-butadiene-co-acrylic acid rubber in water was provided by [NAME REDACTED] or Synthomer plc
Composite was provided by Hartalega.
Blue Dye was provided by Hartalega.
Ammonium hydroxide, 10% in water.
d.d. water

These materials are used as a standard by almost all glove manufacturers. The actual chemical compositions of material provided by [NAME REDACTED] were confidential and their details were not shared. In some experiments, compounded nitrile sourced from Uniglove (UK) Ltd was used.

[NAME REDACTED] or Synthomer Compounded Nitrile Preparation (18% Solid Content) The nitrile solution was prepared over 3 days:

On day 1, a kilogram of raw latex solution was poured into a 3000 ml beaker and slowly stirred for 30 minutes. The pH of the latex was adjusted to 9.5-9.7 with a digital pH metre by using an ammonia solution. The latex was stirred slowly for another 1 hour before 55 grams of the composite was diluted with d.d. water (ratio 1:1). The diluted composite was added into the latex and slowly stirred overnight.

On day 2, the latex was diluted with d.d. water to reach an 18% solid content. A requisite amount of ammonia was added to ensure the latex pH was in the range of 9.9-10.2.

On day 3, the latex had achieved 2 days of maturation and so was suitable to be used for glove manufacturing. At this point, one gram of dye was added to the nitrile mixture and stirred for 2 hrs.

### Uniglove Compounded Nitrile (Solid Content 27%).

Uniglove compounded nitrile (acrylonitrile-co-butadiene-co-acrylic acid rubber) with 27% solid content was used in some experiments. The chemical compositions of additive materials in compounded nitrile latex provided by Uniglove are confidential and their details were not shared.

### Glove Processing

The coagulant solutions were pre-warmed to 60° C.
Former Cleaning: Formers were cleaned using cleaning soap and scouring pad until formers were fully cleaned.
Coagulant dipping: (A) The former temperature before dipping was at 60±2° C. (B) The former was dipped into a tank of coagulant. Dipping parameters: In 3 sec-Dwell 1 sec-Out 10 sec.
Former Drying: after coagulant dipping the former was put into a drying oven. Drying Oven temperature and Duration were varied based on experiment aims.
Nitrile latex Dipping: (A) the former was taken out from the oven to reach a temperature of 65±3° C. (B) The former was dipped into the Nitrile tank to form a layer of nitrile film. Dipping parameter: In 7 sec-Dwell 5 sec-Out 6 sec.
Manual Beading: Manual beading was formed at the cuff of the glove.
Pre-Leaching: The former with the wet film was dipped into a 55° C. water bath for 1 min.
Curing: The former was put in an oven at 125° C. for 20 min to remove water and to vulcanise the glove.
Glove Stripping: the glove was taken out from the oven. The gloves were removed from the former while the temperature during stripping was 65° C.

It is hypothesised that the formulations described in this example form a microencapsulated ionophore:ion complex in which a nature-derived modified polysaccharide (HPC) acts as a shell biocompatible material. Acrylate amphiphilic HPC was synthesised by the reaction between HPC and AAc carried out in alkaline water and SDBS surfactant mixture in which a hydroxyl group in HPC converts into an alkoxide ion, a strong nucleophile. Then, the alkoxide ion of HPC attacks one carbonyl group of the Aac, creating an ester bond while HPC has other hydroxyl groups that coordinate with Calcium ions in solution. The chemical reaction is shown in FIG. 52.

On the other hand, by adding KOH to a coagulant formulation, the extra KOH can react with Ca(NO₃)₂ and create non-soluble Ca(OH)₂ in the coagulant which Ca(OH)₂ is solid segment precipitation in coagulant. The reaction is shown in the following scheme.

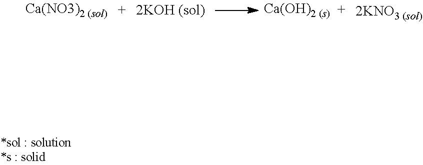

The Ca(OH)₂ sediment dissolves later by adding glycerol in solution.

At the coagulant dipping process, a thin layer of coagulant film forms on the surface of the former. After dipping the former in the nitrile tank, some of this thin layer will start diffusing into the matrix of latex, while the main part will remain on the inner surface of the nitrile layer (former side) when in use, as shown in FIG. 53. Then, during the vulcanisation step at 120° C., the acrylate groups will be polymerised under thermal radical polymerisation which helps the stability of microcapsules on the surface of nitrile (FIG. 53B).

### Antibacterial Test Method:

For the following experiments all antibacterial testing included a negative control (polypropylene (PP) sheet), and a positive control (standard gloves sprayed with 20 k ppm HOCl) were used. This is listed as Samples 1 and 2 respectively in each graph, unless otherwise stated.

### Antiviral Test Method:

Testing was performed in accordance with ISO 21702:2019 ‘Measurement of antiviral activity on plastics and other non-porous surfaces’ (with some modifications). Virus: Mouse Hepatitis virus (VR-764™; strain MHV A59) was used and purchased from American Type Culture Collection (ATCC). In all testing, a negative control, polypropylene (PP) sheet, and a positive control, standard gloves sprayed with 20 k ppm HOCl, were used unless otherwise stated.

### Experiment 1

This experiment investigated water-based coagulant formulations using HPC, glycerol, and KOH concentrations similar to the ethanol-based EC coagulants described in Examples 1 and 2.

Coagulant formulations are set out in Table 16. Coagulant layers were dried for 2 minutes at 100° C.

TABLE 16

| | Coagulant formulation |
|---|---|
| 1 | 0.5% HPC (Mw: 80k) + 4% KOH + 2% Glycerol + 0.5% CS |
| | (dispersion) + 20% CN |
| 2 | 0.5% HPC (Mw: 80k) + 4% KOH + 4% Glycerol + 0.5% CS |
| | (dispersion) + 20% CN |
| 3 | 0.5% HPC (Mw: 80k) + 6% KOH + 2% Glycerol + 0.5% CS |
| | (dispersion) + 20% CN |
| 4 | 0.5% HPC (Mw: 80k) + 6% KOH + 4% Glycerol + 0.5% CS |
| | (dispersion) + 20% CN |

As shown in FIGS. 54 and 55, Sample 1 showed promising antibacterial activity against gram-positive bacteria. Increasing the level of KOH had little effect on gram-negative bacteria.

### Experiment 2

In this experiment washing (W) was added to the protocol to investigate any drop in efficacy after wash. Coagulant formulations are set out in Table 17. Coagulant layers were dried for 2 minutes at 100° C.

TABLE 17

| | Coagulant formulation |
|---|---|
| 1 | 0.5% HPC (Mw: 80k) + 2% KOH + 1% Glycerol + 0.5% CS |
| | (dispersion) + 20% CN |
| 2 | 0.5% HPC (Mw: 80k) + 4% KOH + 2% Glycerol + 0.5% CS |
| | (dispersion) + 20% CN |
| 3 | 0.5% HPC (Mw: 80k) + 4% KOH + 4% Glycerol + 0.5% CS |
| | (dispersion) + 20% CN |
| 4 | 0.5% HPC (Mw: 80k) + 6% KOH + 2% Glycerol + 0.5% CS |
| | (dispersion) + 20% CN |
| 5 | 0.5% HPC (Mw: 80k) + 6% KOH + 4% Glycerol + 0.5% CS |
| | (dispersion) + 20% CN |

Results are shown in FIGS. 56 and 57.

### Experiment 3

This experiment used a 0.5% HPC water-based coagulant including 2% KOH and investigated the effect on antibacterial efficacy with the addition of SBDS. Changing glycerol concentration and coagulant drying time and temperature were also investigated. Synthomer nitrile was used in this experiment.

Coagulant formulations and drying temperatures are set out in Table 18. All coagulant formulations were dried for 2 minutes.

TABLE 18

| | | coagulant |
|---|---|---|
| | Coagulant formulation | drying temp. |
| 1 | 0.5% HPC (Mw: 80k), 2% KOH, 1% gly, 20% | 100° C. |
| | CNC, 0.5% CS, 0.01% SDBS | |
| 2 | 0.5% HPC (Mw: 80k), 2% KOH, 1% gly, 20% | 125° C. |
| | CNC, 0.5% CS, 0.01% SDBS | |
| 3 | 0.5% HPC (Mw: 80k), 2% KOH, 1% gly, 20% | 140° C. |
| | CNC, 0.5% CS, 0.01% SDBS | |
| 4 | 0.5% HPC (Mw: 80k), 2% KOH, 2% gly, 20% | 100° C. |
| | CNC, 0.5% CS, 0.01% SDBS | |
| 5 | 0.5% HPC (Mw: 80k), 2% KOH, 2% gly, 20% | 125° C. |
| | CNC, 0.5% CS, 0.01% SDBS | |
| 6 | 0.5% HPC (Mw: 80k), 2% KOH, 2% gly, 20% | 140° C. |
| | CNC, 0.5% CS, 0.01% SDBS | |

Results are shown in FIGS. 58 and 59 in which similar results against gram-positive bacteria were seen at coagulant drying temperatures of 100° C. and 140° C., but a drying temperature of 125° C. saw a decreased efficacy for both 1% glycerol and 2% glycerol formulations. Samples with 100° C. drying temperature performed marginally better after washing than 120° C. and 140° C.

### Experiment 4

This experiment investigated the effect of increasing KOH concentration against gram-negative bacteria. Synthomer nitrile was used in this experiment.

Coagulant formulations and drying temperatures are set out in Table 19. All coagulant formulations were dried for 2 minutes.

TABLE 19

| | | coagulant |
|---|---|---|
| | Coagulant formulation | drying temp. |
| 1 | 0.5% HPC, 4% KOH, 2% gly, 20% CNC, 0.5% CS, 0.01% SDBS | 100° C. |
| 2 | 0.5% HPC, 4% KOH, 2% gly, 20% CNC, 0.5% CS, 0.01% SDBS | 125° C. |
| 3 | 0.5% HPC, 4% KOH, 2% gly, 20% CNC, 0.5% CS, 0.01% SDBS | 140° C. |
| 4 | 0.5% HPC, 4% KOH, 4% gly, 20% CNC, 0.5% CS, 0.01% SDBS | 100° C. |
| 5 | 0.5% HPC, 4% KOH, 4% gly, 20% CNC, 0.5% CS, 0.01% SDBS | 125° C. |
| 6 | 0.5% HPC, 4% KOH, 4% gly, 20% CNC, 0.5% CS, 0.01% SDBS | 140° C. |

As shown in FIGS. 59 and 60, similar trends were observed to Experiment 2 for gram-positive bacteria. No improvement in efficacy against gram-negative bacteria was seen using a coagulant formulation including 4% KOH.

### Experiment 5

The aim of this experiment was to optimise the concentrations of HPC and functionaliser to improve antibacterial activity.

Contact time for gram-negative bacteria was increased to 2 hours. All coagulant formulations (Table 20) were dried for 2 minutes at 100° C.

TABLE 20

| | Coagulant formulation |
|---|---|
| 1 | 0.5% HPC, 2% KOH, 2% gly, 20% CNC, 0.5% CS |
| 2 | 0.5% HPC, 2% KOH, 2% gly, 20% CNC, 0.5% CS |
| 3 | 0.5% HPC, 2% KOH, 2% gly, 20% CNC, 0.5% CS, 0.5% AAc, 0.01% SDBS |
| 4 | 0.5% HPC, 2% KOH, 2% gly, 20% CNC, 0.5% CS, 1% AAc, 0.01% SDBS |
| 5 | 0.5% HPC, 2% KOH, 2% gly, 20% CNC, 0.5% CS, 1.5% AAc, 0.01% SDBS |
| 6 | 0.5% HPC, 2% KOH, 2% gly, 20% CNC, 0.5% CS, 2% AAc , 0.01% SDBS |
| 7 | 1% HPC, 2% KOH, 2% gly, 20% CNC, 0.5% CS |
| 8 | 1% HPC, 2% KOH, 2% gly, 20% CNC, 0.5% CS, 0.01% SDBS |
| 9 | 1% HPC, 2% KOH, 2% gly, 20% CNC, 0.5% CS, 0.5% AAc, 0.01% SDBS |
| 10 | 1% HPC, 2% KOH, 2% gly, 20% CNC, 0.5% CS, 1% AAc , 0.01% SDBS |
| 11 | 1% HPC, 2% KOH, 2% gly, 20% CNC, 0.5% CS, 1.5% AAc, 0.01% SDBS |
| 12 | 1% HPC, 2% KOH, 2% gly, 20% CNC, 0.5% CS, 2% AAc, 0.01% SDBS |

As seen in FIGS. 62 and 63, antibacterial activity against gram-positive bacteria was high with both 0.5% HPC and 1% HPC, and the optimum activity was found in samples where the percentage of AAc was 2 to 3 times more than the percentage of HPC. At this concentration of AAc, there is a slight improvement in efficacy compared to the base formulation where no Aac is present.

### Experiment 5

This experiment further investigated the effect of 4% KOH on the antibacterial efficacy of coagulant formulations.

All coagulant formulations (Table 21) were dried for 2 minutes at 100° C.

TABLE 21

| | Coagulant formulation |
|---|---|
| 1 | 0.5% HPC, 4% KOH, 4% gly, 20% CNC, 0.5% CS |
| 2 | 0.5% HPC, 4% KOH, 4% gly, 20% CNC, 0.5% CS, 0.01% SDBS |
| 3 | 0.5% HPC, 4% KOH, 4% gly, 20% CNC, 0.5% CS, 0.01% SDBS, 0.5% AAc |
| 4 | 0.5% HPC, 4% KOH, 4% gly, 20% CNC, 0.5% CS, 0.01% SDBS, 1% AAc |
| 5 | 0.5% HPC, 4% KOH, 4% gly, 20% CNC, 0.5% CS, 0.01% SDBS, 1.5% AAc |
| 6 | 0.5% HPC, 4% KOH, 4% gly, 20% CNC, 0.5% CS, 0.01% SDBS, 2% AAc |
| 7 | 1% HPC, 4% KOH, 4% gly, 20% CNC, 0.5% CS |
| 8 | 1% HPC, 4% KOH, 4% gly, 20% CNC, 0.5% CS, 0.01% SDBS |
| 9 | 1% HPC, 4% KOH, 4% gly, 20% CNC, 0.5% CS, 0.01% SDBS, 0.5% AAc |
| 10 | 1% HPC, 4% KOH, 4% gly, 20% CNC, 0.5% CS, 0.01% SDBS, 1% AAc |
| 11 | 1% HPC, 4% KOH, 4% gly, 20% CNC, 0.5% CS, 0.01% SDBS, 1.5% AAc |
| 12 | 1% HPC, 4% KOH, 4% gly, 20% CNC, 0.5% CS, 0.01% SDBS, 2% AAc |

As shown in FIGS. 64 and 65, antibacterial activity against gram-positive bacteria was high with both 0.5% HPC and 1% HPC, and the optimum activity was found in samples where the percentage of AAc was 2 to 4 times more than the percentage of HPC. This is consistent with the ethanol-based formulations including 2% KOH. Without the presence of AAc, antibacterial activity was significantly lower in the presence of 4% KOH. Gram-negative activity was marginally better with 0.5% HPC than 1% HPC.

### Experiment 6

This experiment investigated the effect of washing on gram-positive antibacterial activity of recently optimised HPC coagulant formulations.

TABLE 22

| | Coagulant formulation |
|---|---|
| 1 | 0.5% HPC, 2% KOH, 2% gly, 20% CN, 0.5% CS |
| 2 | 0.5% HPC, 2% KOH, 2% gly, 1.5% AAc, 0.01% SDBS 20% CN, 0.5% CS |
| 3 | 0.5% HPC, 2% KOH, 2% gly, 1.5% AAc, 20% CN, 0.5% CS |
| 4 | 1% HPC, 2% KOH, 2% gly, 20% CN, 0.5% CS |
| 5 | 1% HPC, 2% KOH, 2% gly, 2% AAc, 0.01% SDBS, 20% CN, 0.5% CS, |
| 6 | 1% HPC, 2% KOH, 2% gly, 2% AAc, 20% CN, 0.5% CS, |
| 7 | 0.5% HPC, 2% gly, 20% CN, 0.5% CS |
| 8 | 1% HPC, 2% gly, 20% CN, 0.5% CS |

As seen in FIGS. 66 and 67, where 1% HPC was present, the addition of AAc functionaliser increases antibacterial activity. The addition of SDBS had no effect, positive or negative, when added to the formulations.

### Experiment 7

In this experiment, concentrations of HPC, the addition of a functionaliser (AAc), the addition of SDBS, the addition of glycerol and the effect of KOH on antibacterial activity was investigated. Nitriles from Synthomer were used. Coagulant drying time was 2 minutes at a temperature of 100° C. Antibacterial activity was only tested against gram-positive bacteria (S. aureus). Coagulation formulations tested are set out in Table 23:

TABLE 23

| | Coagulant formulation |
|---|---|
| 1 | 0.5% HPC + 20% CN + 0.5% CS |
| 2 | 0.5% HPC + 2% AAc + 20% CN + 0.5% CS |
| 3 | 0.5% HPC + 2% KOH + 20% CN + 0.5% CS |
| 4 | 0.5% HPC + 2% KOH + 2% Gly + 20% CN + 0.5% CS |
| 5 | 0.5% HPC + 2% KOH + 2% Gly + 0.01% SDBS + 0.5% AAc + 20% CN + 0.5% CS |
| 6 | 0.5% HPC + 2% KOH + 2% Gly + 0.01% SDBS + 1.5% AAc + 20% CN + 0.5% CS |
| 7 | 1% HPC + 20% CN + 0.5% CS |
| 8 | 1% HPC + 2% AAc + 20% CN + 0.5% CS |
| 9 | 1% HPC + 2% KOH + 20% CN + 0.5% CS |
| 10 | 1% HPC + 2% KOH + 2% Gly + 20% CN + 0.5% CS |
| 11 | 1% HPC + 2% KOH + 2% gly + 2% AAc + 20% CN + 0.5% CS |
| 12 | 1% HPC + 2% KOH + 2% Gly + 0.01% SDBS + 2% AAc + 20% CN + 0.5% CS |

As can be seen in FIG. 68, across all formulations, increased efficacy against gram-positive bacteria was seen across all coagulant formulations including 1% HPC. The addition of functionaliser (AAc) to both HPC concentrations also increased antibacterial efficacy.

### Experiment 8

The aim of this experiment was to compare the effectiveness of coagulant formulations including different molecular weights of 1% HPC. In particular, molecular weights of 80K and 100K were compared.

Coagulant drying time for all samples was 2 minutes at a temperature of 100° C. Coagulant formulations are set out in Table 24:

TABLE 24

| | Coagulant formulation |
|---|---|
| 1 | 1% HPC (Mw: 80k) + 20% CN + 0.5% CS |
| 2 | 1% HPC (Mw: 80k) + 2% AAc + 20% CN + 0.5% CS |
| 3 | 1% HPC (Mw: 80k) + 2% KOH + 2% Gly + 20% CN + 0.5% CS |
| 4 | 1% HPC (Mw: 80k) + 2% KOH + 2% Gly + 2% AAc + 20% CN + 0.5% CS |
| 5 | 1% HPC (Mw: 100k) + 20% CN + 0.5% CS |
| 6 | 1% HPC (Mw: 100k) + 2% AAc + 20% CN + 0.5% CS |
| 7 | 1% HPC (Mw: 100k) + 2% KOH + 2% Gly + 20% CN + 0.5% CS |
| 8 | 1% HPC (Mw: 100k) + 2% KOH + 2% Gly + 2% AAc + 20% CN + 0.5% CS |

As shown in FIG. 69, the change from 80K HPC to 100K HPC had no negative effect on gram-positive bacteria antibacterial activity. All future optimisations will use 100K HPC.

### Experiment 9

This experiment investigated the effect of the addition of KOH to the coagulant formulations to enhance antibacterial activity against gram-negative bacteria and explored the addition of calcium hydroxide also to target gram-negative bacteria.

Coagulant drying time was 2 minutes at 100° C. and the HPC used had a molecular weight of 100 k. Coagulant formulations are set out in Table 25:

TABLE 25

| | Coagulant formulation |
|---|---|
| 1 | 1% HPC + 20% CN + 0.5% CS |
| 2 | 1% HPC + 2% AAc + 20% CN + 0.5% CS |
| 3 | 1% HPC + 2% KOH + 20% CN + 0.5% CS |
| 4 | 1% HPC + 2% KOH + 2% AAc + 20% CN + 0.5% CS |
| 5 | 1% HPC + 4% KOH + 20% CN + 0.5% CS |
| 6 | 1% HPC + 4% KOH + 2% AAc + 20% CN + 0.5% CS |
| 7 | 1% HPC + 4% Ca(OH)₂ + 20% CN + 1% CS |
| 8 | 1% HPC + 1% HOCl + 20% CN + 1% CS |
| 9 | 1% HPC + 4% Ca(OH)₂ + 2% AAc + 20% CN + 1% CS |

As seen in FIGS. 70 and 71, calcium hydroxide showed a marginal improvement in efficacy,

### Experiment 10

The aim of this experiment was to compare the addition of functionaliser AAc before and after gloves were washed for both antibacterial (gram-positive) and antiviral activity.

Coagulant drying time was 2 minutes at 100° C. and the HPC used had a molecular weight of 100K. Coagulant formulations are set out in Table 26:

TABLE 26

| | Coagulant formulation |
|---|---|
| 1 | 1% HPC + 20% CN + 0.5% CS |
| 2 | 1% HPC + 2% AAc + 20% CN + 0.5% CS |

As seen in FIGS. 71 and 72, the addition of AAc showed a small improvement in both antibacterial and antiviral activity. Water washing did not appear to affect the antimicrobial activity significantly.

### Experiment 11

The aim of this experiment was to assess the effect on antibacterial activity of the addition of Brij™ 35 to the coagulant formulations. Brij™ 35 is a nonionic polyoxyethylene surfactant.

Coagulant drying time was 2 minutes at 100° C. and the HPC used had a molecular weight of 100 k. Coagulant formulations are set out in Table 27:

TABLE 27

| | Coagulant formulation |
|---|---|
| 1 | 1% HPC (100k) + 20% CN + 0.5% CS |
| 2 | 1% HPC (100K) + 20% CN + 1% CS |
| 3 | 1% HPC (100k) + 2% AAc + 20% CN + 1% CS |
| 4 | 1% HPC (100k) + 0.1% Brij ™ 35 + 20% CN + 1% CS |
| 5 | 1% HPC (100k) + 0.1% Brij ™ 35 + 2% AAc + 20% CN + 1% CS |

As shown in FIGS. 73 and 74, the addition of Brij™ 35 showed a small improvement in antibacterial activity against gram-positive bacteria.

### Experiment 12

The aim of this experiment was to optimise coagulant temperature and coagulant drying temperature. The HPC used had a molecular weight of 100K. Coagulant formulations tested are set out in Table 28.

TABLE 28

| | | Coagulant | Coagulant drying |
|---|---|---|---|
| | Coagulant formulation | temp. | time/temp. |
| 1 | 20% CN + 1% CS | 25° C. | 100° C. |
| 2 | 1% HPC (100K) + 20% CN + 1% CS | 25° C. | 2 min/100° C. |
| 3 | 1% HPC (100k) + 2% AAc + 20% | 25° C. | 2 min/100° C. |
| | CN + 1% CS | | |
| 4 | 1% HPC (100K) + 20% CN + 1% CS | 35° C. | 2 min/100° C. |
| 5 | 1% HPC (100k) + 2% AAc + 20% | 35° C. | 2 min/100° C. |
| | CN + 1% CS | | |
| 6 | 1% HPC (100K) + 20% CN + 1% CS | 45° C. | 2 min/100° C. |
| 7 | 1% HPC (100k) + 2% AAc + 20% | 45° C. | 2 min/100° C. |
| | CN + 1% CS | | |
| 8 | 1% HPC (100K) + 20% CN + 1% CS | 45° C. | 50 sec/100° C. |
| 9 | 1% HPC (100k) + 2% AAc + 20% | 45° C. | 50 sec/100° C. |
| | CN + 1% CS | | |
| 10 | 1% HPC (100K) + 20% CN + 1% CS | 55° C. | 2 min/100° C. |
| 11 | 1% HPC (100k) + 2% AAc + 20% | 55° C. | 2 min/100° C. |
| | CN + 1% CS | | |
| 12 | 1% HPC (100k) + 2% AAc + 20% | 55° C. | 50 sec/100° C. |
| | CN + 1% CS | | |

As shown in FIGS. 75 and 76, a consistent increase in antibacterial activity was seen with the addition of AAc in all processing conditions. Higher coagulant temperature during manufacturing also increased the antibacterial activity against gram-positive bacteria. No obvious trends were found when changing coagulant drying temperature.

### Experiment 13

This experiment investigated the antiviral efficacy of water-based coagulant formulations.

Coagulant drying time was 2 minutes at 100° C. and the HPC used had a molecular weight of 100 k. Sample descriptions and coagulant formulations are set out in Table 29.

TABLE 29

| | Control_PP | |
|---|---|---|
| 1 | Control_Uniglove antimicrobial glove | |
| 2 | Control_Ansell (blue - loose gloves) normal | |
| 3 | Control_Ansell (Microflex - boxed, light purple) normal | |
| 4 | Control_Kimtech (Purple glove) | |
| 5 | Control +ve (HOCl sprayed purple glove) | |
| 6 | Control_Uniglove nitrile film | |
| | | Coagulant |
| | | solution |
| | Coagulant formulation | temperature |
| 7 | 14% CN + 0.5% CS | 25° C. |
| 8 | 20% CN + 0.5% CS | 25° C. |
| 11 | 1% HPC (Mw: 100K) + 20% CN + 1% CS | 55° C. |
| 12 | 1% HPC (Mw: 100k) + 2% AAc + 20% CN + 1% CS | 55° C. |

Results are shown in FIG. 77.

### Example 6—Styrene-Butadiene (SB) Water-Based Coagulant Formulations

### SB-Based Coagulant Materials:

The following chemicals for coagulant preparation were purchased either from Sigma Aldrich or Fisher. The materials were used as received without any further purification:
SB water-based latex 38% or 50%, carboxylated styrene-butadiene copolymer.
Acrylic acid (AAc) anhydrous, contains 200 ppm MEHQ as an inhibitor, 99%.
d.d. water
Calcium nitrate tetrahydrate (CN), 98% or 70%
Calcium stearate (CS) water dispersion (40%); 6.6-7.4% Ca basis.
Calcium Hydroxide powder
Potassium hydroxide pellets
Brij™-35, 30% Solution, Molecular Weight: 1225 g, Nonionic, Aggregation Number: 40, Micelle Molecular Weight: 49,000 g, Critical Micelle Concentration (CMC): 0.09 mM (0.011%, w/v).

Calcium stearate (CS) as water dispersion, was received from [NAME REDACTED]. The SB latex water dispersion was received from either EverBuild (38% solid content) or from KUMHO PETROCHEMICAL (KSL 2601 (50% solid content)). Also, Calcium nitrate tetrahydrate crystals (CNC) (70%), provided by [NAME REDACTED] was used in some experiments.

The KUMHO PETROCHEMICAL KSL 2601 (50%) SB was stabilised by adding 1.5 g Brij™-35 to each 30 g of SB latex.

TABLE 30

| Materials of Coagulant | Chemical structure |
|---|---|
| Brij ™ 35 (Non ionic surfactant) | 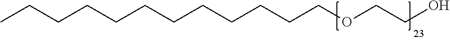 |
| Styrene-butadiene rubber (SB polymer) | 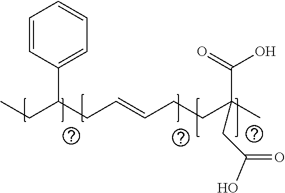 |
| Acrylic acid (AAc_functionaliser) | 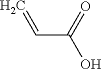 |
| Calcium nitrate tetrahydrate | Ca(NO₃)₂.4H₂O |
| (CN_coagulation agent) | |
| Calcium Stearate (CS_anti-tack agent_former releasing agent) | 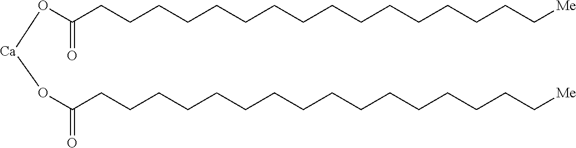 |

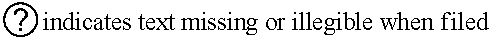

### Coagulant Preparation:

Different formulations were prepared in coagulant tanks to prepare different glove formulations to compare their efficacy and to understand the mechanism of antimicrobial action of the gloves. In addition, based on experimental protocols, the coagulant temperature was kept at room temperature or adjusted to 35° C., or 45° C., using a magnetic stirrer hot plate.

Percentages in formulations were calculated as (gram/milliliter)×100.

### Coagulant Based on Everbuild SB Latex:

In a 2000 ml beaker equipped with a magnetic stirrer bar, the required amount of Brij™ 35 and then the required amount of Everbuild SB latex was dispersed in 1500 ml of d.d. water. The required amount of AAc was then added gradually, and then the required amount of CN was added to the solution. When these components had dissolved completely, the required amount of CS dispersion was added to the solution. The coagulant mixture was stirred fast for more than 3 hours. To obtain 1% Everbuild SB, each 1500 ml coagulant needed 40-gram of Everbuild SB latex.

### Coagulant Based on KUMHO SB Latex:

In a beaker equipped with a magnetic stirrer bar, the required amount of Brij™ 35 and then the required amount of KUMHOSB SB latex was added and stirred until Brij dissolved completely.

In a 2000 ml beaker equipped with a magnetic stirrer bar, the prepared SB latex was dispersed in 1500 ml of d.d. water. Then the required amount of AAc was added gradually, before the required amount of CN was added to the solution. When these components had dissolved completely, the required amount of CS dispersion was added to the solution. The coagulant mixture was stirred fast for more than 3 hours. To obtain 1% KUMHO SB, each 1500 ml coagulant needed 30-gram KUMHO PETROCHEMICAL KSL 2601 SB latex+1.5-gram Brij™ 35.

### Nitrile Preparation Materials:

Nitrile latex solution (NBR); 45% acrylonitrile-co-butadiene-co-acrylic acid rubber was provided by either [NAME REDACTED] or Synthomer
Composite was provided by [NAME REDACTED]
Blue Dye was provided by [NAME REDACTED]
Ammonium hydroxide, 10% in water, were purchased either from Sigma
d.d. water

The above materials are standard that almost all glove manufacturers use. The actual chemical compositions of material provided by Hartalega and Synthomer are confidential and their details were not shared.

[NAME REDACTED] or Synthomer Compounded Nitrile Preparation (18% solid content): The [NAME REDACTED] or Synthomer nitrile solutions were prepared over 3 days:

On day 1, 1 Kg of raw latex was poured into a 3000 ml beaker and slowly stirred for 30 min. The pH of the latex was adjusted to 9.5-9.7 with a digital PH metre using an Ammonia solution. The latex was stirred slowly for another hour. Then, 55 g of the composite was diluted with d.d. water (ratio 1:1) and the diluted composite was added into the latex and slowly stirred overnight.

On day 2, the latex was diluted with d.d. water to reach 18% solid content. To ensure the latex pH was in the range of 9.9-10.2, a required amount of ammonia was added.

On day 3, the latex could be used for glove manufacturing having had 2 days of maturation, and 1 gram of dye was added to the mixture and stirred for 2 hrs.

### Uniglove Compounded Nitrile:

Uniglove compounded nitrile (acrylonitrile-co-butadiene-co-acrylic acid rubber) with 27% solid content was used in some experiments. The chemical compositions of additive materials in compounded Nitrile latex provided by Uniglove are confidential and their details were not shared.

### Glove Processing:

The coagulant solutions were pre-warmed to the corresponding temperature (25° C. or 35° C. or 45° C.).
Former Cleaning: Formers were cleaned using cleaning soap and scouring pad until they were fully cleaned.
Coagulant dipping: (1) The former temperature before dipping should be at 60±2° C. (2) The former was dipped into a tank of coagulant. [dipping parameters are: In 3 sec-Dwell 1 sec-Out 10 sec].
Former Drying: The former after coagulant dipping was put into the drying oven. Oven temperature: 100° C. Duration: 2 minutes or 50 Seconds (based on the experiment plan).
Nitrile latex dipping: (1) The former was taken out from the oven to its temperature reach to 65±3° C. (2) The former was dipped into the Nitrile tank to form a layer of nitrile film [Dipping Parameter: In 7 sec-Dwell 5 sec-Out 6 sec].
Manual Beading: Manual beading was formed at the cuff of the glove.
Pre-Leaching: The former with the wet film was dipped into a 55° C. water bath for 1.5 min.
Curing: The former was put in an oven at 125° C. for 20 mins to remove water and to vulcanise the glove.
Commercial washing of the Nitrile side (chlorination) (optional process):
   An acid bath (chlorine solution) was prepared by adding 10 g of HCl (37%) and 34 g of NaOCl (11%) in 8-litres of soft water.
   The base bath (5% sodium thiosulphate) was prepared by adding 400 g of sodium-thiosulfate-pentahydrate in 8 litres of soft water.
Chlorination detackifies the glove's surface. It starts with preparing chlorine solutions at concentrations of about 1500 ppm (parts per million of chlorine). The gloves on the formers are then dipped in the aqueous chlorine solutions for 10 mins. Following the chlorination process, the gloves are rinsed with a neutraliser solution of 5% sodium thiosulphate, for 5 mins at 60° C. with water, followed by a water rinse. Afterwards, the gloves are dried for 5 mins at 100-120° C. before being removed from the former.
Glove Stripping: The glove was taken out from the oven. The gloves were removed from the former while the temperature during stripping was 65° C.

FIG. 78 illustrates the possibility of encapsulation of Ca ions in the coagulant solution with the carboxylic acid end group of SB latex and AAc as the ionophore, as well as potential double bonds of ionophores to take part in vulcanisation and curing directions of nitrile.

### Antimicrobial Test Method:

In all antibacterial testing, a negative control, polypropylene (PP) sheet, and a positive control, standard gloves sprayed with 20K ppm HOCl, were used. This is listed as samples 1 and 2 respectively in each graph, unless otherwise stated.

### Antiviral Test Method:

Testing was performed in accordance with ISO 21702:2019 ‘Measurement of antiviral activity on plastics and other non-porous surfaces’ with some modifications). Virus: Mouse Hepatitis virus (VR-764™; strain MHV A59) was used and purchased from American Type Culture Collection (ATCC). In all testing, a negative control, polypropylene sheet, and a positive control, standard gloves sprayed with 20K ppm HOCl, were used.

### Experiment 1

The aim of this experiment was the initial development of water-based formulation using SBR and AAc. Coagulant formulations tested are set out in Table 31.

TABLE 31

| | | | Coagulant |
|---|---|---|---|
| | | Coagulant | drying |
| | Coagulant formulation | temp. | time/temp. |
| 3 | 1% Everbuild SB + 20% CN + 0.5% | 25-30° C. | 2 min/100° C. |
| | CS | | |
| 4 | 1% Everbuild SB + 2% AAc + 20% | 25-30° C. | 2 min/100° C. |
| | CN + 0.5% CS | | |
| 5 | 1% Everbuild SB + 20% CN + 0.5% | 25-30° C. | 2 min/100° C. |
| | CS | | |

Results are shown in FIG. 79.

### Experiment 2

The aim of this experiment was to investigate the addition of AAc in the 1% Everbuild SBR formulation for both antibacterial and antiviral activity and determine whether the addition of KOH improves efficacy against gram-negative bacteria.

Coagulant formulations were applied at a temperature of 25-30° C. Coagulant drying time was 2 minutes at 100° C. Coagulant formulations tested are set out in Table 32.

TABLE 32

| | Coagulant formulation |
|---|---|
| 3 | 1% Everbuild SB + 20% CN + 0.5% CS |
| 4 | 1% Everbuild SB + 2% KOH + 20% CN + 0.5% CS |
| 5 | 1% Everbuild SB + 4% KOH + 20% CN + 0.5% CS |
| 6 | 1% Everbuild SB + 2% AAc + 20% CN + 0.5% CS |
| 7 | 1% Everbuild SB + 2% AAc + 2% KOH + 20% CN + 0.5% CS |
| 8 | 1% Everbuild SB + 2% AAc + 4% KOH + 20% CN + 0.5% CS |

As shown in FIGS. 80 and 81, the addition of KOH to the formulation had a small increase in antibacterial activity against gram-negative bacteria. However, KOH decreased efficacy against gram-positive bacteria. The addition of AAc did show a small improvement in both antibacterial and antiviral activity (FIGS. 80, 81 and 82).

### Experiment 3

The aim of this experiment was to investigate whether the addition of the nonionic polyoxyethylene surfactant, Brij™ 35, helps with the consistency and dispersity of the formulation throughout the coagulant and to compare percentages of SBR in the coagulant.

Coagulant formulations were applied at a temperature of 25-30° C. Coagulant drying time was 2 minutes at 100° C. Coagulant formulations tested are set out in Table 33.

TABLE 33

| | Coagulant formulation |
|---|---|
| 3 | 1% Everbuild SB + 20% CN + 0.5% CS |
| 4 | 1% Everbuild SB + 20% CN + 1% CS |
| 5 | 1% Everbuild SB + 0.1% Brij ™ 35 + 20% CN + 1% CS |
| 6 | 1% Everbuild SB + 2% AAc + 20% CN + 1% CS |
| 7 | 1% Everbuild SB + 2% AAc + 0.1% Brij ™ 35 + 20% CN + 1% CS |
| 8 | 2% Everbuild SB + 20% CN + 1% CS |
| 9 | 2% Everbuild SB + 0.1% Brij ™ 35 + 20% CN + 1% CS |
| 10 | 2% Everbuild SB + 2% AAc + 20% CN + 1% CS |
| 11 | 2% Everbuild SB + 2% AAc + 0.1% Brij ™ 35 + 20% CN + 1% CS |

Results are shown in FIGS. 83 and 84. The addition of Brij™ 35 either had no increase in antibacterial activity, or decreased the antibacterial activity of the above formulations.

### Experiment 4

In this experiment, coagulant formulations including 2% Everbuild SB formulations were investigated using Uniglove nitrile. The percentage of CS and coagulant drying time were compared.

The coagulant formulations set out in Table 34 were applied at a temperature of 25-30° C. and dried at 100° C.

TABLE 34

| | | Coagulant drying |
|---|---|---|
| | Coagulant formulation | time/temp. |
| 3 | 2% Everbuild SB + 2% AAc + 20% | 50 sec/100° C. |
| | CN + 1% CS | |
| 4 | 2% Everbuild SB + 2% AAc + 20% | 2 min/100° C. |
| | CN + 1% CS | |
| 5 | 2% Everbuild SB + 2% AAc + 20% | 50 sec/100° C. |
| | CN + 0.5% CS | |
| 6 | 1% Everbuild SB + 2% AAc + 20% | 50 sec/100° C. |
| | CN + 0.5% CS | |

As shown in FIGS. 85 and 86, a concentration of 0.5% CS with 2% Everbuild SBR showed a significant drop in antibacterial activity against gram-positive bacteria, but 0.5% CS with 1% Everbuild SBR is still efficacious. This suggests the importance of the ratio between CS and SBR for optimum antibacterial activity. Gram-negative bacteria antibacterial activity was similar across all formulations.

### Experiment 5

This experiment investigated the antiviral testing of coagulant formulations including SB latex.

Coagulant formulations were applied at a temperature of 25° C. Coagulant drying time was 2 minutes at 100° C. Coagulant formulations tested are set out in Table 35.

TABLE 35

| | Coagulant formulation | Nitrile type | Post leaching |
|---|---|---|---|
| 5 | 20% CN + 1% CS | Uniglove | Without commercial |
| | | Nitrile | wash |
| 6 | 1% Everbuild SB + | Uniglove | Without commercial |
| | 20% CN + 1% CS | Nitrile | wash |
| 10 | 20% CN + 1% CS | Synthomer | Without commercial |
| | | Nitrile | wash |
| 11 | 1% Everbuild SB + | Synthomer | Without commercial |
| | 20% CN + 1% CS | Nitrile | wash |

Additionally, the following control samples were tested alongside the above coagulant formulations:
PG-Purple glove
SB-1% Everbuild SB
1. Uniglove Nitrile film
2. Uniglove Nitrile film+commercial wash
8. Synthomer Nitrile film
9. Synthomer Nitrile film+commercial wash

Results are shown in FIG. 87.

### Experiment 6

The aim of this experiment was to determine an optimum coagulant temperature, coagulant drying time, and percentage of CS in the SBR coagulant formulations.

Coagulant drying temperature was 100° C. for all formulations set out in Table 36.

TABLE 36

| | | | Coagulant | |
|---|---|---|---|---|
| | | Coagulant | drying | |
| | Coagulant formulation | temp. | time | |
| 3 | 1% Everbuild SB + 2% AAc + 20% | 25° C. | 2 | min |
| | CN + 1% CS | | | |
| 4 | 1% Everbuild SB + 2% AAc + 20% | 25° C. | 2 | min |
| | CN + 0.5% CS | | | |
| 5 | 1% Everbuild SB + 2% AAc + 20% | 25° C. | 50 | sec |
| | CN + 1% CS | | | |
| 6 | 1% Everbuild SB + 2% AAc + 20% | 35° C. | 50 | sec |
| | CN + 1% CS | | | |
| 7 | 1% Everbuild SB + 2% AAc + 20% | 25° C. | 50 | sec |
| | CN + 0.5% CS | | | |
| 8 | 1% Everbuild SB + 2% AAc + 20% | 35° C. | 50 | sec |
| | CN + 0.5% CS | | | |
| 9 | 2% Everbuild SB + 2% AAc + 20% | 25° C. | 2 | min |
| | CN + 1% CS | | | |
| 10 | 2% Everbuild SB + 2% AAc + 20% | 25° C. | 2 | min |
| | CN + 0.5% CS | | | |
| 11 | 2% Everbuild SB + 2% AAc + 20% | 25° C. | 50 | sec |
| | CN + 1% CS | | | |
| 12 | 2% Everbuild SB + 2% AAc + 20% | 35° C. | 50 | sec |
| | CN + 1% CS | | | |
| 13 | 2% Everbuild SB + 2% AAc + 20% | 25° C. | 50 | sec |
| | CN + 0.5% CS | | | |
| 14 | 2% Everbuild SB + 2% AAc + 20% | 35° C. | 50 | sec |
| | CN + 0.5% CS | | | |

Results are shown in FIGS. 88 and 89.

### Experiment 7

The aim of this experiment was to investigate the impact of the Uniglove nitrile and the synergistic effect it shows with antimicrobial coagulant formulations, by testing the nitrile alone and in combination with the coagulant formulations, A lower concentration of 14% CN was tested.

Coagulant formulations were applied at a temperature of 25-30° C. Coagulant drying time was 2 minutes at 100° C. Coagulant formulations tested are set out in Table 37.

TABLE 37

| | |
|---|---|
| 1 | No coagulant (Nitrile film) |
| 2 | 20% CN + 0.5% CS |
| 3 | 1% Everbuild SB + 2% AAc + 20% CN + 0.5% CS |
| 4 | 2% Everbuild SB + 2% AAc + 20% CN + 1% CS |
| 5 | 14% CN + 0.5% CS |
| 6 | 1% Everbuild SB + 2% AAc + 14% CN + 0.5% CS |
| 7 | 2% Everbuild SB + 2% AAc + 14% CN + 1% CS |

As shown in FIGS. 90 and 91, gram-positive results confirmed that uniglove nitrile alone has very little antibacterial activity but, when paired with coagulant formulations described herein, a synergistic effect is seen in which both the coagulant side and nitrile side of the gloves have antibacterial activity. This also suggests diffusion of the coagulant material to the nitrile side, making the nitrile very efficacious.

### Experiment 8

The aim of this experiment was to investigate the impact of the Uniglove nitrile and the synergistic effect it shows with coagulant formulations described herein by testing the nitrile alone and in combination with the coagulant formulations for antiviral activity. A concentration of 14% CN and a number of commercially available gloves were also tested.

Coagulant formulations were applied at a temperature of 25° C. Coagulant drying time was 2 minutes at 100° C. Samples and coagulant formulations tested are set out in Table 38.

TABLE 38

| | Control_PP |
|---|---|
| 1 | Control_Uniglove antimicrobial glove (UG) |
| 2 | Control_Ansell (blue - loose gloves) normal (Ansell blue) |
| 3 | Control_Ansell (Microflex - boxed, light purple) normal |
| | (Ansell Microflex) |
| 4 | Control_Kimtech (Purple glove) (Kimtech PG) |
| 5 | Control +ve (HOCl sprayed purple glove) (Positive control) |
| 6 | Control_Uniglove nitrile film (UG nitrile film) |
| | Coagulant formulation |
| 7 | 14% CN + 0.5% CS |
| 8 | 20% CN + 0.5% CS |
| 9 | 1% SBR + 2% AAc + 20% CN + 0.5% CS |
| 10 | 2% SBR + 2% AAc + 20% CN + 1% CS |

Results are shown in FIG. 92.

### Experiment 9

In this experiment, shorter bacterial contact times were tested. The coagulant formulations set out in Table 39 were dried at a temperature of 100° C.

TABLE 39

| | | | Coagulant | |
|---|---|---|---|---|
| | | Coagulant | drying | |
| | Coagulant formulation | temp. | time | |
| 1 | 20% CN + 1% CS | 25° C. | 2 | min |
| 4 | 1% Everbuild SB + 2% AAc + | 25° C. | 50 | sec |
| | 20% CN + 1% CS | | | |
| 11 | 2% Everbuild SB + 2% AAc + | 35° C. | 50 | sec |
| | 20% CN + 1% CS | | | |

| | |
|---|---|
| S. aureus contact times: | Pseudomonas aeruginosa contact times: |

| | | |
|---|---|---|
| 1 | minute | 30 minutes |
| 2 | minutes | 60 minutes |
| 5 | minutes | 2-hours |

Results are shown in FIGS. 93 and 94. A substantial log-reduction in gram-positive bacteria was achieved in a short contact time, showing 2 to 3.5 log in 1 to 2 minutes contact. A small but consistent increase is shown against gram-negative bacteria from 30-minutes to 2-hours.

### Experiment 10

The aim of this experiment was to test a different source of SB latex and to compare the antibacterial efficacy of coagulants formulated with both SB latex types.

The coagulant formulations set out in Table 40 were dried for 50 seconds at 100° C.

TABLE 40

| | | Nitrile | | Coagulant |
|---|---|---|---|---|
| | Coagulant formulation | source | SB type | temp. |
| 1 | 20% CN | Uniglove | — | 25° C. |
| 2 | 20% CN | [NAME | | 25° C. |
| | | REDACTED] | | |
| 3 | 20% CN + 1% CS | Uniglove | — | 25° C. |
| 4 | 20% CN + 1% CS | [NAME | | 25° C. |
| | | REDACTED] | | |
| 5 | 1% Everbuild SB + 2% | Uniglove | Everbuild | 25° C. |
| | AAc + 20% CN + 1% | | | |
| | CS | | | |
| | 1% Everbuild SB + 2% | [NAME | Everbuild | 25° C. |
| | AAc + 20% CN + | REDACTED] | | |
| | 1% CS | | | |
| 7 | 1% KUMHO SB + 2% | Uniglove | KUMHO | 25° C. |
| | AAc + 20% CN + | | SB | |
| | 1% CS | | | |
| 8 | 1% KUMHO SB + 2% | [NAME | KUMHO | 25° C. |
| | AAc + 20% CN + | REDACTED] | SB | |
| | 1% CS | | | |
| 9 | 2% Everbuild SB + 2% | Uniglove | Everbuild | 35° C. |
| | AAc + 20% CN + 1% | | | |
| | CS | | | |
| 10 | 2% Everbuild SB + 2% | [NAME | Everbuild | 35° C. |
| | AAc + 20% CN + | REDACTED] | | |
| | 1% CS | | | |
| 11 | 2% KUMHO SB + 2% | Uniglove | KUMHO | 35° C. |
| | AAc + 20% CN + | | SB | |
| | 1% CS | | | |
| 12 | 2% KUMHO SB + 2% | [NAME | KUMHO | 35° C. |
| | AAc + 20% CN + | REDACTED] | SB | |
| | 1% CS | | | |

Results are shown in FIGS. 95 and 96. Changing the source of SB had no deterioration in antibacterial efficacy, and formulations show consistently higher efficacy when the coagulant formulation is prepared with Uniglove nitrile.

### Experiment 11

The aim of this experiment was to investigate the effect of the pre-leaching step optionally included in the manufacturing process and replacing the pre-leaching water bath with a Ca(OH)₂ aqueous solution bath. Both alternative methods aim to prevent calcium ions from leaching through to the nitrile side and retaining the calcium to the surface of the coagulant side.

The coagulant formulation used for all samples had the following components:

$$1 \% KUMHO SB + 2 \% AAc + 20 \% CN + 1 \% CS$$

The coagulant temperature for all samples listed in Table 41 was 25° C., the coagulant drying time was 50 seconds at 100° C. and all samples were washed with a commercial wash.

TABLE 41

| | | Nitrile | |
|---|---|---|---|
| | Coagulant formulation | source | Pre-leaching |
| 1 | 1% KUMHO SB + 2% | [NAME | No |
| | AAc + 20% CN + | REDACTED] | |
| | 1% CS | | |
| 2 | 1% KUMHO SB + 2% | [NAME | 50° C. water bath |
| | AAc + 20% CN + | REDACTED] | |
| | 1% CS | | |
| 3 | 1% KUMHO SB + 2% | [NAME | With 50° C., Ca(OH)₂ |
| | AAc + 20% CN + | REDACTED] | aqueous solution bath |
| | 1% CS | | |
| 4 | 1% KUMHO SB + 2% | Synthomer | With 50° C. Ca(OH)₂ |
| | AAc + 20% CN + | | aqueous solution bath |
| | 1% CS | | |
| 5 | 1% KUMHO SB + 2% | Uniglove | No |
| | AAc + 20% CN + | | |
| | 1% CS | | |
| 6 | 1% KUMHO SB + 2% | Uniglove | With Ca(OH)₂ aqueous |
| | AAc + 20% CN + | | solution bath |
| | 1% CS | | |

Results are shown in FIGS. 97 and 98. The removal of the pre-leaching step, or replacement of the water bath with Ca(OH)₂ aqueous solution bath showed no improvement in antibacterial activity when the coagulant formulation was prepared with [NAME REDACTED] nitrile. The removal of the pre-leaching step slightly increased antibacterial efficacy with Uniglove nitrile formulated gloves, however replacement of the water bath with Ca(OH)₂ aqueous solution significantly decreased antibacterial activity.

### Experiment 12

This experiment tested the effect of SB-based coagulant formulations on the antibacterial efficacy against the gram-positive bacteria, Enterococcus faecalis with increasing contact time.

Coagulant temperature for all samples was 25° C. Coagulant drying time was 50 seconds at 100° C. and all samples were washed with a commercial wash. The nitrile was sourced from Uniglove Ltd.

$$20 \% CN + 1 \% CS \qquad Sample 1 coagulant formulation$$

$$1 \% KUMHO SB + 2 \% AAc + 20 \% CN + 1 \% CS \qquad Sample 2 coagulant formulation$$

The results are shown in FIG. 99. Results show increased efficacy against Enterococcus faecalis compared to Staphylococcus aureus, confirming significant antibacterial efficacy against a broad range of gram-positive bacterial species.

In summary, formulations have been prepared that can be incorporated into a coagulant solution and used to prepare nitrile material having antimicrobial properties.

1. A coagulant formulation for use in the manufacture of a polymer material formed by dipping, the coagulant formulation comprising a coagulant, one or more wetting agent surfactant, solvent and an anti-tack agent, wherein the coagulant comprises a lipophilic and/or amphiphilic and/or hydrophobic polymeric ionophore:ion complex, wherein the polymeric ionophore is a hydrophilic and/or amphiphilic polymer and wherein the polymeric ionophore:ion complex imparts antimicrobial and/or antiviral properties to the material.

2. The formulation of claim 1, wherein the polymeric ionophore is hydrophilic and/or amphiphilic.

3. The formulation of claim 1, wherein the polymeric ionophore is water soluble.

4. The formulation of claim 2 or claim 3, wherein polymeric ionophore is selected from cellulose, ethyl cellulose (EC), methyl cellulose, hydroxypropyl cellulose (HPC), cellulose acetate and cellulose acetate butyrate, cellulose nitrate, cellulose triacetate, ethylene/vinyl acetate, poly(acrylic acid), poly(methyl methacrylate), poly(propylene oxide), poly(vinyl acetate), poly(methyl methacrylate) (PMMA), poly (2-phenyl-2-oxazoline) (PPhOx), polyethylene oxide (PEO), poly(2-hydroxyethyl methacrylate), poly (1,2-butylene glycol) (PBG), polyacrylonitrile, polyvinyl chloride, polyvinylidene fluoride, poly(vinyl acetate), water-based resins or latex, water-based acrylics, polyurethanes, nitrile latex and natural rubbers, styrene-butadiene and carboxylated styrene-butadiene, cationic surfactants such as dicetyldimonium chloride, anionic surfactants such as sodium dodecylbenzenesulfonate, ammonium dodecyl benzenesulfonate, non-ionic surfactants such as nonylphenol ethoxylated (NPE), ECO BRIJ® O10, and combinations thereof.

5. The formulation of any one of claims 1 to 4, wherein the ion in the complex is a positively charged ion, preferably a metal ion such as Na⁺, K⁺, Ca²⁺, Mn²⁺, Mg²⁺, Sr²⁺, Ti²⁺, Ti⁴⁺, Ba²⁺, Zn²⁺, Fe²⁺, Al³⁺, Cr³⁺ and Bi³⁺.

6. The formulation of claim 5, wherein the ion in the complex is provided in the formulation as a salt, such as a nitrate, nitrite, chloride, hydroxide, carbonate, stearate, iodide, triiodide, iodite, hypoiodite, periodate, iodate or acetate.

7. The formulation of any one of claims 1 to 6, wherein the coagulant is present in the formulation in an amount of between about 2% and about 20%, optionally about 14%.

8. The formulation of any one of claims 1 to 7, wherein the polymeric ionophore:ion complex is present in the coagulant in an amount of between about 0.1% and about 10%.

9. The formulation of any one of claims 1 to 8, wherein the solvent is water, an alcohol or a mixture thereof.

10. The formulation of any one of claims 1 to 9, wherein the formulation further comprises at least one plasticiser.

11. The formulation of claim 10, where in the at least one plasticiser is selected from Dibutyl sebacate (DBS), Hydroxyl end group PDMS (poly dimethyl siloxane), glycerol, sorbitol, sucrose, dibutyl phthalate, ethylene glycol, diethylene glycol, tri ethylene glycol, tetra ethylene glycol, polyethylene glycol, oleic acid, citric acid, tartaric acid, malic acid, soybean oil, dodecanol, lauric acid, tributyrin, trilaurin, epoxidised soybean oil, mannitol, diethanolamine, Fatty acids, triethyl citrate, and/or sucrose esters, and combinations thereof.

12. The formulation of claim 10 or claim 11, where the at least one plasticiser is present in the formulation in an amount of between about 0.1% and about 5%.

13. The formulation of any one of claims 1 to 12, wherein the formulation further comprises one or more functionalising agents.

14. The formulation of claim 13, wherein the one or more functionalising agents is selected from a mono-, di- or multi-factional acrylic, a methacrylic monomer, and acrylic macromonomer, a methacrylic macromonomer, acryloyl chloride, acrylic acid, vinyl chloride, vinyl bromide, vinyl iodide, methacryloyl chloride, methacryloyl bromide, allyl chloride, allyl iodide, allyl bromide, allyl glycidil, methacrylate glycidil, 3-(Trimethoxysilyl)propyl acrylate, 3-(Triethoxysilyl)propyl acrylate, 3-(Trimethoxysilyl)propyl methacrylate, 3-(Triethoxysilyl)propyl methacrylate, 3-(Dimethylchlorosilyl)propyl methacrylate and 3-(Dimethylchlorosilyl)propyl acrylate.

15. The formulation of any one of claims 1 to 14, wherein the formulation further comprises at least one antimicrobial agent.

16. The formulation of claim 15, wherein the at least one antimicrobial agent has antimicrobial activity against gram-negative and/or gram-positive bacteria.

17. The formulation of claim 15 or claim 16, wherein the at least one antimicrobial agent is a basic or acidic compound including a metal hydroxide, a metal hydrate, a metal nitrate, a metal silicate, a metal halide, a metal acetate, a metal sulphide, a tertiary amine, and/or a benzene-based carboxylic acid.

18. The formulation of claim 17, wherein the at least one antimicrobial agent is a salt of a positively charged metal ion selected from Na⁺, K⁺, Ca²⁺, Mn²⁺, Mg²⁺, Sr²⁺, Ba²⁺, Zn²⁺, Fe²⁺, Al³⁺, Cr³⁺ and Bi³⁺.

19. The formulation of claim 18, wherein the salt is a nitrate, chloride, hydroxide, acetate, carbonate, silicate, formates and diformates, or benzoate.

20. The formulation of any one of claims 15 to 19, wherein the antimicrobial agent is a potassium salt or a sodium salt.

21. The formulation of any one of claims 15 to 20, wherein the antimicrobial agent is potassium hydroxide or sodium hydroxide.

22. The formulation of any one of claims 15 to 21, wherein the antimicrobial agent is present in the formulation in an amount of between about 0.5% w/v and about 10% w/v, optionally, in an amount of about 2% w/v, about 4% w/v, about 5% w/v, about 6% w/v or about 8% w/V.

23. The formulation of claim 15, wherein the antimicrobial agent is selected from one or more of O-pheylphenol; sodium phenolate; glycol ethers, propylene glycol phenyl ether (PGPE), 1-phenoxy-2-propanol, phenoxyethanol, 2-Butoxyethanol and poly(ethylene glycol) methyl ether; cationic polymers/surfactants, polyethylenimine, dimethylaminoethyl acrylate (DA), and ethylenediaminetetraacetic acid (EDTA); benzoyl peroxide; phenols; thymols (terpenes and terpenoids); cymenes (alkylbenzene); eugenol.

24. The formulation of any one of claims 1 to 23, wherein the formulation further comprises at least one ionic, or non-ionic surfactant, such as Brij™ 35.

25. The formulation of any one of claims 1 to 24, wherein the ion in the polymeric ionophore:ion complex is a calcium salt, the solvent further includes one or more components that dissolve calcium hydroxide.

26. The formulation of claim 25, wherein the calcium hydroxide solvent is water, glycerol (glycine) and mixtures thereof.

27. The formulation of claim 25 or claim 26, wherein the calcium hydroxide solvent is present in the formulation in an amount of between about 0.1% and about 10%.

28. The formulation of claim 27, wherein the calcium hydroxide solvent comprises about 1% to 2% glycerol and about 5% water.

29. The formulation of any one of claims 1 to 28 wherein the anti-tack agent is a stearate salt, such as calcium stearate, zinc stearate and/or magnesium stearate.

30. The formulation of claim 29, wherein the anti-tack agent is present in an amount of between about 0.1% and about 5%, optionally between about 0.5% and 1.8%.

31. The formulation of any one of claims 1 to 30, wherein the formulation further includes a neutral, pleasant, or unpleasant fragrance and/or flavouring, and/or colourant.

32. The formulation of any one of claims 1 to 31, wherein the formed polymer material is a natural or synthetic elastic polymer, such as latex, nitrile, vinyl and/or nitrile/vinyl.

33. The formulation of any one of claims 1 to 32, wherein the formed polymer material is a natural or synthetic inelastic polymer, such as poly(vinyl chloride (PVC), polyethylene terephthalate (PET), poly propylene (PP), poly ethylene (PE), poly(lactic acid (PLA), polycaprolactone (PCL), Polytetrafluoroethylene (PTFE), polyamide (PA), and polyurethane (PU), biopolymers such as polysaccharides (such as starch, chitosan and cellulose), gelatin, silk and collagen.

34. A method for producing a formable material, the method comprising the steps of:
a) Dipping a former in a coagulant formulation to produce a coagulant-dipped former,
b) Drying and pre-polymerising the dipped former to produce a dried coagulant-dipped former,
c) Cooling the dried coagulant-dipped former to around 25° C.,
d) Dipping the dried former in a solution comprising an elastic polymer to produce a coated former, and
e) Curing and vulcanising the coated former,
wherein the coagulant formulation is a coagulant formulation as claimed in any one of claims 1 to 33.

35. The method as claimed in claim 34, wherein the former is dipped in coagulant formulation for between about 1 second and up to about 3 minutes at a temperature of between about 25° C. and 40° C.

36. The method as claimed in claim 35, wherein the coagulant-dipped former from step a) is dried and pre-polymerised for between less than about 1 minute and up to about 15 minutes at a temperature of about 100° C.

37. The method as claimed in any one of claims 34 to 36, wherein the dried coagulant-dipped former from step c) is dipped for between about 1 second to about 5 minutes at a temperature of between about 18° C. to about 40° C., preferably at about 25° C.

38. The method as claimed in any one of claims 34 to 37, wherein coated former from step d) is cured and vulcanised for between about 6 mins to about 20 minutes, preferably 15 minutes at a temperature of between about 90° C. and about 130° C., preferably 100° C.

39. The method as claimed in any one of claims 34 to 38, wherein the method further includes a pre-step in which the former is heated before being dipped in coagulant formulation.

40. The method as claimed in claim 39, wherein the former is heated for between about 1 minute up to about 10 minutes at a temperature of about 100° C.

41. The method as claimed in any one of claims 34 to 40, wherein the method further includes one or more additional steps before step (a) in which the coagulant-dipped former is pre-dipped one or more times in an additional formulation and dried after each additional dipping step, wherein the first additional formulation comprises an antimicrobial and/or antiviral agent.

42. The method as claimed in claim 41, wherein the additional formulation has a composition that is different for each dipping step.

43. The method as claimed in claim 41 or claim 42, wherein the pre-dipping steps are at the same or different temperatures.

44. The method as claimed in any one of claims 41 to 43, wherein the pre-dipping steps are for the same or different periods of time.

45. The method as claimed in any one of claims 34 to 44, wherein the elastic polymer is selected from latex, nitrile, polyvinyl chloride and/or a mixture of nitrile/PVC.

46. The method as claimed in any one of claims 34 to 45, wherein the formable material and former are for the manufacture of a glove, optionally a disposable glove.

47. A formable material manufactured by the method as claimed in any one of claims 34 to 46, wherein the elastic polymer comprises at least one antimicrobial agent.

48. The formable material as claimed in claim 47, wherein the at least one antimicrobial agent is potassium hydroxide or calcium hydroxide, or is selected from one or more of O-phenylphenol; sodium phenolate; glycol ethers, propylene glycol phenyl ether (PGPE), 1-phenoxy-2-propanol, phenoxyethanol, 2-Butoxyethanol and poly(ethylene glycol) methyl ether; cationic polymers/surfactants, polyethylenimine, dimethylaminoethyl acrylate (DA), and ethylenediaminetetraacetic acid (EDTA); benzoyl peroxide; phenols; thymols (terpenes and terpenoids); cymenes (alkylbenzene); eugenol.
